(19) United States
(12) Patent Application Publication
(10) Pub. No.: US 2013/0332083 A1
(43) Pub. Date: Dec. 12, 2013

(54) Gene Marker Sets And Methods For Classification Of Cancer Patients

(71) Applicant: Ryan Van Laar, New Yorlk, NY (US)

(72) Inventor: Ryan Van Laar, New Yorlk, NY (US)

(21) Appl. No.: 13/877,050

(22) PCT Filed: Sep. 29, 2011
(86) PCT No.: PCT/AU11/01250

§ 371 Date: May 28, 2013

Related U.S. Application Data
(60) Provisional application No. 61/388,181, filed on Sep. 30, 2010.

(51) Int. Cl. G06F 19/24; G06F 19/00

(52) U.S. Cl. CPC G06F 19/24; G06F 19/345
USPC 702/19

(57) ABSTRACT

The present invention relates to gene marker sets for use in classification of cancer patients on the basis of expression of multiple biological markers. The gene marker sets allow identification of the tissue of origin of a metastatic tumor, provide prognostic data on breast cancer recurrence, prognostic data on colon cancer recurrence in cancer patients, or prognosis of increased risk of death of lung cancer patients. The invention also provides methods of use of the gene marker sets for classification. The invention is particularly suited to the generation of microarrays and other high-throughput platforms for diagnostic and prognostic purposes.

### FIELD OF THE INVENTION

The present invention relates to gene marker sets for use in classification of cancer patients on the basis of expression of multiple biological markers, and methods of use therefor. The invention is particularly suited to the generation of microarrays and other high-throughput platforms for diagnostic and prognostic purposes, although it will be appreciated that the invention may have wider applicability.

### BACKGROUND TO THE INVENTION

It has long been recognised that diagnosis and treatment of disease on the basis of epidemiologic studies may not be ideal, especially when the disease is a complex one having multiple causative factors and many subtypes with possibly wildly varying outcomes for the patient. This has recently led to an increased emphasis on so-called “personalised medicine”, whereby specific characteristics of the individual are taken into account when providing care.

An important development in the move towards personalised care has been the ability to identify molecular markers which are associated with a particular disease state, predictive of the individual's chance of relapse/recurrence or response to a particular treatment.

In cancer cases where a tumor has metastasized, it is important to determine the tissue of origin of the tumor. The current diagnostic standard in such cases includes imaging, serum tests and immunohistochemistry (IHC) using one or more of a panel of known antibodies of different tumor specificity [Burton, et al. 1998, Jama: 280; Pavlidis, et al. 2003, Eur J Cancer: 39; Varadhachary, et al. 2004, Cancer: 100]. For approximately 3-5% of all cases, known as Cancer of Unknown Primary (CUP), these conventional approaches do not reach a definitive diagnosis, although some may eventually be solved with further, more extensive investigations [Horlings, et al. 2008, J Clin Oncol: 26]. The range of tests able to be performed can depend not only on an individual patient's ability to tolerate potentially invasive, costly and time consuming diagnostic procedures, but also on the diagnostic tools at the clinician's disposal, which may vary between hospitals and countries.

In relation to breast cancer, the estrogen receptor (ER) or HER2/neu (ERBB-2) status of a tumor can be used in determining a patient's suitability for therapies that target these molecules in the tumor cells. These molecular markers are examples of “companion diagnostics” which are used in conjunction with traditional tests such as histological status in order to determine a patient's risk of disease recurrence and therefore to guide treatment regimes, based on the estimated risk.

In relation to colon cancer, a similar paradigm exists, in which the decision whether to treat patients with non-metastatic colon cancer using adjuvant chemotherapy is predominantly determined by clinical staging (i.e. extent of tumor spread of the tumor at the time of diagnosis), frequently resulting in over- or under-treatment.

In relation to lung cancer, tumors that are detected in the early stages of disease progression present a challenge to physicians. While surgery and/or radiotherapy are curative for many patients in this category, a proportion will experience a rapid progression of their tumor and subsequently die of their disease within 2-5 years. Furthermore, treating all early-stage lung tumors with chemotherapy results in varying levels of response, with some patients experiencing disease remission and high rates of disease-free survival at 3-5 years, and others exhibiting no benefit from receiving the same course of treatment.

To date, most diagnostic protocols are primarily reliant on microscopy, single gene or immunohistochemical biomarkers (IHC) and imaging techniques such as magnetic-resonance imaging (MRI) and positron emission tomography (PET). Unfortunately, these techniques all have limitations and may not provide adequate information to accurately predict patient outcome, response to treatment or to diagnose the primary origin of metastasized tumors or poorly differentiated malignancies.

It has been hypothesized that the information gained from gene expression profiling can be used as a companion diagnostic to the above protocols, helping to confirm or refine the predicted primary origin of metastatic/poorly differentiated tumors, or predict a patients' chance of disease recurrence (i.e. prognosis), in the case of pre-metastatic breast and colon cancer.

Since the advent of various robotic and high throughput genomic technologies, including quantitative polymerase chain reaction (qPCR) and microarrays, several groups have investigated the use of gene expression data to predict the primary origin of a metastatic tumor [Bloom, et al. 2004, The American journal of pathology: 164; Dumur, et al. 2008, J Mol Diagn: 10; Ma, et al. 2006, 130; Tothill, et al. 2005, Cancer Res: 65; van Laar, et al. 2009, Int J Cancer: 125]. Prediction accuracies in the literature range from 78% to 89%.

A number of gene expression based, commercial diagnostic services have arisen since the sequencing of the human genome, offering a range of personalized diagnostic and prognostic assays. These services represent a significant advance in patient access to personalized medicine. However the requirement of shipping fresh or preserved human tissue to an interstate or international reference laboratory has the potential to expose sensitive biological molecules to adverse weather conditions and logistical delays. In some parts of the world it may also be prohibitively expensive to ship human tissue to a reference laboratory in a timely fashion, thus limiting access to this new technology.

The present invention provides a method for diagnosis and/or prognosis of a cancer patient, and provides defined sets of gene markers which can be used to determine tumor tissue origin, the likelihood of breast cancer recurrence and death, the likelihood of colon cancer recurrence and death, the prognosis of increased risk of death of lung cancer patients, and predicts adjuvant chemotherapy response in lung cancer patients.

### SUMMARY OF THE INVENTION

The invention provides gene marker sets that identify the tissue of origin of a metastatic tumor, provide prognostic data on breast cancer recurrence, prognostic data on colon cancer recurrence in cancer patients, or prognosis of increased risk of death of lung cancer patients, and methods of use thereof.

Accordingly, in a first aspect, the present invention provides a method for classifying a biological test sample from a cancer patient, including the steps of:

selecting a set of marker molecules from;
a) any combination of 100 or more of the polynucleotides listed in Table 1, wherein the polynucleotides are represented by oligonucleotide probes described by SEQ ID NOS: 1-24196;
b) any combination of 100 or more of the polynucleotides listed in Table 3, wherein the polynucleotides are represented by oligonucleotide probes described by SEQ ID NOS: 171-270 and 25777-27864;
c) any combination of 15 or more of the polynucleotides listed in Table 6, wherein the polynucleotides are represented by oligonucleotide probes described by SEQ ID NOS: 1-170 and 24197-25776;
d) any combination of 2 or more of the polynucleotides listed in Table 8, wherein the polynucleotides are represented by oligonucleotide probes described by SEQ ID NOS: 1-11, 171-183, 271-383, 25777-25787 and 27865-29496; and
e) any combination of 2 or more of the polynucleotides listed in Table 9, wherein the polynucleotides are represented by oligonucleotide probes described by SEQ ID NOS: 384-476, 27865-27880 and 29497-29809,

providing a database populated with reference expression data, the reference expression data including expression levels of a plurality of molecules in a plurality of reference samples, the plurality of molecules including at least the marker molecules, each reference sample having a pre-assigned value for each of one or more clinically significant variables selected from the group including disease state, disease prognosis, and treatment response;

accepting input expression data, the input expression data including a test vector of expression levels of the marker molecules in the biological test sample; and

assigning one of said pre-assigned values to the test sample for at least one of said clinically significant variables by passing the test vector to a statistical classification program;

wherein the statistical classification program has been trained to distinguish among said pre-assigned values on the basis of that part of the reference data corresponding to expression levels of the marker molecules.

The database may be in communication with a server computer which is interconnected to at least one client computer by a data network, said server computer being configured to accept the input expression data from the client computer.

Hosting the database on a server and allowing remote upload can improve the speed and efficiency of diagnosis. The clinician, having conducted a biopsy and assayed the sample (either themselves, or via a service laboratory located on site or nearby) to obtain a data file containing the expression levels of the marker molecules, can then simply upload the data file to the server for analysis and receive the test results within a short space of time, possibly within seconds. The server may reside on an internal network to which the clinician has access, or may be located on a wide area network, for example in the form of a Web server. The latter is particularly advantageous as it allows hosting and maintenance of a server accessing a large database of samples in one location, while a clinician located anywhere in the world and having access to relatively modest local resources can upload a data file to obtain a diagnosis based on a comprehensive set of annotated samples, such an analysis otherwise being inaccessible to the clinician.

In the case of cancer, the clinically significant variables may be organised according to a hierarchy, the levels of which may be selected from the group consisting of anatomical system, tissue type and tumor subtype. In that case, the classification program may include a multi-level classifier which classifies the test sample according to anatomical system, then tissue type, then tumor subtype. This provides a multi-marker, multi-level classification which is analogous to, but independent of, traditional approaches to diagnosis of tumor origin.

The marker molecules may include any combination of 100 or more of the polynucleotides listed in Table 1, wherein the polynucleotides are represented by oligonucleotide probes described by SEQ ID NOS: 1-24196. We have found that sets of 100 or more of these molecules can provide a classification accuracy of greater than 94% for anatomical system and greater than 92% for tissue type.

In another embodiment, the disease is breast cancer, in which case the clinically significant variable may be risk of recurrence of the disease. The marker molecules in this embodiment may include sets of 100 or more of the polynucleotides listed in Table 3, wherein the polynucleotides are represented by oligonucleotide probes described by SEQ ID NOS: 171-270 and 25777-27864. Preferably, a set of the 200 polynucleotides listed in Table 3 is used. This is a prognostic, rather than diagnostic, application of the invention.

In another embodiment, the disease is colon cancer, in which case the clinically significant variable may be risk of recurrence of the disease. The marker molecules in this embodiment may include sets of 15 or more of the polynucleotides listed in Table 6, wherein the polynucleotides are represented by oligonucleotide probes described by SEQ ID NOS: 1-170 and 24197-25776. Preferably, a set of the 163 polynucleotides listed in Table 6 is used.

In another embodiment, the disease is lung cancer, more particularly non-small-cell-lung cancer, in which case the clinically significant variable may be to identify patients with stage I/II adenocarcinoma who are at increased risk of death. The marker molecules in this embodiment may include sets of 2 or more of the polynucleotides listed in Table 8, wherein the polynucleotides are represented by oligonucleotide probes described by SEQ ID NOS: 1-11, 171-183, 271-383, 25777-25787 and 27865-29496. Preferably, a set of the 160 polynucleotides listed in Table 8 is used. This is also a prognostic application of the invention.

In another embodiment, the disease is lung cancer, more particularly non-small-cell-lung cancer, in which case the clinically significant variable may be to predict adjuvant chemotherapy (ACT) response in patients with non-small-cell lung cancer. The marker molecules in this embodiment may include sets of 2 or more of the polynucleotides listed in Table 9, wherein the polynucleotides are represented by oligonucleotide probes described by SEQ ID NOS: 384-476, 27865-27880 and 29497-29809. Preferably, a set of the 37 polynucleotides listed in Table 9 is used.

In a particularly preferred embodiment, the reference expression data may be generated using a platform selected from the group including cDNA microarrays, oligonucleotide microarrays, protein microarrays, microRNA (miRNA) arrays, and high-throughput quantitative polymerase chain reaction (qPCR). Microarrays can be produced on any suitable solid support known in the art, the more preferable supports being plastic or glass.

Oligonucleotide microarrays are particularly preferred for use in the present invention. If this type of microarray is used, each molecule being assayed is a polynucleotide, which may either be represented by a single probe on the microarray or by multiple probes, each probe having a different nucleotide sequence corresponding to part of the polynucleotide. If multiple probes are present, one of said analysis programs might include instructions for summarising the expression levels of the multiple probes into a single expression level for the polynucleotide.

Oligonucleotide microarrays such as those manufactured by Affymetrix, Inc and marketed under the trademark GeneChip currently represent the vast majority of microarrays in use for gene (and other nucleotide) expression studies. As such, they represent a standardised platform which particularly lends itself to collation of large databases of expression data, for example from cancer patients, in order to provide a basis for diagnostic or prognostic applications such as those provided by the present invention.

Preferably, the input expression data are generated using the same platform as the reference expression data. If the input expression data are generated using a different platform, then the identifiers of the molecules in the input data are matched to the identifiers of the molecules in the reference data prior to performing classification, for example on the basis of sequence similarity, or by any other suitable means such as on the basis of GenBank accession number, Refseq or Unigene ID.

Preferably, the statistical classification program includes an algorithm selected from the group including k-nearest neighbors (kNN), linear discriminant analysis, principal components analysis (PCA), nearest centroid classification (NCC) and support vector machines (SVM).

In a further aspect of the present invention, there is provided a method of classifying a biological test sample from a cancer patient, including the step of:

comparing expression levels in the test sample of a set of marker molecules, selected from;
a) any combination of 100 or more of the polynucleotides listed in Table 1, wherein the polynucleotides are represented by oligonucleotide probes described by SEQ ID NOS: 1-24196;
b) any combination of 100 or more of the polynucleotides listed in Table 3, wherein the polynucleotides are represented by oligonucleotide probes described by SEQ ID NOS: 171-270 and 25777-27864;
c) any combination of 15 or more of the polynucleotides listed in Table 6, wherein the polynucleotides are represented by oligonucleotide probes described by SEQ ID NOS: 1-170 and 24197-25776;
d) any combination of 2 or more of the polynucleotides listed in Table 8, wherein the polynucleotides are represented by oligonucleotide probes described by SEQ ID NOS: 1-11, 171-183, 271-383, 25777-25787 and 27865-29496; and
e) any combination of 2 or more of the polynucleotides listed in Table 9, wherein the polynucleotides are represented by oligonucleotide probes described by SEQ ID NOS: 384-476, 27865-27880 and 29497-29809;
   to expression levels of said set of marker molecules in a set of reference samples, each member of the set of reference samples having a known clinical annotation, to assign a clinical annotation to the test sample,

wherein the clinical annotation is selected from the group including anatomical system, tissue of origin, tumor subtype, risk of cancer recurrence, prognosis of increased risk of death, and prediction of adjuvant chemotherapy response.

In a yet further aspect, the present invention provides use of a set of marker molecules including any combination of 100 or more of the polynucleotides listed in Table 1, wherein the polynucleotides are represented by oligonucleotide probes described by SEQ ID NOS: 1-24196, in a method of classifying a biological test sample from a cancer patient, including the step of:

comparing expression levels of the set of marker molecules in the test sample to expression levels of said set of marker molecules in a set of reference samples, each member of the set of reference samples having a known clinical annotation, to assign a clinical annotation to the test sample,

wherein the clinical annotation is selected from the group including anatomical system, tissue of origin, and tumor subtype.

In a yet further aspect, the present invention provides use of a set of marker molecules including the polynucleotides listed in Table 3, wherein the polynucleotides are represented by oligonucleotide probes described by SEQ ID NOS: 171-270 and 25777-27864, in a method of classifying a biological test sample from a cancer patient with breast cancer, including the step of:

comparing expression levels of the set of marker molecules in the test sample to expression levels of said set of marker molecules in a set of reference samples, each member of the set of reference samples having a known clinical annotation, to assign a clinical annotation to the test sample,

wherein the clinical annotation is risk of breast cancer recurrence.

In a yet further aspect, the present invention provides use of a set of marker molecules including the polynucleotides listed in Table 6, wherein the polynucleotides are represented by oligonucleotide probes described by SEQ ID NOS: 1-170 and 24197-25776, in a method of classifying a biological test sample from a cancer patient with colon cancer, including the step of:

comparing expression levels of the set of marker molecules in the test sample to expression levels of said set of marker molecules in a set of reference samples, each member of the set of reference samples having a known clinical annotation, to assign a clinical annotation to the test sample,

wherein the clinical annotation is risk of colon cancer recurrence.

In a yet further aspect, the present invention provides use of a set of marker molecules including the polynucleotides listed in Table 8, wherein the polynucleotides are represented by oligonucleotide probes described by SEQ ID NOS: 1-11, 171-183, 271-383, 25777-25787 and 27865-29496, in a method of classifying a biological test sample from a cancer patient with lung cancer, including the step of:

comparing expression levels of the set of marker molecules in the test sample to expression levels of said set of marker molecules in a set of reference samples, each member of the set of reference samples having a known clinical annotation, to assign a clinical annotation to the test sample,

wherein the clinical annotation is prognosis of increased risk of death.

In a yet further aspect, the present invention provides use of a set of marker molecules including the polynucleotides listed in Table 9, wherein the polynucleotides are represented by oligonucleotide probes described by SEQ ID NOS: 384-476, 27865-27880 and 29497-29809, in a method of classifying a biological test sample from a cancer patient with lung cancer, including the step of:

comparing expression levels of the set of marker molecules in the test sample to expression levels of said set of marker molecules in a set of reference samples, each member of the set of reference samples having a known clinical annotation, to assign a clinical annotation to the test sample,

wherein the clinical annotation is prediction of adjuvant chemotherapy response.

In a yet further aspect, the present invention provides a set of marker molecules, for use in classifying a biological test sample from a cancer patient, selected from the group;
a) any combination of 100 or more of the polynucleotides listed in Table 1, wherein the polynucleotides are represented by oligonucleotide probes described by SEQ ID NOS: 1-24196;
b) any combination of 100 or more of the polynucleotides listed in Table 3, wherein the polynucleotides are represented by oligonucleotide probes described by SEQ ID NOS: 171-270 and 25777-27864;
c) any combination of 15 or more of the polynucleotides listed in Table 6, wherein the polynucleotides are represented by oligonucleotide probes described by SEQ ID NOS: 1-170 and 24197-25776;
d) any combination of 2 or more of the polynucleotides listed in Table 8, wherein the polynucleotides are represented by oligonucleotide probes described by SEQ ID NOS: 1-11, 171-183, 271-383, 25777-25787 and 27865-29496; and
e) any combination of 2 or more of the polynucleotides listed in Table 9, wherein the polynucleotides are represented by oligonucleotide probes described by SEQ ID NOS: 384-476, 27865-27880 and 29497-29809.

In a yet further aspect, the present invention provides a set of marker molecules for use in classifying a biological test sample from a cancer patient wherein the marker molecule set includes 100 or more of the polynucleotides listed in Table 1, wherein the polynucleotides are represented by oligonucleotide probes described by SEQ ID NOS: 1-24196.

In a yet further aspect, the present invention provides a set of marker molecules for use in classifying a biological test sample from a cancer patient, wherein the marker molecule set includes the 200 polynucleotides listed in Table 3, wherein the polynucleotides are represented by oligonucleotide probes described by SEQ ID NOS: 171-270 and 25777-27864.

In a yet further aspect, the present invention provides a set of marker molecules for use in classifying a biological test sample from a cancer patient, wherein the marker molecule set includes the 163 polynucleotides listed in Table 6, wherein the polynucleotides are represented by oligonucleotide probes described by SEQ ID NOS: 1-170 and 24197-25776.

In a yet further aspect, the present invention provides a set of marker molecules for use in classifying a biological test sample from a cancer patient, wherein the marker molecule set includes the 160 polynucleotides listed in Table 8, wherein the polynucleotides are represented by oligonucleotide probes described by SEQ ID NOS: 1-11, 171-183, 271-383, 25777-25787 and 27865-29496.

In a yet further aspect, the present invention provides a set of marker molecules for use in classifying a biological test sample from a cancer patient, wherein the marker molecule set includes the 37 polynucleotides listed in Table 9, wherein the polynucleotides are represented by oligonucleotide probes described by SEQ ID NOS: 384-476, 27865-27880 and 29497-29809.

Further, a preferred aspect of the invention relates to microarrays specific for each diagnostic or prognostic test which include the specifically disclosed marker sets.

In one embodiment, the invention provides microarrays which include a substrate and at least 100 markers selected from any one of Tables 1, 3, 6, 8 or 9 attached to the substrate.

In a more specific embodiment, at least 80%, 90%, 95% or 100% of the markers defined in Tables 1, 3, 6, 8 and 9 are on a single microarray or, alternatively, on separate test-specific microarrays.

In a preferred embodiment a microarray may include a substrate and oligonucleotide probes representing the marker sets from one or more of Tables 1, 3, 6, 8 and 9 attached thereto.

In another preferred embodiment a microarray for testing tumor tissue origin will include a substrate and oligonucleotide probes representing markers from Table 1 attached thereto, whereas a microarray for prognosis of breast cancer recurrence will include a substrate and oligonucleotide probes representing markers from Table 3 attached thereto, a microarray for prognosis of colon cancer recurrence will include a substrate and oligonucleotide probes representing markers from Table 6 attached thereto, a microarray for prognosis of increased risk of death in lung cancer patients will include a substrate and oligonucleotide probes representing markers from Table 8 attached thereto, and a microarray for predicting adjuvant chemotherapy benefit in lung cancer patients will include a substrate and oligonucleotide probes representing markers from Table 9 attached thereto.

### BRIEF DESCRIPTION OF THE DRAWINGS

FIG. 1 is a schematic of a system suitable for methods of the present invention;

FIG. 2 schematically shows the steps of an exemplary method in accordance with the invention;

FIG. 3 shows a schematic of another embodiment in which user requests are processed in parallel;

FIG. 4 shows the position of samples belonging to a reference data set in multi-dimensional expression data space;

FIG. 5 summarises clinical annotations of reference samples in a reference data set used in one of the Examples;

FIGS. 6(a) and 6(b) show the classification accuracy for a multi-level classifier as used in one of the Examples;

FIGS. 7(a) and 7(b) show cross-validation results for a classification program used in another Example; and

FIGS. 8(a) and 8(b) show independent validation results for the classification program used in the Example of FIGS. 7(a) and 7(b).

FIGS. 9(a) and 9(b) shows the cross validation accuracy of the colon cancer classifier, using subsets of the full 163-gene model.

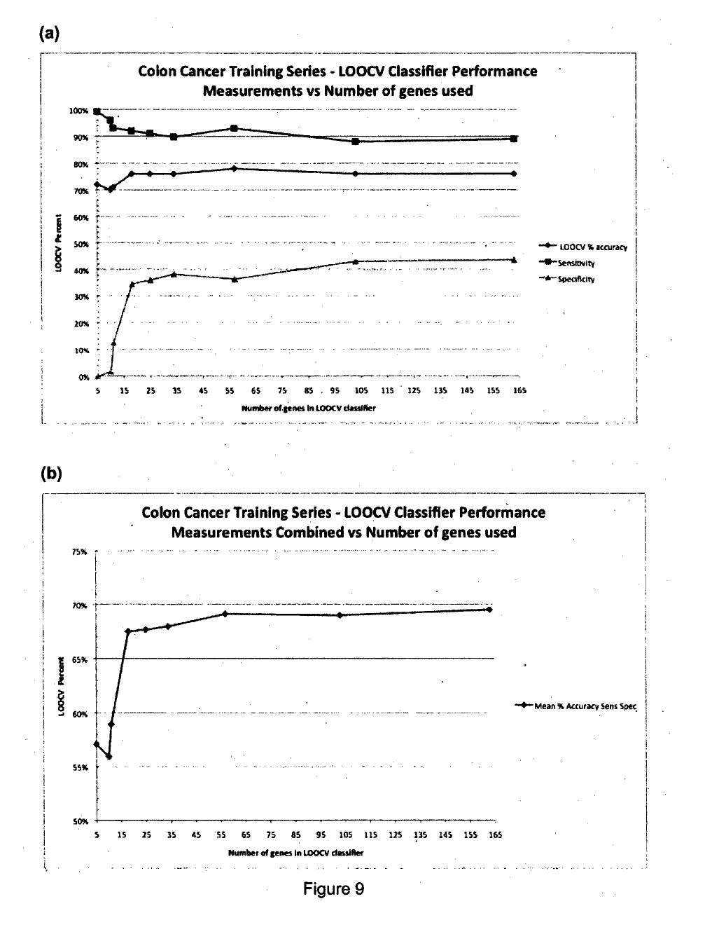

FIGS. 10(a) and 10(b) shows the cross validation accuracy of the breast cancer classifier, using subsets of the full 200-gene model.

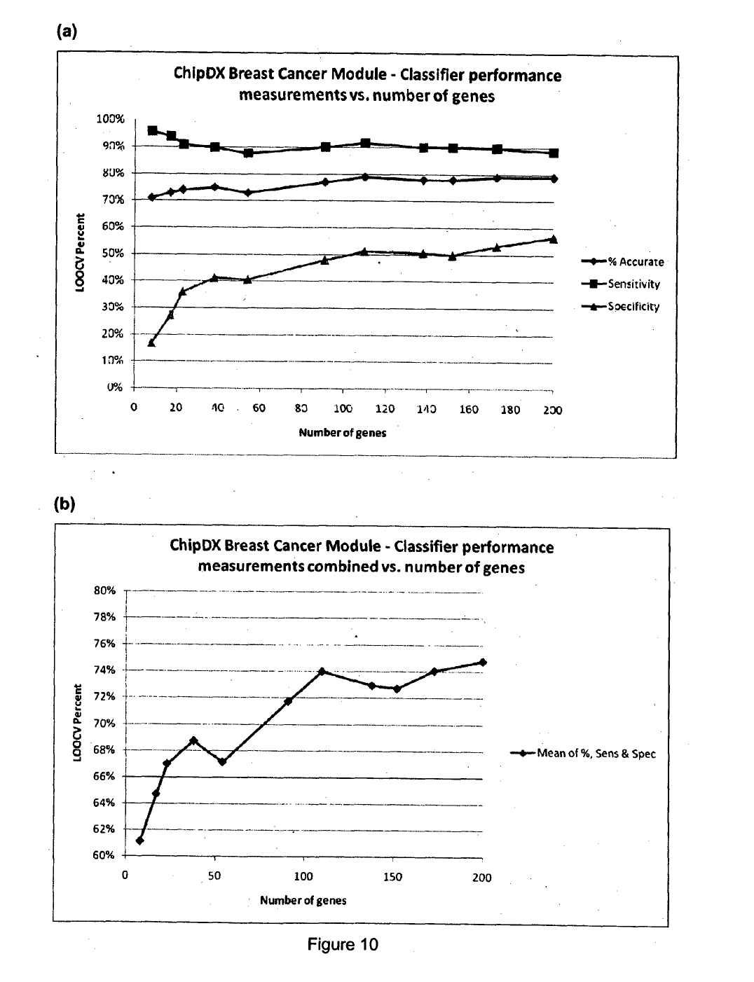

FIG. 11 shows the 200 gene set used by the breast cancer classifier, as measured in the training series of patients used to derive the signature, in addition to the clinical details for each patient, their disease recurrence status and prognostic index.

FIG. 12 shows the 163 gene set used by the colon cancer classifier, as measured in the training series of patients used to derive the signature, in addition to the clinical details for each patient, their disease recurrence status and prognostic index.

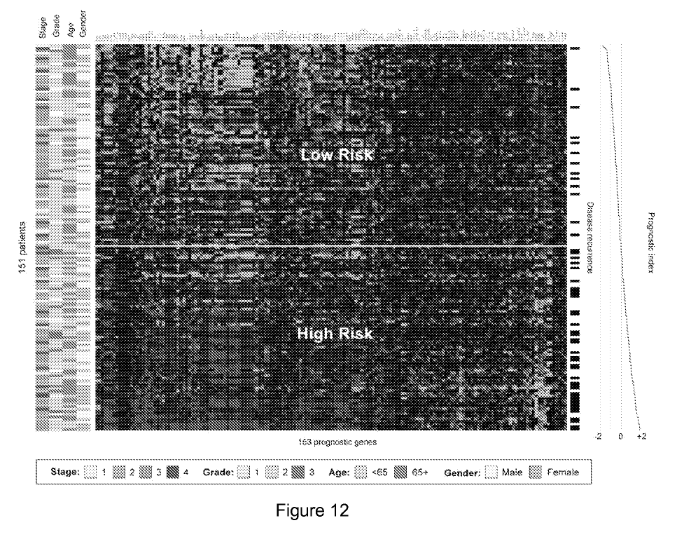

FIG. 13 shows a gene expression heat map of the 160-gene signature in 301 patients from training series A. The association between the gene expression profile (red=relative high expression, green=relative low expression) the prognostic index calculated from these values and patient outcome (disease-specific death within 3 years) can be observed. Each gene in the signature is significantly associated with outcome, independent to age, stage, grade, gender and smoking history.

FIG. 14 shows Kaplan Meier analysis of validation series A patients, stratified by gene expression risk group and clinical stage. Validation series A Stage I patients (N=190) classified based on (C) American Joint Committee on Cancer (AJCC) clinical stage, (D) a clinical algorithm based on tumor size and age at diagnosis and (E) the 160-gene signature. The gene expression signature is able to more accurately identify stage I patients at risk of death within the first 12-24 months following diagnosis compared to stage sub-groups and the combined clinical age+tumor size algorithm.

FIG. 15 shows Kaplan Meier analysis: 37-gene signature treatment response predictions for independent validation series B. Patients in (A) Predicted ‘ACT’ benefit group exhibit significantly improved rate of Disease-specific-survival (DSS) when treated with ACT compared to OBS alone. Patients in (B) Predicted ‘No ACT benefit’ group do not exhibit a significant difference in DSS between either treatment arm of the trial.

### DESCRIPTION OF PREFERRED EMBODIMENTS

In the following discussion, embodiments of the invention will be described mostly by reference to examples employing Affymetrix GeneChips, which are a suitable platform for the gene marker sets of the invention. However, it will be understood by the skilled person that the methods and systems described herein may be readily adapted for use with other types of oligonucleotide microarray, or other measurement platforms. Microarray technology is now well known, in respect of types of microarrays and methods of use (for example; [Hoheisel 2006, Nat Rev Genet: 7]).

The terms “gene”, “probe set”, “marker set”, and “molecule” are used interchangeably for the purposed of the preferred embodiments described herein, but are not to be taken as limiting on the scope of the invention.

The invention provides sets of genetic markers whose expression in cancer patients can be used to determine tumor tissue origin, the likelihood of breast cancer recurrence, or the likelihood of colon or lung cancer recurrence. The respective gene marker sets are listed in Tables 1, 3, 6, 8 and 9 and, more specifically, the oligonucleotide probes for each gene of the respective gene set are provided in the Sequence Listing appended to this application.

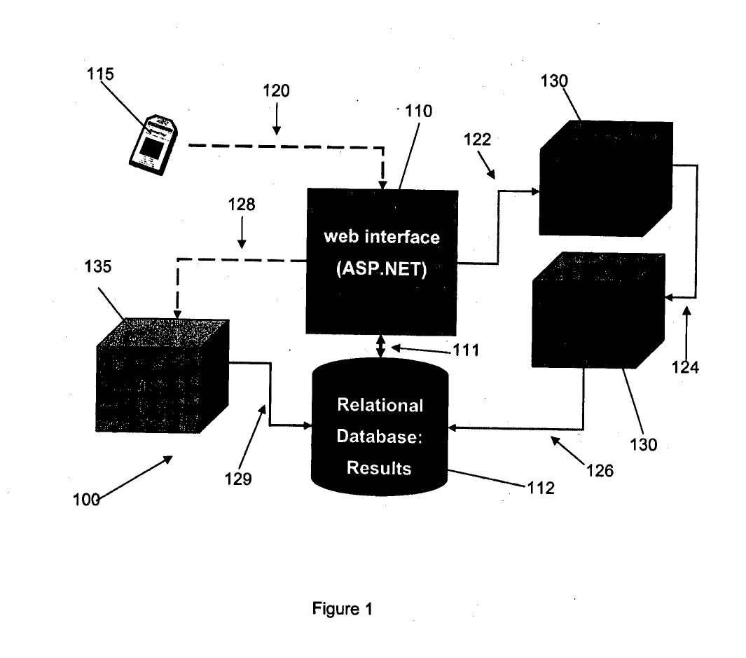

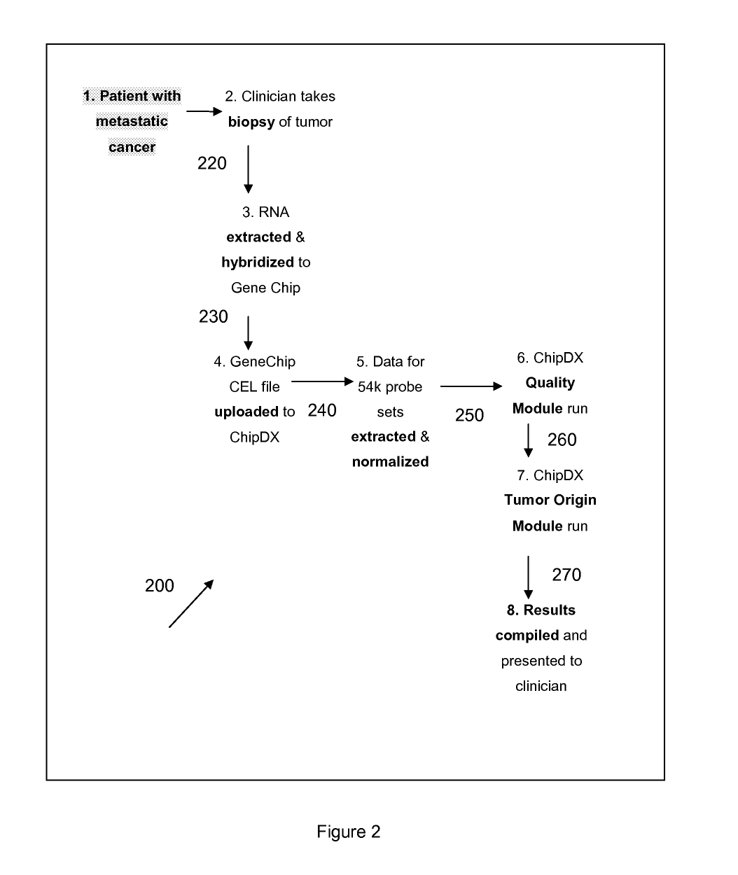

Referring to FIGS. 1 and 2, there is shown in schematic form a system 100 and method 200 for classifying a biological test sample. The sample is acquired 220 by a clinician and then treated 230 to extract, fluorescently label and hybridise RNA to microarray 115 according to standard protocols prescribed by the manufacturer of the microarray. Following hybridisation, the surface of the microarray is scanned at high resolution to detect fluorescence from regions of the surface corresponding to different RNA species. In the case of Affymetrix arrays, each scanned “feature” region contains hundreds of thousands of identical oligonucleotides (25mers), which hybridise to any complementary fluorescently labelled molecules present in the test sample. The fluorescence intensity detected from each feature region is thus correlated with the abundance (expression level) of the complementary sequence in the test sample.

The scanning step results in the production of a raw data file (a CEL file), which contains the intensity values (and other information) for each probe (feature region) on the array. Each probe is one of the 25mers described above and forms part of one of a multiplicity of “probe sets”. Each probe set contains multiple probes, usually 11 or more for a gene expression microarray. A probe set usually represents a gene or part of a gene. Occasionally, a gene will be represented by more than one probe set.

Once the CEL file is obtained, the user may upload it (step 120 or 240) to server 110.

### Accepting Input Data

In the preferred embodiments, the system is implemented using a network including at least one server computer 110, for example a Web server, and at least one client computer. Software running on the Web server can be used to accept the input data file (CEL file) containing the multiple molecule abundance measurements (probe signals) for a particular patient from the client computer over a network connection. This information is stored in the system user's dedicated directory on a file server, with upload filenames, date/time and other details stored in a relational database 112 to allow for later retrieval.

The Web server 110 subsequently allows the user to select individual CEL files for analysis by a list of available diagnostic and prognostic methods, the list being able to be configured to add new methods as they are implemented. Results from the specific analysis requested, in the format of text, numbers and images, are also stored in the relational database 112 and delivered to the user via the Web server 110. All data generated by a particular user is linked to a unique identifier and can be retrieved by the user by logging into to the Web server 110 using a username and password combination.

When an analysis is requested by the user, at step 122, the raw data from the CEL file are passed to a processor, which executes a program 130a contained on a storage medium, which is in communication with the processor.

### Accepting Clinical Data Input

In conjunction with the file that contains the multiple molecule abundance measurements (probe signals) for a particular patient, the user can also be asked to input other information about the patient. This information can be used for predictive, prognostic, diagnostic or other data analytical purposes, independently or in association with the molecular data. These variables can include patient age, gender, tumor grade, estrogen receptor status, Her-2 status, or other clinico-pathological assessments. An electronic form can be used to collect this information, which the user can submit to a secure relational database.

Algorithms that combine ‘traditional’ clinical variables or patient demographic data and molecular data can result in more statistically significant results than algorithms that use only one or the other. The ability to collect and analyse all three types of data is a particularly advantageous aspect of at least some embodiments of the invention.

### Low Level Analysis

Program 130a is a low-level analysis module, which carries out steps of background correction, normalisation and probe set summarisation (grouped as step 250 in FIG. 2).

Background adjustment is desirable because the probe signals (fluorescence intensities) include signal from non-biological sources, such as optical and electronic noise, and non-specific binding to sequences which are not exactly complementary to the sequence of the probe. A number of background adjustment methods are known in the art. For example, Affymetrix arrays contain so-called ‘MM’ (mismatch) probes which are located adjacent to ‘PM’ (perfect match) probes on the array. The sequence of the MM probe is identical to that of the PM probe, except for the 13^{th} base in its sequence, and accordingly the MM probes are designed to measure non-specific binding. A number of known methods use functions of PM-MM or log₂(PM)-log₂(MM) to derive a background-adjusted probe signal, for example the Ideal Mismatch (IM) method used by the Affymetrix MAS 5.0 software (Affymetrix, “Statistical Algorithms Description Document” (2002), Santa Clara, Calif., incorporated herein in its entirety by reference). Other methods ignore MM, for example the model-based adjustment of Irizarry et al [Irizarry, et al. 2003, Biostatistics: 4], or use sequence-based models of non-specific binding to calculate an adjusted probe signal [Wu, et al. 2004, Journal of the American Statistical Association: 99].

Normalisation is generally required in order to remove systematic biases across arrays due to non-biological variation. Methods known in the art include scaling normalisation, in which the mean or median log probe signal is calculated for a set of arrays, and the probe signals on each array adjusted so that they all have the same mean or median; housekeeping gene normalisation, in which the probe or probe set signals for a standard set of genes (known to vary little in the biological system of interest) in the test sample are compared to the probe signals of that same set of genes in the reference samples, and adjusted accordingly; and quantile normalisation, in which the probe signals are adjusted so that they have the same empirical distribution in the test sample as in the reference samples [Bolstad, et al. 2003, Bioinformatics: 19].

If the arrays contain multiple probes per probe set, then these can be summarised by program 130a in any one of a number of ways to obtain a probe set expression level, for example by calculating the Tukey bi-weight of the log (PM-IM) values for the probes in each probe set (Affymetrix, “Statistical Algorithms Description Document” (2002)).

### Quality Control

Once the low-level analysis is completed, the background-corrected, normalised and, if necessary, summarised, data can be processed according to known methods. One such method is described in U.S. 61/247,802 (Van Laar, R.), incorporated herein by reference in its entirety.

### Predictive Analysis

The test sample proceeds (step 270) to predictive analysis as carried out by statistical classification program 135, which is used to assign a value of a clinically relevant variable to the sample. Such clinical parameters could include:
The primary tissue of origin for a biopsy of metastatic cancer;
The molecular similarity to patients who do or do not experience disease relapse with a defined time period after their initial treatment;
The molecular similarity to patients who respond poor or well to a particular type of therapeutic agent;
The status of clinico-pathological markers used in disease diagnosis and patient management, including ER, PR, Her2, angiogenesis markers (VEGF, Notch), Ki67, colon cancer markers etc.;
Possible chromosomal aberrations, including deletions and amplifications of part or whole of a chromosome;
The molecular similarity to patients who respond poor or well to a particular type of radiotherapy;
Other methods that may be developed by 3^{rd} party developers and implemented in the system via an Application Programming Interface (API).

The predictive algorithms used in at least some embodiments of the present invention function by comparing the data from the test sample, to the series of reference samples for which the variable of interest is confidently known, usually having been determined by other more traditional means. The series of known reference samples can be used as individual entities, or grouped in some way to reduce noise and simplify the classification process.

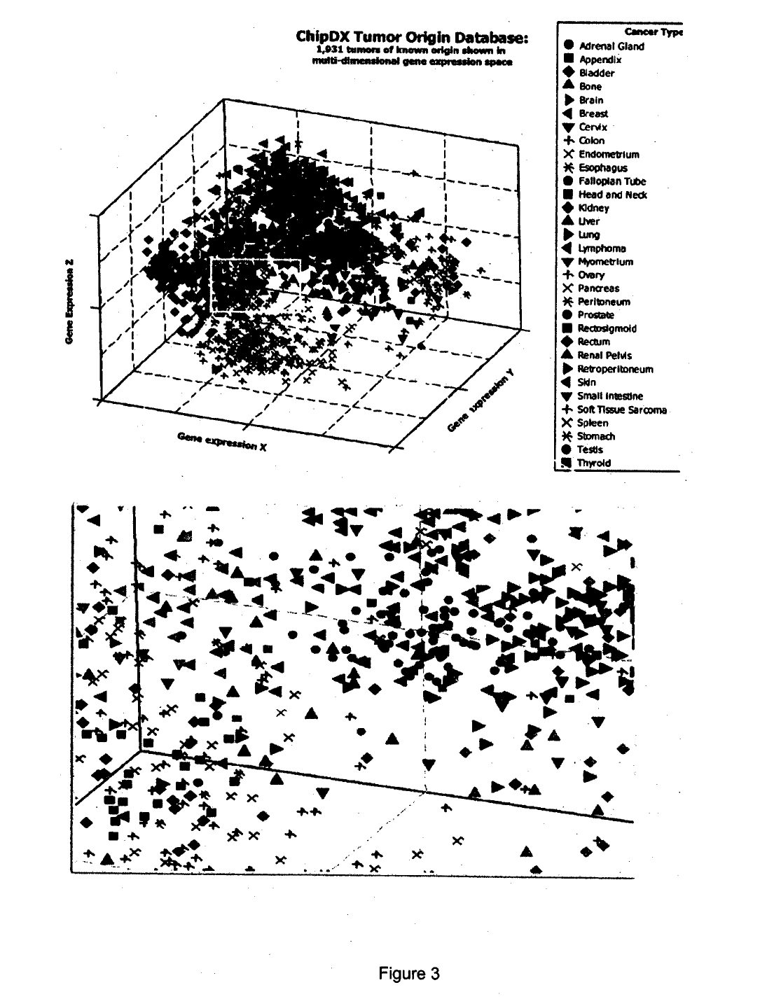

Algorithms such as the K-nearest neighbour (KNN) algorithm use each reference sample of known type as separate entities. The selected genes/molecules (probe sets) are used to project the known samples into multi-dimensional gene/molecule space as shown in FIG. 3, in which the first three principal components for each sample are plotted. The number of dimensions is equal to the number of genes. The test sample is then inserted into this space and the nearest K reference samples are determined, using one of a range of distance metrics, for example the Euclidean or Mahalanobis distance between the points in the multi-dimensional space. Evaluating the classes of the nearest K reference samples to the test sample and determining the weighted or non-weighted majority class present can then be used to infer the class of the test sample.

The variation of classes present in the K nearest neighbors can also be used as a confidence score. For example, if 4 out of 5 of the nearest neighbour samples to a given test sample were of the same class (eg Ovarian cancer) the predicted class of the test sample would be Ovarian cancer, with a confidence score of 4/5=80%.

Other methods of prediction rely on creating a template or summarized version of the data generated from the reference samples of known class. One way this can be done is by taking the average of each selected gene across clinically distinct groups of samples (for example, those individuals treated with a particular drug who experience a positive response compared to those with the same disease/treatment who experience a negative or no response). Once this template has been determined, the class of a test sample can be inferred by calculating a similarity score to one or both templates. The similarity score can be a correlation coefficient.

Classifiers such as the nearest centroid classifier (NCC), linear discriminant analysis (LDA) or support vector machines (SVM) operate on this basis. LDA and SVM carry out weighting of the genes/molecules when creating the classification template, which can reduce the impact of outlier measurements and spread the classification workload evenly over all genes/molecules selected, rather than relying on a subset to contribute to a majority of the total index score calculated. This can be the case when using a simple correlation coefficient as a predictive index.

### Preparation of Reference Data Set

To make clinically useful predictions about a specimen of biological material that has been collected from an individual patient, a large database of reference data from patients with the same condition is desirable. The reference samples are preferably processed using similar, more preferably identical, laboratory processes and the reference data are ideally generated using the same type of measurement platform, for example, an oligonucleotide microarray, to avoid the need to match gene identifiers across different platforms.

The reference data can be generated from tissue specifically collected or obtained for the diagnostic test being created, or from publicly available sources, such as the NCBI Gene Expression Omnibus (GEO: http://www.ncbi.nlm.nih.gov/geo/). Clinical details about each patient can be used to determine whether the finished database accurately reflects the targeted patient population, for example with regard to age/sex/ethnicity and other relevant parameters specific to the disease of interest.

Clinical annotations can be used for analysis of the same input data at different levels. For example, cancer can be classified using a hierarchy of annotations. These begin at the system level, and then progress to unique tissues and subtypes, which are defined on the basis of pathological or molecular characteristics. The NCI Thesaurus is a source of hierarchical cancer classification information (http://nciterms.nci.nih.gov/NCIBrowser/Dictionary.do).

Histological annotations can also be used for analysis of the same input data at different levels. For example, tumors can be classified according to their cell-type, e.g. Adenocarcinoma, squamous cell carcinoma, or non-small cell carcinoma.

All data generated or obtained can be stored in organized flat files or in relational database format, such as Microsoft Access, MySQL, Oracle or Microsoft SQL Server. In this format it can be readily accessed and processed by analytical algorithms trained to use all or part of the data to predict the status of a clinically relevant parameter for a given test sample.

### Presentation of Results to User

Following execution of classification program 135, the clinical predictions are stored in relational database 112. An interface 111 from the server 110 to database 112 can be used to deliver online and offline results to the end user. Online results can be delivered in HTML or other dynamic file format, whereas portable document format (PDF) can be used for creating permanent files that can be downloaded from the interface 111 and stored indefinitely. Result information in the form of text, HTML or PDF can also be delivered to the user by electronic mail.

AJAX Web 2.0 technologies can be used to streamline the presentation of online results and general functionality of the Web site.

### Parallel Processing of Data

A single processor may be used to execute each of the programs 130a, 130b, 135 and any other analysis desired. However, it is advantageous to configure the system 100 such that each analysis module is managed by a separate processor. This allows parallel execution of different user requests to be performed simultaneously, with the results stored in a single centralized relational database 112 and structured file system.

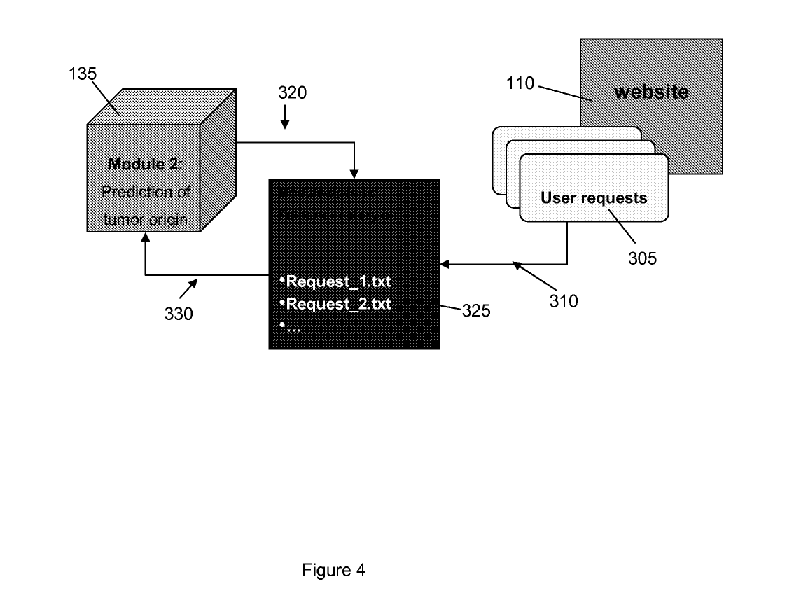

In this embodiment, illustrated schematically in FIG. 4, each module is programmed to monitor 320 a specific network directory (“trigger directory”). When the system operator requests 305 an analysis, either by uploading a new data file or requesting an additional analysis on a previously uploaded data file, the Web server 110 creates a “trigger file” in the directory 325 being monitored by the processing application. This trigger file contains the operator's unique identifier and the unique name of the data file on which to carry out the analysis.

When the classification module 135 detects (step 330) one or more trigger files, the contents of the file are read and stored temporarily in memory. The processing application then performs its preconfigured analysis routine, using the data file corresponding to the information contained in the trigger file. The data file is retrieved from the user's data directory (residing on a storage medium in communication with the server or other network-accessible computer) and read into memory in order to perform the requested calculations and other functions. Once the analysis routine is complete, the trigger file is deleted and the module 135 returns to monitoring its trigger directory for the next trigger file.

Multiple versions of the same classification module 135 can run simultaneously on different processors, all configured to monitor the same trigger directory and write or save their output to the same relational database 112 and file storage system. Alternatively, different modules in addition to classification module 135 could be run on different processors at the same time using the same input data. For processes that take several minutes (eg initial chip processing and Quality Module 130a) this enables analysis requests 305 that are submitted, while an existing request is underway, to be commenced before the completion of the first.

### Example 1

### Identification of Tumor Tissue Origin Markers

### Preparation of Reference Data

The expO data, NCBI GEO accession number GSE2109, generated by the International Genomics Consortium, was used as a reference data set to train a tumor origin classifier.

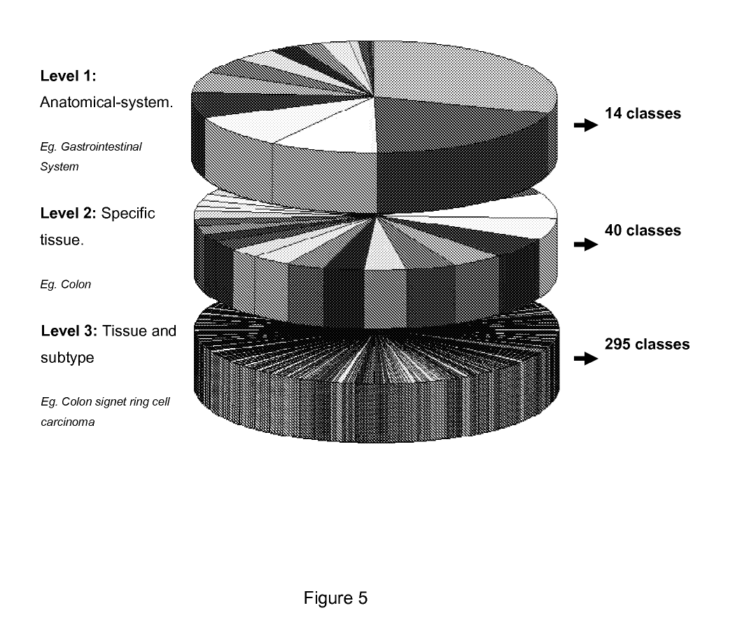

Downloaded CEL files corresponding to the reference samples were pre-processed with the algorithms from Affymetrix MAS 5.0 software and compiled into BRB ArrayTools format, with housekeeping gene normalization applied. Using the associated clinical information from GSE2109, samples were classified at 3 levels of clinical annotation; (1) anatomical system (n=13), (2) tissue (n=29) and (3) subtype (n=295), as shown in FIG. 5. For Level 1 and 2 annotations, a minimum class size of three was set. The mean class sizes for the three levels of sample annotation were: (1) 149, (2) 66 and (3) 6, correlating with number of neighbors used in the kNN algorithm (r²=0.99).

### Data Analysis and Web Service Construction

Predictive gene expression models were developed using BRB ArrayTools and translated to automated scripts in the R statistical language, incorporating functions from the Bioconductor project [Gentleman, et al. 2004, Genome biology: 5]. The Web service was constructed in the Microsoft ASP.net language (Microsoft Corporation, Redmond, USA; version 3.5) with supporting relational databases developed in Microsoft SQL Server 2008. Statistical analysis of internal cross validation and independent validation series results was performed using Minitab (Minitab Inc. State College Pa., version 15.1.3) and MedCalc (MedCalc Software, Mariakerke, Belgium).

### Selecting a Reference Array for Housekeeping Gene Based Normalization

Most cells in the human body express under most circumstances, at comparatively constant levels, a set of genes referred to as “housekeeping genes” for their role in maintaining structural integrity and core cellular processes such as energy metabolism. The Affymetrix U133 Plus 2.0 GeneChip (NCBI GEO accession number GPL 570) contains 100 probe sets that correspond to known housekeeping genes, which can be used for data normalization and quality control purposes. For normalization purposes, the 100 housekeeping genes present on a given array within the reference data set were compared to those of a specific normalization array. To select a normalization array for this test, BRB-ArrayTools was used to identify the “median” array from the entire reference data set. The algorithm used was as follows:
Let N be the number of arrays, and let i be an index of arrays running from 1 to N;
For each array i, compute the median log-intensity of the array (denoted Mᵢ);
Select a median M from the [M₁, . . . , M_{N}] values. If N is even, then the median M is the lower of the two middle values;
Choose as the median array the one for which the median log-intensity Mᵢ equals the overall median M.

Housekeeping gene normalization was applied to each array in the reference data set. The differences between the log₂ expression levels for housekeeping genes in the array and log₂ expression levels for housekeeping genes in the normalization array were computed. The median of these differences was then subtracted from the log₂ expression levels of all 54,000 probe sets, resulting in a normalized whole genome gene expression profile.

### Selection of Marker Probe Sets for Tumor-Type Discrimination

To select probe sets for the prediction of tumor origin, ‘one-v-all’ comparisons (t-tests) were performed for each tissue type in the training set (n=29) to identify probe sets which were differentially expressed in each tissue type compared to the rest of the data set. The probe sets identified by this procedure provide a characteristic gene expression signature for tumors originating in each tissue type.

In each comparison, genes that had a p-value less than 0.01 for differential expression, and a minimum fold change of 1.5 in either direction (up-regulated or down-regulated) were identified as marker probe sets. The analysis was performed using BRB ArrayTools (National Institute of Health, US). The 29 sets of marker probe sets were combined into a single list of 2221 unique probe sets, represented by oligonucleotide primer SEQ ID NOS: 1-24196, which are listed in Table 1.

The normalized expression data corresponding to these marker probe sets was retrieved from the complete 1942 reference sample×54000 probe set reference data, and this subset was passed to a kNN algorithm at both Level 1 (Anatomical-system, 5NN (nearest neighbors) used) and Level 2 (Tissue, 3NN used) clinical annotation.

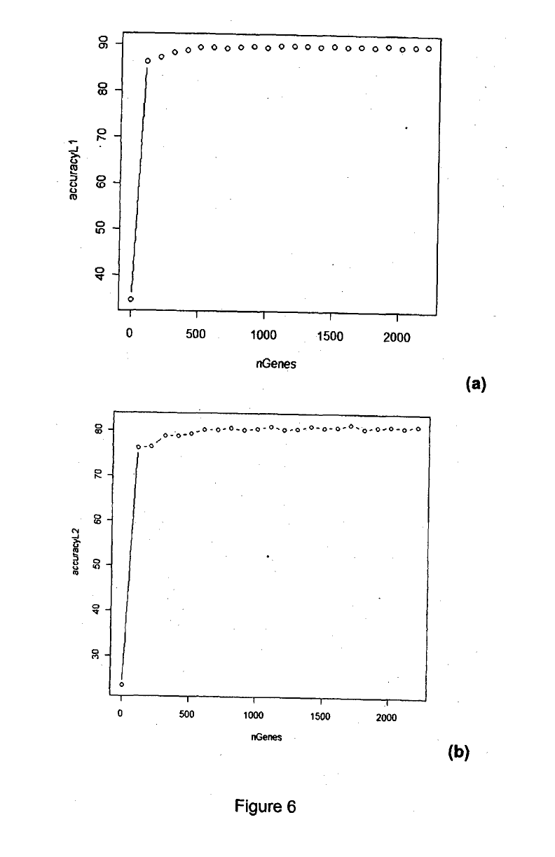

To evaluate whether a smaller set of probe sets would achieve lower misclassification rates, leave-one-out cross validation (LOOCV) of the level 1 and 2 classifiers was performed using multiples of 100 probe sets from 10 to 2220, after ranking in descending order of variance. For each cross-validation test, the percentage agreement between the true and predicted classes was recorded and this is shown in FIGS. 6(a) and 6(b). The maximum classification accuracy obtained was 90% for Level 1 and 82% for Level 2. Reducing the number of marker probe sets used did not significantly improve computation speed.

### Validation Datasets for Prediction of Tumor Origin

CEL files from 22 independent Affymetrix datasets (all Affymetrix U133 Plus 2.0) containing a total of 1,710 reference samples were downloaded from NCBI GEO and processed as previously described. These datasets represent a broad range of primary and metastatic cancer types, contributing institutes and geographic locations, as detailed in Table 2.

Of 1,461 primary tumor validation samples that passed all QC checks, the Level 1 and Level 2 classifiers predicted 92% and 82% correctly. Tumor subtype data were not available for most validation datasets; therefore percentage accuracy of this level (3) of the classifier was not calculated. The difference observed between Level 1 and Level 2 classifier accuracy is largely influenced by ovary/endometrial and colon/gastric misclassifications. As with all comparisons of novel diagnostic methods with clinically derived results, the percentage agreement is dependent on multiple factors, including the accuracy of the clinical annotation, integrity of the sample annotations and data files as well as the performance characteristics of the method itself.

General linear model analysis was performed on the proportion of correct level 1 and level 2 predictions, including tissue type (n=10) and geographic location (n=3) in a regression equation to determine if these variables were factors in overall result accuracy. For Level 1 predictions (anatomical system), no significant difference in result accuracy was observed for tissue type (P=0.13) or geographic location (P=0.86). For Level 2 predictions (tissue type), a marginally significant difference was observed with tissue type (P=0.049) but no significant difference associated with location (P=0.38). The significant difference associated with tissue type at Level 2 is most likely associated with the small sample size of some tumor types.

TABLE 2
Independent primary tumor datasets used for validation of the tumor origin classifier.
Percentage agreement with the original (clinically-determined) diagnosis.

| | | | | | | Level 2 |
|---|---|---|---|---|---|---|
| | | | | | Level 1 | classifier % |
| | | | | | classifier % | agreement |
| | | | | % samples | agreement | with |
| Cancer | | NCBI GEO | | passing all | with clinical | clinical |
| Type | Origin | Dataset ID | samples | QC checks | diagnosis | diagnosis |
| Breast | Boston, MA, USA | GSE5460 | 125 | 95% | 100% | 99% |
| Breast | San Diego, CA, | GSE7307 | 5 | 100% | 100% | 100% |
| | USA | | | | | |
| Colon | Singapore | GSE4107 | 22 | 91% | 100% | 90% |
| Colon | Zurich, Switzerland | GSE8671 | 64 | 100% | 100% | 69% |
| Gastric | Singapore | GSE15460 | 236 | 96% | 89% | 44% |
| Gastric | Singapore | GSE15459 | 200 | 95% | 96% | 54% |
| Liver | Taipei, Taiwan | GSE6222 | 13 | 85% | 91% | 91% |
| Liver | Cambridge, MA, | GSE9829 | 91 | 82% | 99% | 99% |
| | USA | | | | | |
| Lung | St Louis, MO, USA | GSE12667 | 75 | 99% | 89% | 88% |
| Lung | Villejuif, France | GSE10445 | 72 | 57% | 93% | 95% |
| Melanoma | Tampa, FL, USA | GSE7553 | 40 | 100% | 68% | 65% |
| Melanoma | Durham, NC, USA | GSE10282 | 43 | 100% | 65% | 84% |
| Ovarian | Melbourne, | GSE9891 | 285 | 100% | 99% | 96% |
| | Australia | | | | | |
| Ovarian | Ontario, Canada | GSE10971 | 37 | 97% | 100% | 72% |
| Prostate | Ann Arbor, MI, | GSE3325 | 19 | 95% | 89% | 89% |
| | USA | | | | | |
| Prostate | San Diego, CA, | GSE7307 | 10 | 100% | 90% | 90% |
| | USA | | | | | |
| Soft tissue | Paris, France | M-EXP- | 16 | 100% | 75% | 75% |
| | | 964* | | | | |
| Soft tissue | New York, NY, | GSE12195 | 83 | 99% | 98% | 98% |
| | USA | | | | | |
| Thyroid | Columbus, OH, | GSE6004 | 18 | 67% | 100% | 100% |
| | USA | | | | | |
| Thyroid | Valhalla, NY, USA | GSE3678 | 14 | 93% | 92% | 100% |
| | | | Total: 1468 | Mean: 92% | Mean: 92% | Mean: 85% |

*Dataset obtained from EBI ArrayExpress (http://www.ebi.ac.uk/microarray-as/ae/)

Agreement of the Level 2 classifier increases to 90% if colon/rectum misclassifications are considered as correct.

### A Three-Stage Classifier for Prediction of Tumor Origin

Reflecting the nature of existing diagnostic workflows for metastatic tumors, a novel 3-tiered approach to predicting the origin of a metastatic tumor biopsy was developed. For each test sample analysed, 3 rounds of kNN classification were performed, using the 3 levels of annotation previously described, i.e. (1) anatomical system, (2) tissue and (3) histological subtype, with k=5, 3 and 1 respectively. The decreasing value of k with increasing specificity of tissue annotation was chosen based on the decreasing mean class size at each tier of the classifier, with which it is highly correlated (r²=0.99).

A measurement of classifier confidence was generated for Level 1 (k=5) and Level 2 (k=3) results by determining the relative proportion of a test sample's 5 or 3 neighbors, respectively, that contribute to the winning class. The Level 3 prediction (k=1) identifies the specific individual tumor from the reference database that is closest to the test sample, in multi-dimensional gene expression space. As such, it is not possible to calculate a weighted confidence score for this level of classifier.

To determine the internal cross validation performance of the reference data and 3-tier algorithm, leave-one-out cross validation (LOOCV) was performed on the reference data set, using annotation levels 1 and 2. Results were tallied and overall percentage agreement and class-specific sensitivities and specificities were determined. The R/Bioconductor package “class” was used for kNN classification and predictive analyses.

### Example 2

### Identification of Breast Cancer Prognostic Markers

Two training data sets from untreated breast cancer patients_(NCBI GEO accession numbers GSE4922 and GSE6352), including a total of 425 samples hybridized to Affymetrix HG-U133A arrays (NCBI GEO accession number GPL96) were downloaded in CEL file format. Clinical data were available for age, grade, ER status, tumor size, lymph node involvement, and follow-up data for up to 15 years after diagnosis were also available. An independent validation data set, consisting of samples from 128 Tamoxifen-treated patients hybridized to Affymetrix HG-U133Plus2 arrays with age, grade, ER status, nodal involvement and tumor size data, was also obtained.

A semi-supervised method substantially in line with the method described by Bair and Tibshirani [Bair, et al. 2004, PLoS Biol: 2], incorporated herein in its entirety by reference, was used, with algorithm settings of k=2 (number of principal components for the “supergenes”), p-value threshold of 0.001 for significance of a probe set being univariately correlated with survival, 10-fold cross-validation, and age, grade, nodes, tumor size and ER status used as clinical covariates. The method identified 200 prognostic marker probe sets, represented by oligonucleotide primer SEQ ID NOS: 171-270 and 25777-27864, shown in Table 3, and gave the following model for risk of recurrence (Formula I):

$$P I = {\sum }_{i = 1}^{200} {w}_{i} {x}_{i} - 0.139601 ( grade ) + 0.64644 ( ER ) + 0.938702 ( nodes ) + 0.010679 ( size ( mm ) ) + 0.23595 ( age ) + 0.243639$$

In Formula I, wᵢ is the weight of the i^{th} probe set, xᵢ is its log expression level, and PI is prognostic index.

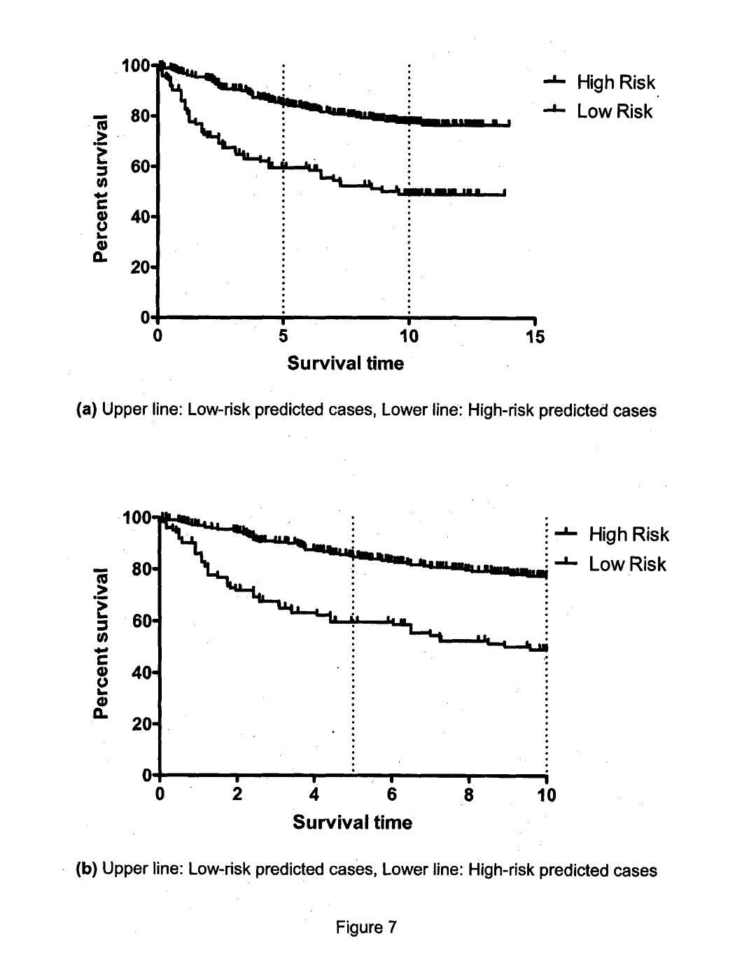

FIGS. 7(a) and 7(b) show Kaplan Meier analysis of 10-fold cross validation predictions made for the 425-sample training set. Log rank tests were used to compare the survival characteristics of the two risk groups identified.

Evaluation of the cross-validation predictions made for the training set revealed a highly statistically significant difference in the survival characteristics of the high and low risk groups. Of the 425 patients, 297 (70%) were classified as high-risk and 128 (30%) as high risk. The p-value of the Kaplan Meier analysis log-rank test was P<0.0001 and the hazard ratio of the classifier was 3.75 (95% confidence interval 2.47 to 5.71).

In the training set, 85% of patients classified as low risk were disease-recurrence free at 5 years after treatment. In the high-risk group, 41% of patients experienced disease recurrence within this same time period.

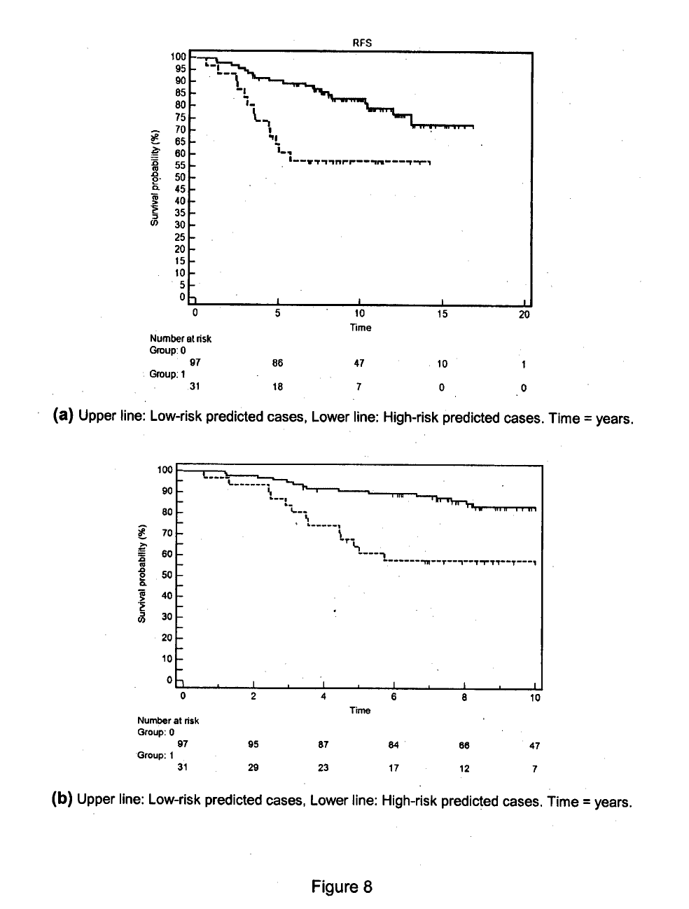

FIGS. 8(a) and 8(b) show survival characteristics of the high and low risk groups for the independent validation data set. The groups identified in this cohort are more similar to each other up to 3 years after diagnosis. This is likely attributable to the use of Tamoxifen in these patients. After this time point survival characteristics are significantly different.

Kaplan Meier analysis and log-rank testing was performed on the independent validation set. The P-value associated with the log rank test was P=0.0007. A hazard ratio of 4.90 (95% confidence interval 1.96 to 12.28) was observed. These figures indicate that the classifier was able to stratify the patients into two groups with markedly different survival characteristics.

Overall those individuals in the high-risk group are 4.9 times more likely to experience disease recurrence than those in the low risk group in the 10 years after diagnosis. Three quarters of the independent validation patients are classified as low risk (n=97) and of these, 90% are recurrence-free after 5 years.

Additionally, multivariate Cox Proportional Hazards analysis was performed on the 128 sample independent validation set. Two models were built and tested, one including the clinical variables only, and the other including the clinical variables and classifier prediction variable (high/low risk). The significance level of the clinical-only model was P=0.0291, whilst for the clinical+classifier model it was P=0.0126. The classifier remained independently prognostic in the second model (P=0.048).

These results indicate that the classifier (comprised of 200 genes+5 clinical variables) is able to stratify patients into high and low risk groups for disease recurrence. Furthermore, the stratification of patients is more statistically significant than the use of clinical variables alone. The prognostic significance of the classifier has been evaluated in patients who do and do not receive Tamoxifen treatment following their initial diagnosis and surgical procedure.

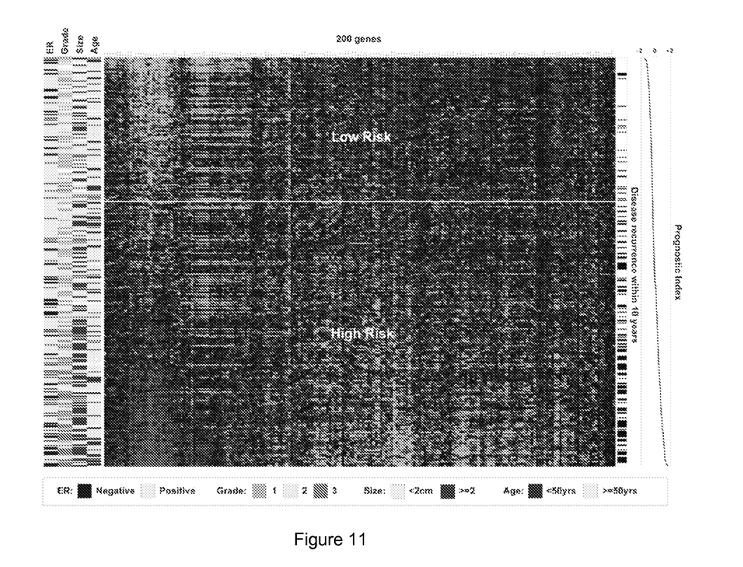

The 200 gene set can also be used to stratify breast cancer patients into high and low risk for disease recurrence groups without the requirement of considering the patients clinical variables. In this version of the prognostic algorithm, samples are classified as low risk if their prognostic index (i.e. sum of percentile-rank values*gene weights) is below −0.38 or high risk if they are above this threshold, as shown in FIG. 11. This threshold corresponded to an 8.5% false-negative rate for 5-year RFS in the subset of training series patients who did not receive systemic therapy.

FIG. 11 also shows the relationship between tumor grade and the prognostic index, with 97% of grade 3 tumors are classified as high risk and 54% of grade 1 tumors are classified as low risk. Sixty-nine percent of grade 2 tumors (representing 54% of the complete training series) were classified as high risk. Chi square test of tumor grade vs. risk group was significant at P<0.001. The difference in mean tumor size was significantly different between risk groups; low risk group was 19 mm (standard deviation 10 mm), high risk: 25 mm (12 mm), P<0.0001.

Kaplan Meier analysis and log rank testing was performed on the cross-validated training series risk groups and a statistically significant difference in recurrence-free survival was observed between the high and low risk group (P<0.001, HR: 4.2 95% CI: 3.0 to 5.8). At the 10-year follow up point, RFS for the low risk group (N=161, 33.8%) was 87%, compared to 56% for high-risk classified patients (N=316, 66.2%). Of the 118 patients who developed disease recurrence within 5 years, 104 (88%) were assigned to the high-risk group. An additional 32 individuals relapsed between 5 and 10 years of follow-up, with 26 being classified as high risk by the signature (81%).

Details of the training and validation series used to create and evaluate the 200-gene only model are shown in Table 4, in addition to the results of the multivariate Cox Proportional Hazards analysis performed on each series.

TABLE 4
Training and validation series, and Cox proportional hazards analysis.

| Series | Description | Cox Proportional Hazards Analysis | | | | |
|---|---|---|---|---|---|---|
| Training: | | Covariate | P (RF) | HR (95% CI) | | |
| GSE4922 | ER+/ER−, | Age | 0.42 | 1.01 (0.99 to 1.02) | | |
| Ivshina/ | N0/N1, | ER+ | 0.58 | 1.18 (0.65 to 2.16) | | |
| Miller [Ivshina, | Systemic | Grade | 0.059 | 1.40 (0.99 to 1.97) | | |
| et al. 2006, | therapy, | Size (mm) | 0.10 | 1.01 (1.00 to 1.02) | | |
| Cancer Res: | tamoxifen | Node + | 0.0001 | 2.79 (1.67 to 4.66) | | |
| 66], | only or no | Endocrine Tx | 0.28 | 0.73 (0.42 to 1.28) | | |
| GSE6532 | adjuvant | Chemo Tx | 0.0032 | 0.35 (0.18 to 0.70) | | |
| Loi/ | therapy. | 200-gene sig | 0.0001 | 3.14 (1.80 to 5.49) | | |
| Sotiriou [Loi, | | | | | | |
| et al. 2007, J | | | | | | |
| Clin Oncol: | | | | | | |
| 25] N = 477 | | | | | | |
| Validation 1: | | Covariate | P (DM) | HR (95% CI) | P (OS) | HR (95% CI) |
| GSE7390 | ER+/−, N0, | Age | 0.35 | 1.022 (0.98 to 1.07) | 0.46 | 1.02 (0.97 to 1.06) |
| Desmedt/ | <61 yrs, | ER+ | 0.54 | 0.81 (0.40 to 1.62) | 0.033 | 0.48 (0.25 to 0.94) |
| Sotiriou[Desmedt, | untreated, | Grade | 0.73 | 1.11 (063 to 1.95) | 0.23 | 0.74 (0.45 to 1.21) |
| et al. | ≦5 cm | Size (mm) | 0.092 | 1.35 (0.95 to 1.92 | 0.074 | 1.35 (0.97 to 1.87) |
| 2007, Clinical | | 200-gene sig | 0.0046 | 4.37 (1.58 to 12.08) | 0.0053 | 3.31 (1.43 to 7.64) |
| Cancer | | | | | | |
| Research: | | | | | | |
| 13] N = 198 | | | | | | |
| Validation 2: | | Covariate | P | HR (95% CI) | | |
| GSE11121 | ER+/−, | Grade | 0.033 | 1.93 (1.057 to 3.51) | | |
| Schmidt/ | untreated, | Size (mm) | 0.79 | 1.044 (0.75 to 1.45) | | |
| Gehrmann [Schmidt, | population- | 200-gene sig | 0.056 | 2.63 (0.98 to 7.055) | | |
| et al. | based, N0. | | | | | |
| 2008, Cancer | | | | | | |
| Res: 68] | | | | | | |
| N = 200 | | | | | | |
| Validation 3: | | Covariate | P (DM) | HR (95% CI) | P (DS) | HR (95% CI) |
| GSE1456 | ER+/−, | Grade | 0.19 | 1.47 (0.83 to 2.64) | 0.34 | 1.40 (0.70 to 2.80) |
| Pawitan/ | population- | 200-gene sig. | 0.055 | 2.58 (0.98 to 6.67) | 0.025 | 4.67 (1.23 to 17.81) |
| Bergh | based, 126 | | | | | |
| [Pawitan, et | adjuvant tx. | | | | | |
| al. 2005, | | | | | | |
| Breast | | | | | | |
| Cancer Res: | | | | | | |
| 7]) N = 159 | | | | | | |
| Validation 4: | | Covariate | P (DM) | HR (95% CI) | | |
| GSE9195, | ER+, | Age | 0.22 | 0.97 (0.93 to 1.019) | | |
| GSE6532 | adjuvant | Grade | 0.74 | 0.89 (0.46 to 1.72) | | |
| Loi/ | tamoxifen | Nodes | 0.94 | 0.96 (0.38 to 2.38) | | |
| Sotiriou [Loi, | treated, | Size | 0.0075 | 1.49 (1.11 to 1.98) | | |
| et al. 2007, J | N0/N1, | 200-gene | 0.019 | 6.51 (1.37 to 30.86) | | |
| Clin Oncol: | ≦5 cm | sig. | | | | |
| 25] | | | | | | |
| Validation 5: | | Covariate | P (DM) | HR (95% CI) | P (OS) | HR (95% CI) |
| NKI 295 (Van | ER+/− | ER+ | 0.18 | 0.74 (0.47 to 1.16) | 0.057 | 0.51 (0.32 to 0.82) |
| De Vijver et | untreated, | Node+ | 0.39 | 0.84 (0.56 to 1.25) | 0.63 | 0.90 (0.57 to 1.40) |
| al [van de | Stage I/II, | 200-gene sig | <0.0001 | 2.92 (1.77 to 4.80) | <0.0001 | 3.91 (2.06 to 7.42) |
| Vijver, et al. | <53 years | | | | | |
| 2002, N Engl | old; N0/N1. | | | | | |
| J Med: 347]* | | | | | | |
| N = 295 | | | | | | |

To further assess the clinical significance of 200-gene signature, differences in OS and DSS data for the high and low risk groups from validation series 1 and 3 (respectively) were analyzed. This showed that patients classified as low risk experienced high 10 years OS (90%) and 8.5-years DSS (95%). Kaplan Meier analysis and log rank testing of the risk groups was significant for DSS (P=0.003 HR: 3.73, 95% CI: 2.11 to 6.61) and OS (P=0.002, HR: 6.97, 95% CI: 3.35 to 14.5). Finally, OS of patients from validation series 5 classified as high risk (by the 99 gene model) was again found to be significantly poorer than those classified as low risk (P<0.0001, HR: 4.81, 95% CI: 3.07 to 7.52). In this series, 88% of low risk patients were alive at the 10-years follow-up mark.

Multivariate CPH was performed on the training and validation series using all available clinico-pathological covariates, to further assess the clinical significance of the 200-gene algorithm (Table 3). Covariate-adjusted recurrence-free survival hazard ratios for the training series, validation series 1 and 4 were statistically significant; 3.14 (P=0.0001), 4.37 (P=0.0046) and 6.51 (P=0.019), respectively. The 200-gene signature was marginally significant in validation series 2 (P=0.056) and 3 (P=0.055). Analysis of validation series 5 revealed the 99-gene subset classifier to be independently significant for both DMFS and OS (P<0.0001). In each CPH analysis the gene expression classifier was the strongest predictor of outcome.

Analysis of untreated, N0 patients (validation series 1 and 2) revealed the sensitivity and specificity of the assay for predicting 10-year DMFS to be 87.8% (95% CI: 78.7% to 94.0%) and 41.8% (36.0% to 47.8%), respectively. The positive and negative predictive values (PPV/NPV) of the classifier in this clinical setting were 30.5% (95% CI: 24.7% to 36.8%) and 92.2% (95% CI: 86.1% to 96.2%), respectively. The sensitivity and specificity of the assay for 10-year OS (based on validation series 1 only) was 89.2% (95% CI: 74.5% to 97/0%) and 46.1% (95% CI: 37.2% to 55.1%), respectively. PPV and NPV for OS were 32.4% (95% CI: 23.4% and 42.3%) and 93.4% (95% CI: 84% to 96.2%), respectively.

### Example 3

### Identification of Colon Tumor Prognostic Markers

To identify individual genes with expression patterns significantly associated with prognosis and train an algorithm to predict colon cancer recurrence, a database of clinical and gene expression data was compiled from a previously described patient series [Smith, et al. 2009, Gastroenterology: 138]. This comprised of 232 whole-genome Affymetrix U133 Plus 2.0 profiles that were generated from fresh-frozen biopsies taken from colon cancer patients diagnosed with stage 1-4 disease (NCBI GEO: GSE17538). These patients were treated at either the Vanderbilt Medical Centre (Nashville, Tenn., USA) or the H. Lee Moffittt Cancer Center (Tampa, Fla., USA) and are described in detail in the original publication.

To objectively assess the significance of the prognostic algorithm developed, an independent validation series of 163 Affymetrix U133 Plus 2.0 profiles from stage 2 and 3 colon cancer patients from a different previously published study was used [Jorissen, et al. 2009, Clinical Cancer Research: 15]. This clinical validation series (NCBI GEO ID: GSE14333) represented consecutive colon cancer patients who were treated at The Peter MacCallum Cancer Centre, Westmead Hospital and the Royal Melbourne Hospital (Australia) and the H. Lee Moffitt Cancer Center (USA). Patients were untreated prior to surgery and data were available for age at diagnosis, gender, tumor grade, stage, and recurrence-free survival. A summary of training and validation series demographics is shown in Table 5.

TABLE 5
Patient demographics of the colon cancer series used for gene selection,
algorithm training and independent validation

| | | | Independent | |
|---|---|---|---|---|
| | Training series | | validation series | |
| NCBI GEO ID | GSE17538 | | GSE14333 | |
| Contributing institutes | Vanderbilt Medical | | The Peter | |
| | Center (Nashville, TN) | | MacCallum Cancer | |
| | & H. Lee Moffit | | Centre, Westmead | |
| | Cancer Center | | Hospital, &Royal | |
| | (Tampa, FL) | | Melbourne Hospital | |
| | | | (Australia) | |
| Number of samples | 232 | | 60 | |
| Age (years), mean +/− | 64 +/− 13.4 | | 68 +/− 13.7 | |
| SD | | | | |
| Stage 1, n (%) | 28 | (12%) | — | |
| Stage 2, n (%) | 72 | (31%) | 33 | (55%) |
| Stage 3, n (%) | 76 | (33%) | 27 | (45%) |
| Stage 4, n (%) | 56 | (24%) | — | |
| Gender: Female, n (%) | 110 | (47%) | 28 | (47%) |
| Gender: Male, n (%) | 122 | (53%) | 32 | (53%) |
| Adjuvant chemotherapy | — | | 22 | (37%) |
| Adjuvant radiotherapy | — | | 1 | (2%) |
| Median follow-up/ | 30 | (0 to 210) | 37 | (2 to 85) |
| survival (months), | | | | |
| (range) | | | | |
| No. recurrences, n (%) | 55 | (23%) | 16 | (17%) |

| | | | |
|---|---|---|---|
| No. deaths, n (%) | 93 | (40%) | n/a |

As the reproducibility of gene expression data can be influenced by a number of factors, including the method of tissue preservation and technical factors such reagent batches and scanning equipment settings, an additional series of replicated hybridizations were obtained [Bowtell 1999, Nat Genet: 21; Mutter, et al. 2004, BMC Genomics: 5]. These came from the multi-center Microarray Quality Control study (MAQC) and were used to assess the stability of the prognostic signature between analysis sites (NCBI GEO ID: GSE5350) [Shi, et al. 2006, Nature biotechnology: 24]. Affymetrix hybridizations of four pools of cell-line RNA were performed five times in six different laboratories, resulting in 120 CEL files.

All Affymetrix CEL files were processed using MASS normalization and background correction. Probes with low intensity (<100) were excluded and each chip was median centered based on the expression of the internal 100—probe ‘reference set’, a series of probes selected by Affymetrix based on their low variation between multiple tissue types. Although the authors of the original studies reportedly examined the quality of their hybridizations prior to analysis, all genomic data were re-analyzed using the ChipDX Quality Module, which was specifically designed for diagnostic applications. This multi-step quality system evaluates factors such as non-specific background binding, normalization factors, signal-to-noise ratios and replicate probe variation. GeneChips flagged by the ChipDX Quality Module were excluded from the classifier evaluation analyses.

A modified version of the method described by Bair and Tibshirani [Bair and Tibshirani 2004, PLoS Biol: 2] was used to develop and train a predictive algorithm capable of stratifying patients into categories corresponding to low or high risk of disease recurrence. This approach uses CPH models to relate survival time to two “metagene” expression levels. These “metagenes” are the first two principal component linear combinations of the corresponding genes found to be significantly associated with recurrence, independent to clinical covariates. The prognostic significance of each gene was assessed using multivariate CPH regression models that included age at diagnosis, tumor grade and clinical staging. In this study, genes with patterns of expression that were significant at P<0.002 were used to compute the principal components and regression coefficients (weights).

To apply the classifier on data from a patient whose gene expression profile is described by a vector ‘x’ of log expression levels, the two principal components are computed by combining x with the weights of each linear combination. The weighted average of these two principal component values is then calculated, resulting in a value referred to as the ‘prognostic index’. A high prognostic index corresponds to an increased hazard of colon cancer recurrence. The classification threshold was set based on the 50^{th} percentile of training series indices, which were calculated using leave-one-out cross validation (LOOCV).

After completing this process on the 232—sample training series, expression data for genes selected in 20% or more of the cross validation rounds were converted to percentile-rank values (range 0.00-100.00) and used to retrain the predictive algorithm. Training-series risk group predictions from both log-intensity and percentile-rank versions of the algorithm were compared. Finally, the rank-based prognostic algorithm was applied to data from the independent validation series of patients with stage 2 or 3 colon cancer.

Kaplan Meier analysis and log-rank testing was used to evaluate the differences between the predicted risk groups in the training series for 5-year disease-free survival (DFS) and disease-specific survival (DSS). The independent validation series was evaluated for 5-year DFS only as DSS data was not available. Multivariate Cox Proportional Hazards (CPH) analysis was performed to determine the independence of the prognostic signature in the presence of clinical covariates. For all tests, p-values<0.05 were considered significant.

Gene expression analysis was performed using R (www.r-project.org), Bioconductor [Gentleman, et al. 2004, Genome biology: 5] and BRB ArrayTools [Simon, et al. 2007, Cancer Inform: 3]. Statistical analysis of the prognostic index and risk group predictions were carried out using MedCalc (MedCalc Inc. Belgium). A custom R-script was created to encapsulate the diagnostic algorithm created and was incorporated into to the ChipDX online analysis system; developed with R, Bioconductor, Microsoft ASP.NET and SQL Server (Microsoft Corporation, WA).

### Identification of Recurrence-Associated Gene Expression Patterns

Multivariate analysis of the 232-sample stage 1-4 training series successfully identified a set of 163 probes, significantly associated with colon cancer recurrence, independent to age, grade and stage. An annotated list of the 163 probes, represented by oligonucleotide primer SEQ ID NOS: 1-170 and 24197-25776, is provided in Table 6. The gene set was compared to prognostic colon cancer signatures published by Smith et al (34 genes) [Smith, et al. 2009, Gastroenterology: 138] and Jorissen et al (128 genes) [Jorissen, et al. 2009, Clinical Cancer Research: 15]. No overlap was found between all three signatures, or between the Smith and Jorissen signatures. Seven genes were found in common between the Jorissen signature and the 163 probe set identified in this study; AKAP12, DCBLD2, FN1, SPARC, SPP1, THBS2 and VCAN. The hypergeometric probability of this overlap occurring by chance is <1.40×10⁻⁷.

To explore the biological functions of the genes selected from the prognostic signature, Ingenuity Pathway Analysis software was used (www.ingenuity.com). A significant overlap was detected with several relevant gene families, including colon cancer progression (e.g. FN1, IGBP3, PLAUR and TIMP1; P=0.00052), tumor cell apoptosis (e.g. BID, TNFRSF21, PHLDA1 and NOTCH1; P=1.46×10-6) and cell proliferation (e.g. CTGF, SPP1, FOLR1 and SPARC). Enrichment of genes from the IGF-1 signaling and VDR/RXR activation canonical pathways (P=7.82×10⁻⁴ and P=3.85×10⁻³ respectively) was also found. These molecular pathways have been implicated in colon cancer development and progression [Khandwala, et al. 2000, Endocr Rev: 21][Wactawski-Wende, et al. 2006, N Engl J Med: 354].

### Analysis of Independent Clinical Validation Series

The trained 163-probe algorithm was then applied to data from an independent series of 33 stage 2 and 27 stage 3 colon cancer patients, not involved in the gene selection or algorithm development process. Thirty-five (58%) of these patients were classified as low risk (i.e. prognostic index<50^{th} percentile of cross-validated training series indices; −0.104). Kaplan Meier analysis and log rank testing of the two risk groups, containing both stage 2 and 3 patients, revealed a significant difference in 5-year DFS (P=0.021, HR: 3.19 95% CI: 1.18 to 8.63).

Kaplan Meier analysis of risk groups stratified by gene expression risk group and clinical staging was then performed, resulting in a significant difference in DFS for stage 2 patients (P=0.0031) and approaching significance for stage 3 patients (P=0.057). Notably, no low-risk stage 2 patient from this series experienced disease recurrence for (up to) 5 years.

As the use of chemotherapy for patients with stage 2 and 3 cancer remains controversial [Quasar Collaborative, et al. 2007, Lancet: 370], there is a need for improved methods of risk assessment. In this study, multivariate survival models were applied to clinical and gene expression data to identify a prognostic signature for stage 2 and 3 colon cancer. This was used to create a robust diagnostic tool that may ultimately assist clinicians in tailoring personalized treatment options, in conjunction with the clinical staging system.

The ‘meta-gene’ classification algorithm was developed from a multi-center series of stage 1-4 colon cancer patients and then independently validated on a separate series of stage 2 and 3 colon cancer patients. In the case of patients with stage 2 disease, the assay is able to identify those who are at low risk of disease recurrence; i.e. 89% recurrence-free survival (RFS) in the training series and 100% RFS in the validation series, for up to 5 years following diagnosis. By comparison, high-risk stage 2 patients experience a 24-27% lower rate RFS, suggesting that adjuvant therapies should be considered for patients assigned to this risk group. Stratification of stage 2 patients also corresponded to a significant difference in DSS in the training series, confirming the clinical significance of the assay.

Patients diagnosed with stage 3 colon cancer are commonly treated with adjuvant chemotherapy, yet relapse is still observed in approximately 40% of cases [Andre, et al. 2004, N Engl J Med: 350]. Genomic stratification of stage 3 patients in this study resulted in groups with significant differences in RFS, with those patients classified as high risk experiencing an extremely poor 5-year RFS rate of 43% (training series) and 26% (validation series). As such, a patient with stage 3 disease and the high-risk gene expression signature may benefit from a more aggressive treatment regimen, possibly including targeted or experimental therapies, such as bevacizumab or panitumumab [Hurwitz, et al. 2004, N Engl J Med: 350][Seront, et al. Cancer Treat Rev: 36 Suppl 1].

The signature developed in this study differs from previous groups in several ways. Firstly, it was developed exclusively using a training series of gene expression and clinical data derived from human colon tumors, representing all major stages of progression. Tumors of the rectum were intentionally excluded as they are increasingly recognized as a distinct category with different origins and treatment options [Konishi, et al. 1999, Gut: 45]. Each gene in the signature is individually associated with outcome independent to traditional prognostic variables. The algorithm trained on these data uses robust gene expression rank values, rather that log scale intensities which are more susceptible to inter- and intra-laboratory technical variation. Finally, the prognostic index is a continuous variable, positively correlated with increased risk of colon cancer recurrence and capable of stratifying patients into risk groups that are statistically and clinically significant, for up to 5-years following diagnosis.

[Bair and Tibshirani 2004, PLoS Biol: 2; Gentleman, et al. 2004, Genome biology: 5; Khandwala, et al. 2000, Endocr Rev: 21; Simon, et al. 2007, Cancer Inform: 3] [Wactawski-Wende, et al., 2006, Journal/N Engl J Med, 354] [Quasar Collaborative, et al., 2007, Journal/Lancet, 370] [Andre, et al., 2004, Journal/N Engl J Med, 350] [Hurwitz, et al., 2004, Journal/N Engl J Med, 350] [Seront, et al., Journal/Cancer Treat Rev, 36 Suppl 1][Konishi, et al. 1999, Gut: 45]

### Example 4

### Identification of Non-Small-Cell Lung Cancer Prognostic and Adjuvant Chemotherapy Benefit Predictive Markers

Adenocarcinoma is the most common form of non-small cell lung cancer (NSCLC), a category that represents 85% of all lung cancers. Disease stage is strongly associated with outcome and commonly used to determine adjuvant treatment eligibility. Improved and integrated methods for predicting outcome and adjuvant chemotherapy (ACT) benefit have the potential to lower over and under treatment rates [Pisters, et al. 2007, Journal of Clinical Oncology: 25].

Subramanian and Simon recently compared 16 studies describing the development of prognostic gene expression signatures for non-small cell lung cancer (NSCLC), published between 2002 and 2009 [Subramanian, et al. Journal of the National Cancer Institute: 102]. A standard set of evaluation criteria was applied to each, assessing study design, statistical validation, result presentation and demonstrable improvement over existing treatment guidelines. It was concluded that none were ready for clinical application as none significantly improved upon a simple clinical formula based on patient age and tumor size [Subramanian, et al. Nat Rev Clin Oncol: 7].

Using a unique randomized controlled clinical trial design, Zhu et al [Zhu, et al. 2010, Journal of Clinical Oncology: 28] identified a set of 15 genes with the ability to stratify patients into categories with significant differences in their outcome and adjuvant chemotherapy benefit. Multiple histological subtypes were present in the training series used to develop the gene signature. While the prognostic significance of the 15-gene set was validated in several previously published independent series of NSCLC patients, only cross-validation or ‘resubstitution’ results were presented to verify their predictive ability. A number of statistical guidelines have described the potential pitfalls of this approach [Simon 2005, J Clin Oncol: 23; Subramanian and Simon 2010, Journal of the National Cancer Institute: 102].

The goal of this analysis was to perform meta-analysis of publicly available gene expression data from patients with lung adenocarcinoma to develop and independently validate complimentary algorithms for classifying patients into groups with significant differences in outcome and ACT-benefit. In addition, genomic indicators for select genetic mutations involved in lung cancer development and progression were also sought.

Genomic and clinical data from The Directs Challenge Consortium for Molecular classification of Lung Adenocarcinoma series [Shedden, et al. 2008, Nat Med: 14], representing 442-patients from six treatment centres, were used to identify genes with robust patterns of expression associated with outcome and ACT-benefit. Patients who received adjuvant systemic or radio-therapy were excluded from training series A, leaving 329 patients with stage 1a-3b disease, as summarized in Table 7.

TABLE 7
Clinicopathological characteristics of the lung adenocarcinomapatients used
in this study.

| | Prognostic signature | | Chemotherapy-response signature | |
|---|---|---|---|---|
| | Training Series | Validation Series | Training Series | Validation Series |
| Variable | A (n = 329) | A (n = 327) | B (n = 88) | B (n = 90) |
| Age: Median (SD) | 65 (12) | 64 (10) | 62 (10) | 63 (8) |
| Gender: Female, | 156 (47%), | 178 (54%), | 51 (58%), 39 | 23 (26%), 67 |
| Male | 173 (53%) | 149 (46%) | (42%) | (74%) |
| Stage: | 230 (70%), 59 | 201 (62%), 66 | 39 (44%), 27 | 45 (50%), 45 |
| I/II/III/IV/unknown | (18%), 40 (12%), | (20%), 60 (18%), | (31%), 21 (24%), | (50%), 0 (0%), 0 |
| | 0 (0%), 0 (0%) | 0 (0%), 0 (0%) | 1 (1%), 0 (0%) | (0%), 0 (0%) |
| Stage I: A/B | 108, 122 | 93, 97 | 5, 34 | — |
| Stage II: A/B | 48, 11 | 16, 44 | 25, 3 | — |
| Grade: | 48 (15%), 161 | 22 ( ), 36 ( ), 48 ( ), | 10 (11%), 40 | — |
| 1/2/3/unknown | (49%), 116 (35%), | | (45%), 36 (41%), | |
| | 4 (1%) | | 2 (2%) | |
| Histological | Adenocarcinoma: | Adenocarcinoma: | Adenocarcinoma: | Adenocarcinoma: |
| subtype | 329 (100%) | 327 (100%) | 88 (100%) | 28 (31%), Large |
| | | | | cell carcinoma: 10 |
| | | | | (11%), Squamous |
| | | | | cell carcinoma: 52 |
| | | | | (58%) |
| Smoking history | Never: 33 (10%) | Never: 1 (<1%) | Never: 14 (16%) | — |
| | Former: 181 | Former: 21 (6%) | Former: 65 (74%) | |
| | (55%) | Unknown: 325 | Current: 7 (8%) | |
| | Current: 25 (8%) | (93%) | Unknown: 2 (2%) | |
| | Unknown: 90 | | | |
| | (27%) | | | |
| Radiotherapy | 0 (0%) | 20 (6%) | 45 (51%) | 0 (0%) |
| Chemotherapy | 0 (0%) | 0 (0%) | 88 (100%) | 50 (56%) |
| Original | [Shedden, et al. | [Shedden, et al. | [Shedden, et al. | [Zhu, et al. 2010, |
| publication(s): | 2008, Nat Med: | 2008, Nat Med: | 2008, Nat Med: | Journal of Clinical |
| | 14] | 14] | 14] | Oncology: 28] |
| | | [Takeuchi, et al. | | |
| | | 2006, Journal of | | |
| | | Clinical Oncology: | | |
| | | 24] | | |
| | | [Zhu, et al. 2010, | | |
| | | Journal of Clinical | | |
| | | Oncology: 28] | | |
| | | [Bild, et al. 2006, | | |
| | | Nature: 439] | | |
| Genomic | Affymetrix | Agilent custom | Affymetrix | Affymetrix |
| platform: | GeneChip U133A | array: 82 (25%) | GeneChip U133A | GeneChip U133A |
| | | Affymetrix | | |
| | | GeneChip: U95A: | | |
| | | 155 (47%), | | |
| | | U133A: 35 (11%), | | |
| | | U133 Plus 2.0: 55 | | |
| | | (17%) | | |
| NCBI Gene | n/a¹ | GSE11969, | n/a¹ | GSE14814 |
| Expression | | GSE14814, | | |
| Omnibus ID(s) | | GSE3141 and¹ | | |
| Disease specific | 120 (36%) | 144 (44%) | 47 (53%) | 27 (30%) |
| death within 5 | | | | |
| years | | | | |

“—” = not available.
¹Data available at: https://array.nci.nih.gov/caarray/project/details.action?project.experiment.publicIdentifier=jacob-00182

To independently evaluate the prognostic significance of the algorithm, a multi-institute, multi-platform validation series of stage I-II large lung adenocarcinoma patients was compiled from three previously published studies [Takeuchi, et al. 2006, Journal of Clinical Oncology: 24; Bild, et al. 2006, Nature: 439; Bhattacharjee, et al. 2001, Proceedings of the National Academy of Sciences of the United States of America: 98]. These were combined with patients who received radiotherapy-only from the Directors Challenge study for a total of 334 patients (validation series A).

To develop a predictive signature for ACT-benefit, data from the 88 patients who were part of the NIH Director's Challenge series and received adjuvant chemotherapy were compiled as training series B. To validate the signature in patients not involved in the gene selection or algorithm training process, data from 90 patients enrolled in a randomized controlled trial of adjuvant vinorelbine/cisplatin vs observation alone were used (validation series B). This series, recently published by Zhu et al., [Zhu, et al. 2010, Journal of Clinical Oncology: 28], described 133 samples in total; however 43 patients were part of the NIH Directors Challenge study (25 of whom were included in validation series A) and were therefore excluded from validation series C.

Relevant clinico-pathological information for the six series of lung cancer patients used in this study is summarized in Table 1. Consent was obtained for all subjects using protocols approved by each institution's Institutional Review Board, as described in the original publications listed in Table 7.

### Gene Selection and Prognostic Algorithm Training

Genomic and clinical data from the 329-patient training series A were integrated to identify genes with individual prognosis significance, using methods as previously described [Van Laar 2010, British journal of cancer: 103; Van Laar 2011, The Journal of molecular diagnostics: JMD]. Briefly, after filtering out low intensity features from each profile and reducing redundant probes to one per gene, 6566 genes remained. Individual genes were selected for inclusion in the classification final model if they were significantly associated with outcome at P<0.001 in cross-validated Cox regression models, including age at diagnosis, smoking history, gender, histological grade and AJCC stage [Cox 1972, Journal of the Royal Statistical Society: B; Simon, et al. 2007, Cancer Inform: 3]. At each round of cross validation, significant genes were used to train a principal component classification algorithm, which was then used to predict the risk status of the held-out sample.

At the conclusion of the cross-validation exercise, genes present in >=20% of the models were converted to percent-rank values and used to form a final classifier, as previously described [Van Laar 2010, British journal of cancer: 103]. The 60^{th} percentile of the prognostic indexes calculated for training series A was used as the threshold for high/low risk assignment. The finalized classifier was then applied to independent validation series A, in order to evaluate its prognostic significance in adenocarcinoma patient data not used in the gene selection or algorithm training process.

As a key criterion for evaluating NSCLC prognostic gene expression assays is the ability to improve over current ‘clinical’ assessments of patients with stage 1 disease. To this end, a prognostic equation for predicting outcome (high/low risk) was developed based on tumor size (≦3 cm or >3 cm) and age at diagnosis of stage I patients in training series A, based on methods described in Subramanian & Simon [Subramanian and Simon 2010, Journal of the National Cancer Institute: 102]. The trained clinical algorithm was then used to stratify stage I patients in validation series A into high or low risk groups for DSS.

### Development and Validation of a Gene Expression Signature to Predict Adjuvant Chemotherapy Benefit

Patients from validation series B were analyzed using the Cox Regression method previously described. Genes were selected if they were significantly associated with outcome in patients treated with ACT, independent to age, stage, gender, smoking history and prognosis risk group at P<0.001. A principal component algorithm was trained on the genes identified and then applied to the 90-patient training series B. The algorithm assigned patients to categories corresponding to ‘ACT benefit’ or ‘no ACT benefit’ and the survival characteristics of patients treated with ACT or OBS were compared within each category. Gene expression data were analyzed using BRB ArrayTools [Simon, et al. 2007, Cancer Inform: 3], R (www.r-project.org), and Bioconductor [Gentleman, et al. 2004, Genome biology: 5]. Statistical analyses were performed using MedCalc (MedCalc Software, Mariakerke, Belgium).

To evaluate the significance of the prognostic signature developed, Kaplan Meier analysis with log rank testing was performed on risk groups identified in independent validation series. Receiver Operator Curve (ROC) analysis was also performed on both gene expression and clinical-variable risk classifiers. Patients with less than 12 months follow-up were excluded from the ROC analyses and deaths were censored at 5 years.

For validation series A and B, multivariate Cox Proportional Hazards analysis was used to determine if the risk group stratifications were independent to clinical covariates and genomic platform (where applicable). Survival data for patients analyzed with the prognostic signature were censored at 60 months.

### Prognostic Gene Selection & Algorithm Training

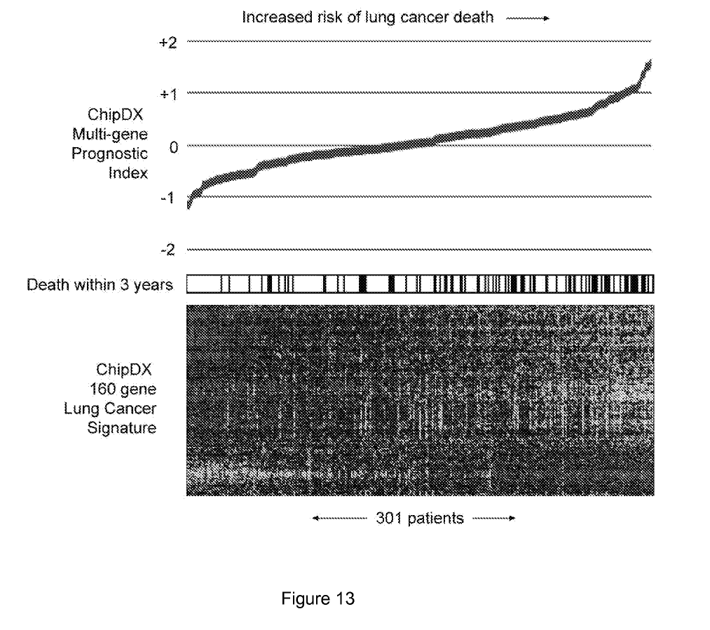

The multivariate method of gene selection employed identified a set of 160 Affymetrix probes corresponding to unique genes, whose pattern of expression was significantly associated with outcome over and above the clinical variables. The normalized log intensity values associated with these genes were converted to percent-ranks and used to train a single meta-gene algorithm, which generates a prognostic index for each patient that is continuously associated with risk of death from lung cancer. The association between the 160-gene expression profile, the resulting prognostic index and patient outcome can be observed in FIG. 13 while an annotated list of probe IDs, represented by oligonucleotide primer SEQ ID NOS: 1-11, 171-183, 271-383, 25777-25787 and 27865-29496, and individual correlations and p-value for association without outcome is provided in Table 8.

Functional characterization of the 160 gene set was performed using DAVID (http://david.abcc.ncifcrf.gov/) [Dennis, et al. 2003, Genome biology: 4]. Clustering of gene annotation terms and enrichment assessment revealed genes involved in negatively regulating metabolic processes (enrichment score: 4.31), regulation of cellular organization (1.52), cell cycle control (1.25) and apoptosis (1.15) to be a significant component of the signature. Genes implicated in the MAPK signaling pathway (i.e. CDC42, MKNK1, MAPKAPK2 and TRADD) were also significantly over-represented in the gene set, compared to random selection (P=0.034). Activation of the MAPK signaling pathway has recently been linked to the oncogenic factor EAPII (TDP2) and the development of lung cancer[Li, et al. 2011, Oncogene].

### Predictive Gene Selection and Algorithm Training

Cross-validated Cox Regression models identified 37 unique genes associated with outcome in ACT-treated patients from training series B. The significance of each gene was independent to age, stage, gender and prognosis (as calculated using the 160-gene model described above). During cross-validation, the status of the held-out sample was predicted based on a principal component algorithm trained on significant genes identified in the other 87 (N-1) samples. Cross validated training-series risk groups with significant differences in DSS (P=0.0021, HR: 2.48, 95% CI: 1.40 to 4.42).

Analysis of gene function using DAVID showed the 37-gene signature represents cellular processes involved in vinorelbine function such as lipid metabolism (e.g. LARGE, FA2H, and PCYT1B) [Robieux, et al. 1996, Clin Pharmacol Ther: 59] and also in cisplatin function, including membrane transport (e.g. SLC17A1, COX411 and SLC2A1) [Egawa-Takata, et al. Cancer Science: 101], apoptosis/proliferation (e.g. CASP9, DUSP22 and TBX2) [Kuwahara, et al. 2000, Cancer Lett: 148] and purine binding (DHX16, DHX16, and LYN) [Kowalski, et al. 2008, Molecular Pharmacology: 74]. The full list of annotated genes, represented by oligonucleotide primer SEQ ID NOS: 384-476, 27865-27880 and 29497-29809, with Cox regression p-values, is provided in Table 9.

### Independent Validation of the 160-Gene Prognosis Signature

The trained algorithm was then applied to data from a series of 327 lung adenocarcinoma patients with stage 1-2 disease, receiving either no adjuvant therapy (n=321) or radiotherapy only (n=19). Four microarray types were present in the validation series and each was found to contain a different proportion of the 160-gene signature; Affymetrix U133a and U133 Plus 2.0: 160/160 (100%), Affymetrix U95A: 132/160 (83%) and Agilent: 135/160 (84%).

Kaplan Meier analysis (with log rank testing) and multivariate Cox Proportional Hazards analysis was used to compare the difference in outcome between the high and low risk groups for the complete series and also stage-based subsets is shown in Table 10.

TABLE 10
Analysis of the independent validation series risk group predictions
generated using the 160-gene prognostic signature.

| | | | | Kaplan Meier Analysis | | Cox Proportional Hazards | |
|---|---|---|---|---|---|---|---|
| | | | | (160-gene signature | | Regression (160-gene | |
| | | Receiver Operator | | assigned high/low risk | | signature assigned high/low | |
| | | Curve analysis | | categories) | | risk categories) | |
| | No. | | AUC (95% | Univariate | Hazard Ratio | Multivariate | Hazard Ratio |
| Stage | patients | P-value | CI) | P-value | (95% CI) | P-value | (95% CI) |
| I & II | 327 | <0.0001 | 0.67 (0.61 | <0.0001 | 2.055 (1.45 | <0.0001 | 2.31 (1.64 to |
| | | | to 0.73) | | to 2.92) | | 3.26) |
| I | 201 | 0.0002 | 0.68 (0.61 | 0.0008 | 2.26 (1.31 to | <0.0001 | 3.56 (2.026 to |
| | | | to 0.75) | | 3.89) | | 6.28) |
| IA | 93 | 0.025 | 0.693 (0.59 | 0.18 | 1.76 (0.70 to | 0.045 | 2.65 (1.029 to |
| | | | to 0.78) | | 4.47) | | 6.84) |
| IB | 97 | 0.0001 | 0.746 (0.65 | 0.0008 | 2.79 (1.38 to | <0.0001 | 5.45 (2.48 to |
| | | | to 0.83) | | 5.64) | | 11.97) |
| II | 66 | 0.52 | 0.55 (0.41 | 0.019 | 2.43 (1.15 to | 0.019 | 2.73 (1.19 to |
| | | | to 0.69) | | 5.14) | | 6.23) |
| IIA | 16 | 0.032 | 0.77 (0.50 | 0.013 | 4.53 (1.38 to | 0.012 | 22.048 (1.99 |
| | | | to 0.94) | | 13.77) | | to 244.30.) |
| IIB | 36 | 0.54 | 0.44 (0.29 | 0.33 | 1.62 (0.60 to | 0.48 | 1.44 (0.54 to |
| | | | to 0.61) | | 4.33) | | 4.027) |

Of the 255-patient independent validation series, 164 patients were assigned to the low risk category (64%) and 91 to the high risk category (36%). Kaplan Meier analysis with log rank testing was highly significant (P<0.0001) and a hazard ratio of 2.44 (95% CI: 1.57 to 3.79) observed. When adjusted for age, gender, AJCC Stage (I vs II), and microarray-type, the 160-gene signature remains significant (P<0.0001) and is the strongest predictor of outcome (hazard ratio: 2.95, 95% CI: 1.91 to 4.55). The area-under-the-curve (AUC), a combined measurement of test sensitivity and specificity, for stage I-II patients was 0.64 (95% CI: 0.58 to 0.70), which was statistically significant (P=0.0002).

In addition to gene expression platform independence, the 160-gene signature was also shown to be compatible with other non-PCA based classification algorithms (data not shown). The gene set results in statistically significant risk group stratification of validation series A patients when used in conjunction with the method referred to as “Prediction Analysis of Microarrays” (PAM) [Tibshirani, et al. 2002, Proceedings of the National Academy of Sciences: 99], nearest centroid classifier or linear discriminant analysis [Dudoit, et al. 2002, Journal of the American Statistical Association: 97] (all log rank test p-value≦0.05). The gene set approached, but did not achieve, statistical significance when used with a nearest neighbor or support vector machine [Brown, et al. 2000, Proc Natl Acad Sci USA: 97] algorithm (P=0.093 and 0.11 respectively). Ultimately, the PCA method used was retained as the method of analysis as it resulted in the largest, statistically-significant validation series hazard ratio and has previously been used to develop prognostic assays for other cancer types [Van Laar 2010, British journal of cancer: 103; Van Laar 2011, The Journal of molecular diagnostics: JMD].

The 160-gene signature was also investigated in patients from two additional series of NSCLC patients for which P53, KRAS and EGFR mutation testing results and gene expression data were available [Angulo, et al. 2008, The Journal of Pathology: 214; Ding, et al. 2008, Nature: 455]. The 160-gene prognostic score (previously shown to be positively correlated with worsening prognosis), was found to be correlated with P53 mutation status (coefficient=0.75), mildly inversely correlated with KRAS mutation status (−0.33) and also inversely correlated with EGFR mutation status (−0.73). Overall, individuals with the ‘poor prognosis’ gene expression profile were likely to be P53-mutant, EGFR-wildtype (data not shown).

Comparison of Prognosis by Gene Expression Vs. Clinical Formula

As described by Subramanian & Simon, a simple clinical-variable classifier was developed based on patient age and tumor size (≦3 cm or >3 cm) using 195 training series A Stage I patients. The resulting formula was then used to predict the outcome of the Stage I patients in independent validation series A. Kaplan Meier analysis of the predicted ‘clinical’ outcome groups revealed a statistically significant difference in 5-year OS (P=0004, HR: 2.65 95% CI 1.40 to 1.99) which is marginally less accurate than the 160-gene signature (P=0.002 HR: 2.82 95% CI 1.53 to 5.19 for same patient subset).

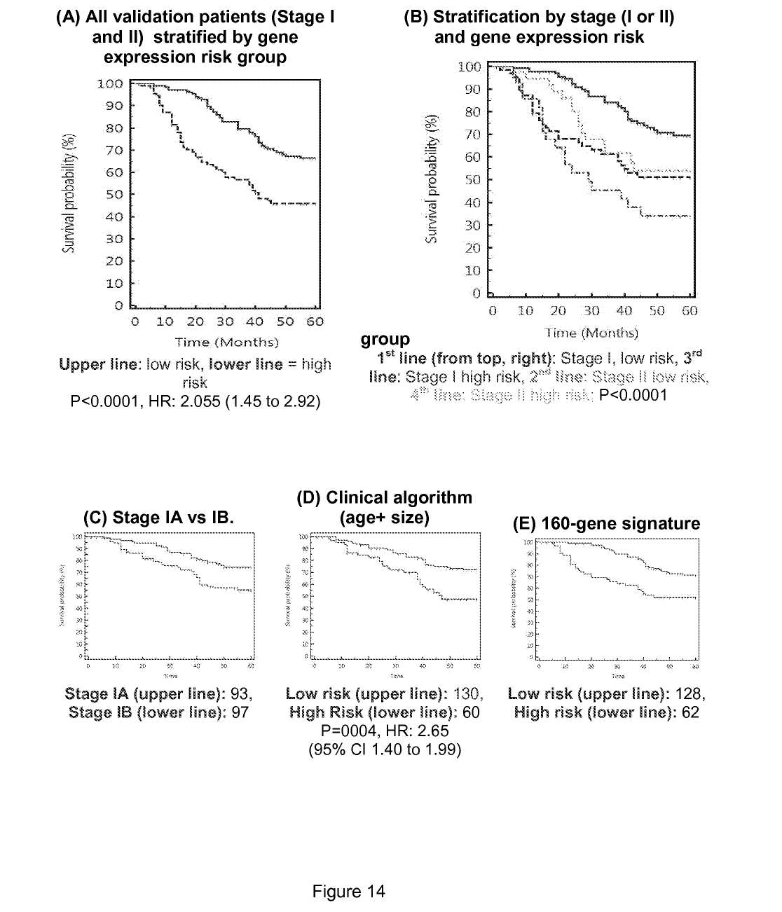

Despite the similarity of hazard ratios calculated for the clinical and molecular methods, inspection of the 12 and 24-month point on the Kaplan Meier curves in FIG. 14 reveals an important difference between the methods. The 160-gene signature is superior at identifying stage I patients at increased risk of death within the first 24 months following diagnosis, compared to either staging alone or the clinical model. This is highlighted further by the differences in AUC, calculated on data censored at 60 months (gene-sig: 0.69, clinical 0.64), 36 months (gene-sig: 0.71, clinical: 0.61), 24 months (gene-sig: 0.74, clinical: 0.61) and 12 months: (gene-sig: 0.81, clinical: 0.62).

Five patients from independent validation series A were diagnosed with stage 1A disease (ages 63-74 yrs), did not receive systemic therapy, and died within 24 months (3 died within 12 months). All five (100%) were predicted to be high-risk cases by 160-gene signature. Conversely, 0 out of 65 gene-signature ‘low risk’ stage 1A patients died within the same time period, although 13 deaths were recorded over the full 5 year follow-up period (20%). These data suggest the 160-gene algorithm is effective at identifying early-stage individuals at short-term risk of death from lung cancer, warranting increased screening and/or the use of systemic or targeted therapies.

### Independent Validation of the 37-Gene Predictive Signature

The 37-gene ACT-response signature, identified from 88 ACT-treated adenocarcinoma patients (training series B), was applied to data from validation series B. This series represents 90 participants from a randomized controlled clinical trial, designed to investigate the use of genomic profiling to predict treatment benefit. Sixty-six (73%) patients were classified as ‘ACT benefit’ and 24 (27%) as ‘no ACT benefit’ on the basis of the gene expression profile. The survival characteristics of those who received ACT vs. OBS only were compared within each of the response-prediction categories.

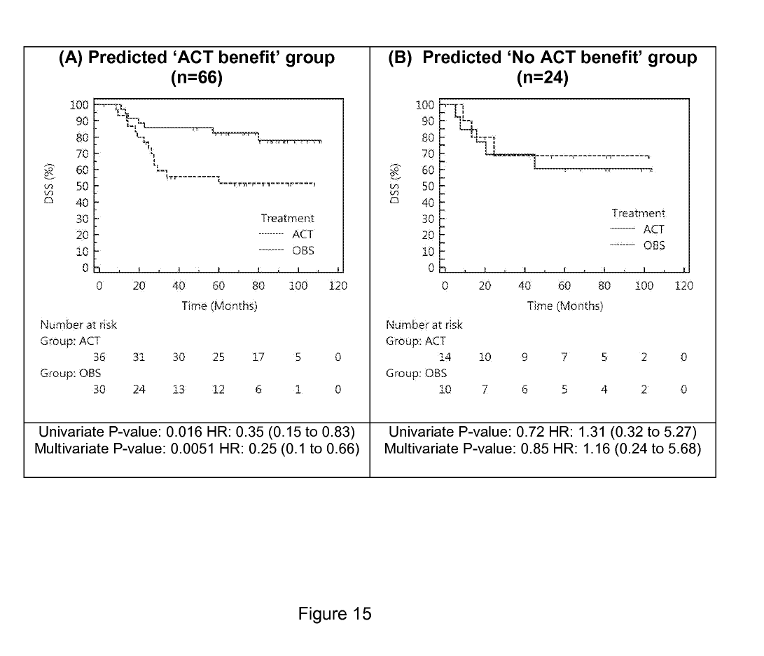

As shown in FIG. 15, patients in the ‘ACT benefit’ group experienced a significant reduction in DSS when treated with ACT compared to observation only. This difference was statistically significant in both univariate (log rank) testing; P=0.016, and in a multivariate analysis when adjusted for differences related to age, gender, stage and histology; P=0.0051. Individuals predicted to benefit from ACT were between 2.9-times (univariate) and 4.0-times (adjusted) less at risk of death from the disease during the study period when treated with ACT, compared to OBS alone.

Patients in the predicted ‘No ACT benefit’ group exhibited no difference in DSS between ACT or observation only groups—at either the univariate (P=0.72) or multivariate level (P=0.74). No significant difference was also observed when the signature was applied to 363 patients from training and validation series A (P>0.05), confirming that the 37-gene signature is predictive and not prognostic.

### Lung Cancer Prognosis and Treatment-Response Signatures—Determination of Minimum Gene Set Required.

Classifiers were trained (leave-one-out cross validation) using subsets of the full 160 genes identified as being significantly associated with outcome in untreated lung adenocarcinoma patients. Genes were ranked by Cox-regression p-values to create subsets. The prognostic risk group assignments generated by each model were evaluated against the true outcome of patients in the study (i.e. training series A) and are shown in Table 11 and the associated graph.

TABLE 11
Comparison of the prognostic value of using less than the full 160-gene
signature associated with outcome in untreated lung adenocarcinoma
patients.

| Number of | | | Lower | Upper |
|---|---|---|---|---|
| genes in | | Hazard | boundary of 95% | boundary of 95% |
| classifier | P-value | ratio | confidence interval | confidence interval |
| 160 | <0.0001 | 2.56 | 1.76 | 3.72 |
| 128 | <0.0001 | 2.4 | 1.68 | 3.48 |
| 105 | <0.0001 | 2.35 | 1.61 | 3.41 |
| 92 | <0.0001 | 2.5 | 1.72 | 3.64 |
| 68 | <0.0001 | 2.56 | 1.75 | 3.72 |
| 61 | <0.0001 | 2.46 | 1.69 | 3.59 |
| 39 | <0.0001 | 2.78 | 1.91 | 4.05 |
| 31 | <0.0001 | 2.72 | 1.88 | 3.95 |
| 20 | <0.0001 | 2.2 | 1.51 | 3.21 |
| 15 | 0.0002 | 1.94 | 1.33 | 2.82 |
| 4 | 0.0039 | 1.68 | 1.15 | 2.44 |
| 2 | 0.033 | 1.47 | 1.017 | 2.13 |

Statistically significant risk-group stratification was observed with as few as 2 genes, therefore this is the minimum number required to classify patients as high or low risk for disease-specific death from stage 1A lung cancer.

### 37-Gene Treatment-Response Prediction Signature

Classifiers were trained (leave-one-out cross validation) using subsets of the full 37 genes, ranked by Cox-regression p-value and evaluated against the true outcome of patients in the study (i.e. training series B) and are shown in Table 12 and associated graph.

TABLE 12
Comparison of the predictive value of using less than the full 37-gene
signature associated with outcome in adjuvant-treated lung
adenocarcinoma patients.

| | | | Lower boundary of | Upper |
|---|---|---|---|---|
| Genes in | | Hazard | 95% confidence | boundary of 95% |
| classifier | P-value | ratio | interval | confidence interval |
| 37 | 0.0006 | 2.83 | 1.59 | 5.02 |
| 33 | 0.0024 | 2.45 | 1.38 | 4.37 |
| 27 | 0.0078 | 2.17 | 1.22 | 3.87 |
| 19 | 0.1 | 1.61 | 0.91 | 2.86 |
| 10 | 0.19 | 1.46 | 0.82 | 2.59 |
| 4 | 0.049 | 1.82 | 1.024 | 3.22 |
| 2 | 0.0297 | 1.89 | 1.067 | 3.36 |

The full 37-gene signature results in the largest hazard ratio, however statistically significant response-group stratification of patients was observed with as few as two (2) genes. Therefore the minimum gene set required for prediction of treatment response is two genes.

A 160-gene prognosis signature identified patients with stage I/II adenocarcinoma who are at increased risk of death, independent to age, stage and gender (Hazard ratio: 2.33, P<0.0001). The gene signature is superior to stage and clinical assessments of prognosis at identifying poor-prognosis early stage patients, potentially warranting a monitoring or treatment regimen in these individuals different to the current standard of care. A set of 37 genes were found to be associated with outcome in patients receiving ACT, independent to their prognosis score. These were used to stratify an independent series of early-stage NSCLC participants in a randomized controlled trial of adjuvant vinorelbine/cisplatin (ACT) vs. observation alone (OBS). For those patients with the ACT-response signature (73%), receiving ACT resulted in a 4.0-fold risk-reduction for death from lung cancer (adjusted for covariates, P=0.0051). No difference was observed between treatment arms for those patients predicted to be ‘non-responders’ (P=0.85).

In summary, the invention provides gene markers listed in Table 1, Table 3, Table 6, Table 8, and Table 9, the specific oligonucleotide probe sequences of which are provided in the appended Sequence Listing, which can be used in methods to determine tumor tissue of origin in cancer patients, prognosis of breast cancer recurrence, prognosis of colon cancer recurrence, prognosis of non-small cell lung cancer and treatment response of non-small-cell lung cancer respectively. Also provided are methods of use of the gene marker (polynucleotide) sets.

The specific embodiments described herein are offered by way of example only, and the invention is to be limited only by the terms of the appended claims along with the full scope of equivalents to which such claims are entitled.

TABLE 1
List of probes used for tumor origin prediction

| | Genbank | | | | |
|---|---|---|---|---|---|
| Affymetrix | Accession | | Affymetrix | Genbank | |
| Probeset | No | SEQ ID NOS | Probeset | Accession No | SEQ ID NOS |
| 1431_at | J02843 | 477-492 | 211793_s_at | AF260261 | 12285-12291 |
| 1552378_s_at | NM_172037 | 493-503 | 211797_s_at | U62296 | 12292-12302 |
| 1552487_a_at | NM_001717 | 504-514 | 211843_x_at | AF315325 | 12303-12312 |
| 1552496_a_at | NM_015198 | 515-525 | 211848_s_at | AF006623 | 12313-12323 |
| 1552575_a_at | NM_153344 | 526-536 | 211881_x_at | AB014341 | 12324-12334 |
| 1552627_a_at | NM_001173 | 537-547 | 211882_x_at | U27331 | 12335-12345 |
| 1552648_a_at | NM_003844 | 548-558 | 211883_x_at | M76742 | 12346-12356 |
| 1552742_at | NM_144633 | 559-569 | 211889_x_at | D12502 | 12357-12362 |
| 1552754_a_at | AA640422 | 570-580 | 211890_x_at | AF127765 | 12363-12373 |
| 1553081_at | NM_080869 | 581-591 | 211896_s_at | AF138302 | 12374-12384 |
| 1553089_a_at | NM_080736 | 592-602 | 211906_s_at | AB046400 | 12385-12393 |
| 1553169_at | BC019612 | 603-613 | 211934_x_at | W87689 | 12394-12404 |
| 1553179_at | NM_133638 | 614-624 | 211945_s_at | BG500301 | 12405-12415 |
| 1553394_a_at | NM_003221 | 625-635 | 211960_s_at | BG261416 | 12416-12426 |
| 1553413_at | NM_025011 | 636-646 | 211974_x_at | AL513759 | 351-361 |
| 1553434_at | NM_173534 | 647-657 | 212014_x_at | AI493245 | 12427-12427 |
| 1553530_a_at | NM_033669 | 658-668 | 212063_at | BE903880 | 12428-12438 |
| 1553589_a_at | NM_005764 | 669-679 | 212089_at | M13452 | 12439-12449 |
| 1553602_at | NM_058173 | 680-690 | 212092_at | BE858180 | 12450-12460 |
| 1553605_a_at | NM_152701 | 691-701 | 212094_at | AL582836 | 225-235 |
| 1553622_a_at | NM_152597 | 702-712 | 212224_at | NM_000689 | 236-246 |
| 1553808_a_at | NM_145285 | 713-723 | 212233_at | AL523076 | 12461-12471 |
| 1554375_a_at | AF478446 | 724-734 | 212236_x_at | Z19574 | 12472-12482 |
| 1554436_a_at | AY126671 | 735-745 | 212252_at | AA181179 | 12483-12493 |
| 1554459_s_at | BC020687 | 746-756 | 212285_s_at | AW008051 | 12494-12504 |
| 1554460_at | BC027866 | 757-767 | 212287_at | BF382924 | 12505-12515 |
| 1554491_a_at | BC022309 | 768-778 | 212339_at | AL121895 | 12516-12526 |
| 1554547_at | BC036453 | 779-789 | 212444_at | AA156240 | 12527-12537 |
| 1554592_a_at | BC028721 | 790-800 | 212486_s_at | N20923 | 12538-12548 |
| 1554600_s_at | BC033088 | 801-811 | 212558_at | BF508662 | 12549-12559 |
| 1554789_a_at | AB085825 | 812-822 | 212587_s_at | AI809341 | 362-372 |
| 1555236_a_at | BC042578 | 823-833 | 212588_at | Y00062 | 12560-12570 |
| 1555349_a_at | L78790 | 834-844 | 212624_s_at | BF339445 | 12571-12581 |
| 1555383_a_at | BC017500 | 845-855 | 212636_at | AL031781 | 12582-12592 |
| 1555404_a_at | BC029819 | 856-866 | 212654_at | AL566786 | 12593-12603 |
| 1555497_a_at | AY151049 | 867-877 | 212657_s_at | U65590 | 12604-12614 |
| 1555520_at | BC043542 | 878-888 | 212688_at | BC003393 | 12615-12625 |
| 1555778_a_at | AY140646 | 889-899 | 212713_at | R72286 | 12626-12636 |
| 1555779_a_at | M74721 | 900-910 | 212741_at | AA923354 | 12637-12647 |
| 1555814_a_at | AF498970 | 911-921 | 212764_at | AI806174 | 12648-12658 |
| 1555854_at | AA594609 | 922-932 | 212768_s_at | AL390736 | 12659-12669 |
| 1556116_s_at | AI825808 | 933-943 | 212780_at | AA700167 | 12670-12680 |
| 1556168_s_at | BC042133 | 944-954 | 212816_s_at | BE613178 | 12681-12691 |
| 1556194_a_at | BC042959 | 955-965 | 212843_at | AA126505 | 12692-12702 |
| 1556474_a_at | AK095698 | 966-976 | 212909_at | AL567376 | 12703-12713 |
| 1556641_at | AK094547 | 977-987 | 212925_at | AA143765 | 12714-12724 |
| 1556773_at | M31157 | 988-998 | 212935_at | AB002360 | 12725-12735 |
| 1556793_a_at | AK091138 | 999-1009 | 212983_at | NM_005343 | 12736-12746 |
| 1557053_s_at | BC035653 | 1010-1020 | 212992_at | AI935123 | 12747-12757 |
| 1557122_s_at | BC036592 | 1021-1031 | 213002_at | AA770596 | 12758-12768 |
| 1557136_at | BG059633 | 1032-1042 | 213022_s_at | NM_007124 | 12769-12779 |
| 1557146_a_at | T03074 | 1043-1053 | 213036_x_at | Y15724 | 12780-12787 |
| 1557382_x_at | AI659151 | 1054-1064 | 213050_at | AA594937 | 428-438 |
| 1557417_s_at | AA844689 | 1065-1075 | 213068_at | AI146848 | 12788-12798 |
| 1557545_s_at | BF529886 | 1076-1086 | 213093_at | AI471375 | 12799-12809 |
| 1557651_x_at | AK096127 | 1087-1097 | 213106_at | AI769688 | 12810-12820 |
| 1557905_s_at | AL552534 | 1098-1108 | 213143_at | BE856707 | 12821-12831 |
| 1557921_s_at | BC013914 | 1109-1119 | 213150_at | BF792917 | 12832-12842 |
| 1558093_s_at | BI832461 | 1120-1130 | 213201_s_at | AJ011712 | 12843-12853 |
| 1558189_a_at | BG819064 | 1131-1141 | 213228_at | AK023913 | 12854-12863 |
| 1558214_s_at | BG330076 | 1142-1152 | 213240_s_at | X07695 | 12864-12874 |
| 1558388_a_at | R41806 | 1153-1163 | 213265_at | AI570199 | 12875-12885 |
| 1558549_s_at | BG120535 | 1164-1174 | 213276_at | T15766 | 12886-12896 |
| 1558775_s_at | AU142380 | 1175-1185 | 213294_at | AV755522 | 12897-12907 |
| 1558795_at | AL833240 | 1186-1196 | 213355_at | AI989567 | 12908-12918 |
| 1558796_a_at | AL833240 | 1197-1207 | 213385_at | AK026415 | 12919-12929 |
| 1558828_s_at | AL703532 | 1208-1218 | 213395_at | AL022327 | 12930-12940 |
| 1559064_at | BC035502 | 1219-1229 | 213417_at | AW173045 | 12941-12951 |
| 1559203_s_at | BC029545 | 1230-1240 | 213421_x_at | AW007273 | 12952-12953 |
| 1559239_s_at | AW750026 | 1241-1251 | 213438_at | AA995925 | 12954-12964 |
| 1559459_at | BC043571 | 1252-1262 | 213441_x_at | AI745526 | 247-248 |
| 1559477_s_at | AL832770 | 1263-1273 | 213482_at | BF593175 | 12965-12975 |
| 1559606_at | AL703282 | 1274-1284 | 213486_at | BF435376 | 12976-12986 |
| 1559607_s_at | AL703282 | 1285-1295 | 213487_at | AI762811 | 12987-12997 |
| 1559949_at | T56980 | 1296-1306 | 213492_at | X06268 | 12998-13008 |
| 1559965_at | BC037827 | 1307-1317 | 213506_at | BE965369 | 13009-13019 |
| 1560225_at | AI434253 | 1318-1328 | 213523_at | AI671049 | 13020-13030 |
| 1560770_at | BQ719658 | 1329-1339 | 213573_at | AA861608 | 13031-13041 |
| 1560850_at | BC016831 | 1340-1350 | 213574_s_at | AA861608 | 13042-13052 |
| 1561421_a_at | AK057259 | 1351-1361 | 213596_at | AL050391 | 13053-13063 |
| 1561658_at | AF086066 | 1362-1372 | 213609_s_at | AB023144 | 13064-13074 |
| 1561817_at | BF681305 | 1373-1383 | 213638_at | AW054711 | 13075-13085 |
| 1561956_at | AF085947 | 1384-1394 | 213674_x_at | AI858004 | 13086-13096 |
| 1562981_at | AY034472 | 1395-1405 | 213680_at | AI831452 | 13097-13107 |
| 1564307_a_at | AL832750 | 1406-1416 | 213693_s_at | AI610869 | 13108-13118 |
| 1564494_s_at | AK075503 | 1417-1427 | 213695_at | L48516 | 13119-13129 |
| 1565162_s_at | D16947 | 1428-1438 | 213707_s_at | NM_005221 | 13130-13140 |
| 1565228_s_at | D16931 | 1439-1449 | 213721_at | L07335 | 13141-13151 |
| 1565269_s_at | AF047022 | 1450-1460 | 213724_s_at | AI870615 | 13152-13162 |
| 1565868_at | W96225 | 1461-1471 | 213766_x_at | N36926 | 13163-13173 |
| 1565936_a_at | T24091 | 1472-1482 | 213791_at | NM_006211 | 13174-13184 |
| 1566140_at | AK096707 | 1483-1493 | 213800_at | X04697 | 13185-13195 |
| 1566764_at | AL359055 | 1494-1504 | 213803_at | BG545463 | 13196-13206 |
| 1568603_at | AI912173 | 1505-1515 | 213825_at | AA757419 | 13207-13217 |
| 1568604_a_at | AI912173 | 1516-1526 | 213841_at | BE223030 | 13218-13228 |
| 1569361_a_at | BC028018 | 1527-1537 | 213849_s_at | AA974416 | 13229-13239 |
| 1569872_a_at | BC036550 | 1538-1548 | 213870_at | AL031228 | 13240-13250 |
| 1569886_a_at | BC040605 | 1549-1559 | 213880_at | AL524520 | 13251-13261 |
| 160020_at | Z48481 | 1560-1575 | 213909_at | AU147799 | 13262-13272 |
| 1729_at | L41690 | 271-286 | 213917_at | BE465829 | 13273-13283 |
| 1861_at | U66879 | 1576-1591 | 213920_at | AB006631 | 13284-13294 |
| 200059_s_at | BC001360 | 1592-1602 | 213943_at | X99268 | 13295-13305 |
| 200602_at | NM_000484 | 1603-1613 | 213944_x_at | BG236220 | 13306-13311 |
| 200604_s_at | M18468 | 1614-1624 | 213947_s_at | AI867102 | 13312-13322 |
| 200606_at | NM_004415 | 1625-1635 | 213953_at | AI732381 | 13323-13333 |
| 200624_s_at | AA577695 | 1636-1646 | 213980_s_at | AA053830 | 13334-13344 |
| 200664_s_at | BG537255 | 1647-1657 | 213992_at | AI889941 | 13345-13355 |
| 200693_at | NM_006826 | 1658-1668 | 213993_at | AI885290 | 13356-13366 |
| 200697_at | NM_000188 | 1669-1679 | 213994_s_at | AI885290 | 13367-13377 |
| 200764_s_at | AI826881 | 1680-1689 | 214014_at | W81196 | 13378-13388 |
| 200765_x_at | NM_001903 | 1690-1699 | 214053_at | AW772192 | 13389-13399 |
| 200771_at | NM_002293 | 1700-1710 | 214063_s_at | AI073407 | 13400-13410 |
| 200832_s_at | AB032261 | 1711-1721 | 214069_at | AA865601 | 13411-13421 |
| 200863_s_at | AI215102 | 1722-1732 | 214070_s_at | AW006935 | 13422-13432 |
| 200931_s_at | NM_014000 | 22-Dec | 214074_s_at | BG475299 | 13433-13443 |
| 201016_at | BE542684 | 1733-1743 | 214079_at | AK000345 | 13444-13454 |
| 201017_at | BG149698 | 1744-1754 | 214087_s_at | BF593509 | 13455-13465 |
| 201019_s_at | NM_001412 | 1755-1765 | 214091_s_at | AW149846 | 13466-13476 |
| 201058_s_at | NM_006097 | 1766-1776 | 214119_s_at | AI936769 | 13477-13487 |
| 201059_at | NM_005231 | 1777-1787 | 214133_at | AI611214 | 13488-13498 |
| 201092_at | NM_002893 | 1788-1798 | 214135_at | BE551219 | 13499-13509 |
| 201109_s_at | AV726673 | 1799-1809 | 214142_at | AI732905 | 13510-13520 |
| 201116_s_at | AI922855 | 1810-1820 | 214147_at | AL046350 | 13521-13531 |
| 201128_s_at | NM_001096 | 1821-1831 | 214157_at | AA401492 | 13532-13542 |
| 201131_s_at | NM_004360 | 1832-1842 | 214164_x_at | BF752277 | 13543-13553 |
| 201202_at | NM_002592 | 287-297 | 214199_at | NM_003019 | 13554-13564 |
| 201209_at | NM_004964 | 1843-1853 | 214219_x_at | BE646618 | 13565-13565 |
| 201234_at | NM_004517 | 1854-1864 | 214235_at | X90579 | 13566-13576 |
| 201235_s_at | BG339064 | 1865-1875 | 214243_s_at | AL450314 | 13577-13587 |
| 201242_s_at | BC000006 | 1876-1886 | 214247_s_at | AU148057 | 13588-13598 |
| 201262_s_at | NM_001711 | 1887-1897 | 214259_s_at | AI144075 | 13599-13609 |
| 201286_at | Z48199 | 1898-1908 | 214303_x_at | AW192795 | 13610-13620 |
| 201288_at | NM_001175 | 298-308 | 214324_at | BF222483 | 13621-13631 |
| 201328_at | AL575509 | 1909-1919 | 214339_s_at | AA744529 | 13632-13637 |
| 201329_s_at | NM_005239 | 1920-1930 | 214352_s_at | BF673699 | 13638-13648 |
| 201349_at | NM_004252 | 1931-1941 | 214370_at | AW238654 | 13649-13659 |
| 201401_s_at | M80776 | 1942-1952 | 214385_s_at | AI521646 | 13660-13666 |
| 201415_at | NM_000178 | 1953-1963 | 214387_x_at | AA633841 | 13667-13671 |
| 201428_at | NM_001305 | 1964-1974 | 214411_x_at | AW584011 | 13672-13682 |
| 201431_s_at | NM_001387 | 1975-1985 | 214421_x_at | AV652420 | 13683-13693 |
| 201435_s_at | AW268640 | 1986-1996 | 214448_x_at | NM_002503 | 13694-13704 |
| 201436_at | AI742789 | 1997-2007 | 214451_at | NM_003221 | 13705-13715 |
| 201437_s_at | NM_001968 | 2008-2018 | 214465_at | NM_000608 | 13716-13726 |
| 201453_x_at | NM_005614 | 2019-2029 | 214475_x_at | AF127764 | 13727-13732 |
| 201461_s_at | NM_004759 | 2030-2040 | 214476_at | NM_005423 | 13733-13743 |
| 201464_x_at | BG491844 | 2041-2051 | 214487_s_at | NM_002886 | 13744-13754 |
| 201465_s_at | BC002646 | 2052-2062 | 214510_at | NM_005293 | 13755-13765 |
| 201466_s_at | NM_002228 | 2063-2073 | 214528_s_at | NM_013951 | 13766-13775 |
| 201468_s_at | NM_000903 | 2074-2084 | 214549_x_at | NM_005987 | 13776-13786 |
| 201495_x_at | AI889739 | 2085-2095 | 214577_at | BG164365 | 13787-13797 |
| 201496_x_at | S67238 | 2096-2106 | 214580_x_at | AL569511 | 13798-13808 |
| 201525_at | NM_001647 | 2107-2117 | 214590_s_at | AL545760 | 13809-13819 |
| 201528_at | BG398414 | 2118-2128 | 214598_at | AL049977 | 13820-13830 |
| 201585_s_at | BG035151 | 2129-2139 | 214599_at | NM_005547 | 13831-13841 |
| 201587_s_at | NM_001569 | 2140-2150 | 214601_at | AI350339 | 13842-13852 |
| 201596_x_at | NM_000224 | 2151-2161 | 214624_at | AA548647 | 13853-13863 |
| 201599_at | NM_000274 | 2162-2172 | 214639_s_at | S79910 | 13864-13874 |
| 201650_at | NM_002276 | 2173-2183 | 214651_s_at | U41813 | 13875-13885 |
| 201666_at | NM_003254 | 23-33 | 214669_x_at | BG485135 | 13886-13896 |
| 201727_s_at | NM_001419 | 2184-2194 | 214677_x_at | X57812 | 13897-13907 |
| 201755_at | NM_006739 | 2195-2205 | 214679_x_at | AL110227 | 13908-13912 |
| 201787_at | NM_001996 | 2206-2216 | 214680_at | BF674712 | 13913-13923 |
| 201792_at | NM_001129 | 2217-2227 | 214726_x_at | AL556041 | 13924-13934 |
| 201820_at | NM_000424 | 2228-2238 | 214803_at | BF344237 | 13935-13945 |
| 201839_s_at | NM_002354 | 2239-2249 | 214811_at | AB002316 | 13946-13956 |
| 201841_s_at | NM_001540 | 2250-2260 | 214842_s_at | M12523 | 13957-13967 |
| 201849_at | NM_004052 | 2261-2271 | 214895_s_at | AU135154 | 13968-13978 |
| 201860_s_at | NM_000930 | 2272-2282 | 214898_x_at | AB038783 | 13979-13989 |
| 201865_x_at | AI432196 | 171-181 | 214908_s_at | AC004893 | 13990-14000 |
| 201866_s_at | NM_000176 | 2283-2293 | 214917_at | AK024252 | 14001-14011 |
| 201884_at | NM_004363 | 2294-2304 | 214953_s_at | X06989 | 14012-14022 |
| 201903_at | NM_003365 | 2305-2315 | 214977_at | AK023852 | 14023-14033 |
| 201957_at | AF324888 | 2316-2326 | 214993_at | AF070642 | 14034-14044 |
| 201958_s_at | NM_002481 | 2327-2337 | 215037_s_at | U72398 | 14045-14055 |
| 202005_at | NM_021978 | 2338-2348 | 215045_at | BC004145 | 14056-14066 |
| 202068_s_at | NM_000527 | 34-44 | 215050_x_at | BG325734 | 14067-14076 |
| 202097_at | NM_005124 | 2349-2359 | 215059_at | AA053967 | 14077-14087 |
| 202178_at | NM_002744 | 2360-2370 | 215075_s_at | L29511 | 14088-14098 |
| 202219_at | NM_005629 | 2371-2381 | 215103_at | AW192911 | 14099-14109 |
| 202222_s_at | NM_001927 | 2382-2392 | 215214_at | H53689 | 14110-14120 |
| 202226_s_at | NM_016823 | 2393-2403 | 215240_at | AI189839 | 14121-14131 |
| 202260_s_at | NM_003165 | 2404-2414 | 215244_at | AI479306 | 14132-14142 |
| 202267_at | NM_005562 | 2415-2425 | 215356_at | AK023134 | 14143-14153 |
| 202274_at | NM_001615 | 2426-2436 | 215363_x_at | AW168915 | 14154-14156 |
| 202286_s_at | J04152 | 2437-2447 | 215382_x_at | AF206666 | 14157-14160 |
| 202291_s_at | NM_000900 | 2448-2458 | 215388_s_at | X56210 | 14161-14171 |
| 202329_at | NM_004383 | 2459-2469 | 215432_at | AC003034 | 14172-14182 |
| 202351_at | AI093579 | 2470-2480 | 215443_at | BE740743 | 14183-14193 |
| 202354_s_at | AW190445 | 2481-2491 | 215444_s_at | X81006 | 14194-14204 |
| 202357_s_at | NM_001710 | 2492-2502 | 215447_at | AL080215 | 14205-14215 |
| 202363_at | AF231124 | 2503-2513 | 215454_x_at | AI831055 | 14216-14224 |
| 202376_at | NM_001085 | 2514-2524 | 215464_s_at | AK001327 | 14225-14235 |
| 202409_at | X07868 | 2525-2535 | 215530_at | BG484069 | 14236-14246 |
| 202410_x_at | NM_000612 | 2536-2546 | 215574_at | AU144294 | 14247-14257 |
| 202411_at | NM_005532 | 2547-2557 | 215621_s_at | BG340670 | 14258-14268 |
| 202417_at | NM_012289 | 2558-2568 | 215688_at | AL359931 | 14269-14279 |
| 202425_x_at | NM_000944 | 2569-2579 | 215702_s_at | W60595 | 14280-14290 |
| 202429_s_at | AL353950 | 2580-2590 | 215704_at | AL356504 | 14291-14301 |
| 202449_s_at | NM_002957 | 2591-2601 | 215729_s_at | BE542323 | 14302-14312 |
| 202454_s_at | NM_001982 | 2602-2612 | 215806_x_at | M13231 | 14313-14315 |
| 202457_s_at | AA911231 | 45-55 | 215807_s_at | AV693216 | 14316-14326 |
| 202484_s_at | AF072242 | 2613-2623 | 215813_s_at | S36219 | 14327-14334 |
| 202489_s_at | BC005238 | 2624-2634 | 215946_x_at | AL022324 | 14335-14345 |
| 202504_at | NM_012101 | 384-394 | 215987_at | AV654984 | 14346-14356 |
| 202508_s_at | NM_003081 | 2635-2645 | 216025_x_at | M21940 | 14357-14360 |
| 202514_at | AW139131 | 2646-2656 | 216056_at | AW851559 | 14361-14371 |
| 202523_s_at | AI952009 | 2657-2667 | 216059_at | U02309 | 14372-14382 |
| 202525_at | NM_002773 | 2668-2678 | 216086_at | AB028977 | 14383-14393 |
| 202527_s_at | NM_005359 | 2679-2689 | 216199_s_at | AL109942 | 14394-14398 |
| 202528_at | NM_000403 | 2690-2700 | 216206_x_at | BC005365 | 14399-14409 |
| 202555_s_at | NM_005965 | 309-319 | 216237_s_at | AA807529 | 14410-14420 |
| 202575_at | NM_001878 | 2701-2711 | 216238_s_at | BG545288 | 14421-14431 |
| 202604_x_at | NM_001110 | 2712-2722 | 216243_s_at | BE563442 | 14432-14442 |
| 202615_at | BF222895 | 2723-2733 | 216258_s_at | BE148534 | 14443-14453 |
| 202618_s_at | L37298 | 2734-2744 | 216261_at | AI151479 | 14454-14464 |
| 202625_at | AI356412 | 2745-2755 | 216321_s_at | X03348 | 14465-14475 |
| 202626_s_at | NM_002350 | 2756-2766 | 216326_s_at | AF059650 | 14476-14486 |
| 202627_s_at | AL574210 | 2767-2777 | 216331_at | AK022548 | 14487-14497 |
| 202628_s_at | NM_000602 | 2778-2788 | 216339_s_at | AF086641 | 14498-14508 |
| 202637_s_at | AI608725 | 2789-2799 | 216379_x_at | AK000168 | 14509-14510 |
| 202638_s_at | NM_000201 | 2800-2810 | 216412_x_at | AF043584 | 14511-14521 |
| 202652_at | NM_001164 | 2811-2821 | 216430_x_at | AF043586 | 14522-14532 |
| 202677_at | NM_002890 | 2822-2832 | 216470_x_at | AF009664 | 14533-14542 |
| 202687_s_at | U57059 | 2833-2843 | 216474_x_at | AF206667 | 14543-14543 |
| 202688_at | NM_003810 | 2844-2854 | 216594_x_at | S68290 | 14544-14547 |
| 202704_at | AA675892 | 2855-2865 | 216623_x_at | AK025084 | 14548-14558 |
| 202718_at | NM_000597 | 2866-2876 | 216661_x_at | M15331 | 14559-14563 |
| 202762_at | AL049383 | 2877-2887 | 216687_x_at | U06641 | 14564-14571 |
| 202765_s_at | AI264196 | 2888-2898 | 216733_s_at | X86401 | 14572-14582 |
| 202787_s_at | U43784 | 2899-2909 | 216840_s_at | AK026829 | 14583-14593 |
| 202788_at | NM_004635 | 2910-2920 | 216918_s_at | AL096710 | 14594-14604 |
| 202790_at | NM_001307 | 2921-2931 | 216920_s_at | M27331 | 14605-14610 |
| 202820_at | NM_001621 | 2932-2942 | 216942_s_at | D28586 | 14611-14621 |
| 202825_at | NM_001151 | 2943-2953 | 216953_s_at | S75264 | 14622-14632 |
| 202831_at | NM_002083 | 2954-2964 | 216963_s_at | AF279774 | 14633-14643 |
| 202844_s_at | AW025261 | 2965-2975 | 217014_s_at | AC004522 | 249-259 |
| 202850_at | NM_002858 | 2976-2986 | 217023_x_at | AF099143 | 14644-14648 |
| 202864_s_at | NM_003113 | 2987-2997 | 217057_s_at | AF107846 | 14649-14659 |
| 202880_s_at | NM_004762 | 2998-3008 | 217073_x_at | X02162 | 14660-14660 |
| 202917_s_at | NM_002964 | 3009-3019 | 217077_s_at | AF095723 | 14661-14664 |
| 202927_at | NM_006221 | 3020-3030 | 217109_at | AJ242547 | 14665-14675 |
| 202928_s_at | NM_024165 | 3031-3041 | 217110_s_at | AJ242547 | 14676-14686 |
| 202935_s_at | AI382146 | 3042-3052 | 217133_x_at | X06399 | 14687-14697 |
| 202949_s_at | NM_001450 | 56-66 | 217157_x_at | AF103530 | 14698-14708 |
| 202950_at | NM_001889 | 3053-3063 | 217165_x_at | M10943 | 14709-14719 |
| 202965_s_at | NM_014289 | 3064-3074 | 217179_x_at | X79782 | 14720-14730 |
| 202997_s_at | BE251211 | 3075-3085 | 217227_x_at | X93006 | 14731-14741 |
| 203000_at | BF967657 | 3086-3096 | 217234_s_at | AF199015 | 14742-14752 |
| 203001_s_at | NM_007029 | 3097-3107 | 217258_x_at | AF043583 | 14753-14762 |
| 203021_at | NM_003064 | 3108-3118 | 217272_s_at | AJ001698 | 14763-14773 |
| 203029_s_at | NM_002847 | 3119-3129 | 217276_x_at | AL590118 | 14774-14784 |
| 203031_s_at | NM_000375 | 3130-3140 | 217284_x_at | AL589866 | 14785-14788 |
| 203074_at | NM_001630 | 3141-3151 | 217294_s_at | U88968 | 14789-14799 |
| 203108_at | NM_003979 | 3152-3162 | 217299_s_at | AK001017 | 14800-14810 |
| 203116_s_at | NM_000140 | 3163-3173 | 217404_s_at | X16468 | 14811-14821 |
| 203129_s_at | BF059313 | 3174-3184 | 217422_s_at | X52785 | 14822-14832 |
| 203130_s_at | NM_004522 | 3185-3195 | 217428_s_at | X98568 | 14833-14843 |
| 203131_at | NM_006206 | 3196-3206 | 217480_x_at | M20812 | 14844-14854 |
| 203132_at | NM_000321 | 3207-3217 | 217512_at | BG398937 | 14855-14865 |
| 203151_at | AW296788 | 3218-3228 | 217523_at | AV700298 | 14866-14876 |
| 203157_s_at | AB020645 | 3229-3239 | 217528_at | BF003134 | 14877-14887 |
| 203158_s_at | AF097493 | 3240-3250 | 217558_at | BE971373 | 14888-14898 |
| 203159_at | NM_014905 | 3251-3261 | 217564_s_at | W80357 | 14899-14909 |
| 203167_at | NM_003255 | 3262-3272 | 217590_s_at | AA502609 | 14910-14920 |
| 203179_at | NM_000155 | 3273-3283 | 217626_at | BF508244 | 14921-14931 |
| 203180_at | NM_000693 | 3284-3294 | 217744_s_at | NM_022121 | 14932-14942 |
| 203221_at | AI758763 | 3295-3305 | 217767_at | NM_000064 | 14943-14953 |
| 203222_s_at | NM_005077 | 3306-3316 | 217888_s_at | NM_018209 | 14954-14964 |
| 203240_at | NM_003890 | 3317-3327 | 217901_at | BF031829 | 14965-14975 |
| 203269_at | NM_003580 | 3328-3338 | 217936_at | AW044631 | 14976-14986 |
| 203279_at | NM_014674 | 3339-3349 | 217946_s_at | NM_016402 | 14987-14997 |
| 203325_s_at | AI130969 | 3350-3360 | 218181_s_at | NM_017792 | 14998-15008 |
| 203348_s_at | BF060791 | 3361-3371 | 218186_at | NM_020387 | 15009-15019 |
| 203351_s_at | AF047598 | 3372-3382 | 218221_at | AL042842 | 15020-15030 |
| 203352_at | NM_002552 | 3383-3393 | 218261_at | NM_005498 | 15031-15041 |
| 203394_s_at | BE973687 | 3394-3404 | 218284_at | NM_015400 | 15042-15052 |
| 203395_s_at | NM_005524 | 3405-3415 | 218309_at | NM_018584 | 15053-15063 |
| 203397_s_at | BF063271 | 3416-3426 | 218311_at | NM_003618 | 15064-15074 |
| 203400_s_at | NM_001063 | 3427-3437 | 218338_at | NM_004426 | 15075-15085 |
| 203411_s_at | NM_005572 | 3438-3447 | 218353_at | NM_025226 | 15086-15096 |
| 203413_at | NM_006159 | 3448-3458 | 218380_at | NM_021730 | 15097-15107 |
| 203423_at | NM_002899 | 3459-3469 | 218468_s_at | AF154054 | 15108-15118 |
| 203438_at | AI435828 | 3470-3480 | 218469_at | NM_013372 | 15119-15129 |
| 203453_at | NM_001038 | 3481-3491 | 218484_at | NM_020142 | 15130-15140 |
| 203510_at | BG170541 | 3492-3502 | 218510_x_at | AI816291 | 15141-15151 |
| 203525_s_at | AI375486 | 3503-3513 | 218532_s_at | NM_019000 | 15152-15162 |
| 203526_s_at | M74088 | 184-194 | 218625_at | NM_016588 | 15163-15173 |
| 203535_at | NM_002965 | 3514-3524 | 218644_at | NM_016445 | 15174-15184 |
| 203540_at | NM_002055 | 3525-3535 | 218687_s_at | NM_017648 | 15185-15195 |
| 203562_at | NM_005103 | 3536-3546 | 218689_at | NM_022725 | 15196-15206 |
| 203571_s_at | NM_006829 | 3547-3557 | 218692_at | NM_017786 | 15207-15217 |
| 203581_at | BC002438 | 3558-3568 | 218704_at | NM_017763 | 15218-15228 |
| 203582_s_at | NM_004578 | 3569-3579 | 218796_at | NM_017671 | 15229-15239 |
| 203625_x_at | BG105365 | 3580-3590 | 218804_at | NM_018043 | 15240-15250 |
| 203627_at | AI830698 | 3591-3601 | 218806_s_at | AF118887 | 15251-15261 |
| 203628_at | H05812 | 3602-3612 | 218824_at | NM_018215 | 15262-15272 |
| 203632_s_at | NM_016235 | 3613-3623 | 218835_at | NM_006926 | 15273-15283 |
| 203649_s_at | NM_000300 | 3624-3634 | 218857_s_at | NM_025080 | 15284-15294 |
| 203660_s_at | NM_006031 | 3635-3645 | 218865_at | NM_022746 | 15295-15305 |
| 203662_s_at | NM_003275 | 3646-3656 | 218880_at | N36408 | 15306-15316 |
| 203673_at | NM_003235 | 3657-3667 | 218899_s_at | NM_024812 | 15317-15327 |
| 203680_at | NM_002736 | 3668-3678 | 218974_at | NM_018013 | 15328-15338 |
| 203691_at | NM_002638 | 3679-3689 | 218990_s_at | NM_005416 | 15339-15349 |
| 203699_s_at | U53506 | 3690-3700 | 219014_at | NM_016619 | 15350-15360 |
| 203724_s_at | NM_014961 | 3701-3711 | 219059_s_at | AL574194 | 15361-15371 |
| 203747_at | NM_004925 | 3712-3722 | 219087_at | NM_017680 | 15372-15382 |
| 203757_s_at | BC005008 | 3723-3733 | 219106_s_at | NM_006063 | 15383-15393 |
| 203771_s_at | AA740186 | 3734-3744 | 219107_at | NM_021948 | 15394-15404 |
| 203773_x_at | NM_000712 | 3745-3755 | 219121_s_at | NM_017697 | 15405-15415 |
| 203779_s_at | NM_005797 | 3756-3766 | 219183_s_at | NM_013385 | 15416-15426 |
| 203806_s_at | NM_000135 | 3767-3777 | 219186_at | NM_020224 | 15427-15437 |
| 203819_s_at | AU160004 | 3778-3788 | 219190_s_at | NM_017629 | 15438-15448 |
| 203824_at | NM_004616 | 3789-3799 | 219196_at | NM_013243 | 15449-15459 |
| 203843_at | AA906056 | 3800-3810 | 219197_s_at | AI424243 | 15460-15470 |
| 203844_at | NM_000551 | 3811-3821 | 219255_x_at | NM_018725 | 15471-15481 |
| 203851_at | NM_002178 | 3822-3832 | 219263_at | NM_024539 | 15482-15492 |
| 203861_s_at | AU146889 | 3833-3843 | 219271_at | NM_024572 | 15493-15503 |
| 203868_s_at | NM_001078 | 3844-3854 | 219274_at | NM_012338 | 15504-15514 |
| 203872_at | NM_001100 | 3855-3865 | 219288_at | NM_020685 | 260-270 |
| 203876_s_at | AI761713 | 3866-3876 | 219331_s_at | NM_018203 | 15515-15525 |
| 203889_at | NM_003020 | 3877-3887 | 219355_at | NM_018015 | 15526-15536 |
| 203892_at | NM_006103 | 3888-3898 | 219388_at | NM_024915 | 15537-15547 |
| 203895_at | AL535113 | 67-77 | 219404_at | NM_024526 | 15548-15558 |
| 203903_s_at | NM_014799 | 3899-3909 | 219412_at | NM_022337 | 15559-15569 |
| 203913_s_at | AL574184 | 3910-3920 | 219415_at | NM_020659 | 15570-15580 |
| 203914_x_at | NM_000860 | 3921-3931 | 219429_at | NM_024306 | 439-449 |
| 203929_s_at | AI056359 | 3932-3942 | 219434_at | NM_018643 | 15581-15591 |
| 203935_at | NM_001105 | 3943-3953 | 219465_at | NM_001643 | 15592-15602 |
| 203946_s_at | U75667 | 3954-3964 | 219466_s_at | NM_001643 | 15603-15613 |
| 203951_at | NM_001299 | 3965-3975 | 219508_at | NM_004751 | 15614-15624 |
| 203953_s_at | BE791251 | 3976-3986 | 219529_at | NM_004669 | 15625-15635 |
| 203954_x_at | NM_001306 | 3987-3997 | 219532_at | NM_022726 | 15636-15646 |
| 203961_at | AL157398 | 3998-4008 | 219554_at | NM_016321 | 15647-15657 |
| 203962_s_at | NM_006393 | 4009-4019 | 219564_at | NM_018658 | 15658-15668 |
| 203963_at | NM_001218 | 4020-4030 | 219580_s_at | NM_024780 | 15669-15679 |
| 203964_at | NM_004688 | 4031-4041 | 219591_at | NM_016564 | 15680-15690 |
| 203980_at | NM_001442 | 4042-4052 | 219597_s_at | NM_017434 | 15691-15701 |
| 204009_s_at | W80678 | 4053-4063 | 219612_s_at | NM_000509 | 15702-15712 |
| 204014_at | NM_001394 | 4064-4074 | 219630_at | NM_005764 | 15713-15722 |
| 204035_at | NM_003469 | 4075-4085 | 219643_at | NM_018557 | 15723-15733 |
| 204036_at | AW269335 | 4086-4096 | 219659_at | AU146927 | 15734-15744 |
| 204037_at | BF055366 | 4097-4107 | 219727_at | NM_014080 | 15745-15755 |
| 204038_s_at | NM_001401 | 4108-4118 | 219728_at | NM_006790 | 15756-15766 |
| 204039_at | NM_004364 | 4119-4129 | 219736_at | NM_018700 | 15767-15777 |
| 204053_x_at | U96180 | 4130-4140 | 219756_s_at | NM_024921 | 15778-15788 |
| 204058_at | AL049699 | 4141-4151 | 219764_at | NM_007197 | 15789-15799 |
| 204059_s_at | NM_002395 | 4152-4162 | 219772_s_at | NM_014332 | 15800-15810 |
| 204069_at | NM_002398 | 4163-4173 | 219775_s_at | NM_024695 | 15811-15821 |
| 204073_s_at | NM_013279 | 4174-4184 | 219795_at | NM_007231 | 15822-15832 |
| 204081_at | NM_006176 | 4185-4195 | 219803_at | NM_014495 | 15833-15843 |
| 204083_s_at | NM_003289 | 4196-4206 | 219804_at | NM_024875 | 15844-15854 |
| 204086_at | NM_006115 | 4207-4217 | 219829_at | NM_012278 | 15855-15865 |
| 204089_x_at | NM_006724 | 4218-4228 | 219836_at | NM_024508 | 15866-15876 |
| 204103_at | NM_002984 | 4229-4239 | 219873_at | NM_024027 | 15877-15887 |
| 204124_at | AF146796 | 4240-4250 | 219894_at | NM_019066 | 15888-15898 |
| 204151_x_at | NM_001353 | 4251-4261 | 219896_at | NM_015722 | 15899-15909 |
| 204159_at | NM_001262 | 4262-4272 | 219902_at | NM_017614 | 15910-15920 |
| 204165_at | NM_003931 | 4273-4283 | 219909_at | NM_024302 | 15921-15931 |
| 204171_at | NM_003161 | 4284-4294 | 219914_at | NM_004826 | 15932-15942 |
| 204179_at | NM_005368 | 4295-4305 | 219936_s_at | NM_023915 | 15943-15953 |
| 204192_at | NM_001774 | 4306-4316 | 219948_x_at | NM_024743 | 15954-15964 |
| 204201_s_at | NM_006264 | 4317-4327 | 219949_at | NM_024512 | 15965-15975 |
| 204225_at | NM_006037 | 4328-4338 | 219954_s_at | NM_020973 | 15976-15986 |
| 204247_s_at | NM_004935 | 4339-4349 | 219993_at | NM_022454 | 15987-15997 |
| 204248_at | NM_002067 | 4350-4360 | 219995_s_at | NM_024702 | 15998-16008 |
| 204252_at | M68520 | 4361-4371 | 220013_at | NM_024794 | 16009-16019 |
| 204254_s_at | NM_000376 | 4372-4382 | 220017_x_at | NM_000771 | 16020-16023 |
| 204259_at | NM_002423 | 4383-4393 | 220026_at | NM_012128 | 16024-16034 |
| 204260_at | NM_001819 | 4394-4404 | 220035_at | NM_024923 | 16035-16045 |
| 204268_at | NM_005978 | 4405-4415 | 220037_s_at | NM_016164 | 16046-16056 |
| 204272_at | NM_006149 | 4416-4426 | 220056_at | NM_021258 | 16057-16067 |
| 204273_at | NM_000115 | 4427-4437 | 220057_at | NM_020411 | 16068-16078 |
| 204320_at | NM_001854 | 4438-4448 | 220059_at | NM_012108 | 16079-16089 |
| 204337_at | AL514445 | 4449-4459 | 220074_at | NM_017717 | 16090-16100 |
| 204359_at | NM_013231 | 4460-4470 | 220084_at | NM_018168 | 16101-16111 |
| 204363_at | NM_001993 | 4471-4481 | 220100_at | NM_018484 | 16112-16122 |
| 204378_at | NM_003657 | 4482-4492 | 220106_at | NM_013389 | 16123-16133 |
| 204379_s_at | NM_000142 | 4493-4503 | 220116_at | NM_021614 | 16134-16144 |
| 204393_s_at | NM_001099 | 4504-4514 | 220148_at | NM_022568 | 16145-16155 |
| 204412_s_at | NM_021076 | 4515-4525 | 220187_at | NM_024636 | 16156-16166 |
| 204420_at | BG251266 | 4526-4536 | 220191_at | NM_019617 | 16167-16177 |
| 204424_s_at | AL050152 | 4537-4547 | 220196_at | NM_024690 | 16178-16188 |
| 204437_s_at | NM_016725 | 4548-4558 | 220224_at | NM_017545 | 16189-16199 |
| 204450_x_at | NM_000039 | 4559-4569 | 220233_at | NM_024907 | 16200-16210 |
| 204454_at | NM_012317 | 4570-4580 | 220260_at | NM_018317 | 16211-16221 |
| 204455_at | NM_001723 | 4581-4591 | 220273_at | NM_014443 | 16222-16232 |
| 204456_s_at | AW611727 | 4592-4602 | 220275_at | NM_022034 | 16233-16243 |
| 204460_s_at | AF074717 | 4603-4613 | 220316_at | NM_022123 | 16244-16254 |
| 204465_s_at | NM_004692 | 4614-4624 | 220359_s_at | NM_016300 | 16255-16265 |
| 204466_s_at | BG260394 | 4625-4635 | 220392_at | NM_022659 | 16266-16276 |
| 204467_s_at | NM_000345 | 4636-4646 | 220393_at | NM_016571 | 16277-16287 |
| 204469_at | NM_002851 | 4647-4657 | 220414_at | NM_017422 | 16288-16298 |
| 204471_at | NM_002045 | 4658-4668 | 220421_at | NM_024850 | 16299-16309 |
| 204489_s_at | NM_000610 | 4669-4679 | 220468_at | NM_025047 | 16310-16320 |
| 204490_s_at | M24915 | 4680-4690 | 220502_s_at | NM_022444 | 16321-16331 |
| 204503_at | NM_001988 | 4691-4701 | 220542_s_at | NM_016583 | 16332-16342 |
| 204508_s_at | BC001012 | 4702-4712 | 220620_at | NM_019060 | 16343-16353 |
| 204532_x_at | NM_021027 | 4713-4723 | 220639_at | NM_024795 | 16354-16364 |
| 204534_at | NM_000638 | 4724-4734 | 220645_at | NM_017678 | 16365-16375 |
| 204537_s_at | NM_004961 | 4735-4745 | 220658_s_at | NM_020183 | 450-460 |
| 204548_at | NM_000349 | 4746-4756 | 220664_at | NM_006518 | 16376-16386 |
| 204551_s_at | NM_001622 | 4757-4767 | 220723_s_at | NM_025087 | 16387-16397 |
| 204561_x_at | NM_000483 | 4768-4778 | 220724_at | NM_025087 | 16398-16408 |
| 204579_at | NM_002011 | 4779-4789 | 220751_s_at | NM_016348 | 16409-16419 |
| 204581_at | NM_001771 | 4790-4800 | 220773_s_at | NM_020806 | 16420-16430 |
| 204582_s_at | NM_001648 | 4801-4811 | 220779_at | NM_016233 | 16431-16441 |
| 204583_x_at | U17040 | 4812-4822 | 220816_at | NM_012152 | 16442-16452 |
| 204602_at | NM_012242 | 4823-4833 | 220834_at | NM_017716 | 16453-16463 |
| 204612_at | NM_006823 | 4834-4844 | 220994_s_at | NM_014178 | 16464-16474 |
| 204614_at | NM_002575 | 4845-4855 | 221003_s_at | NM_030925 | 16475-16485 |
| 204623_at | NM_003226 | 4856-4866 | 221009_s_at | NM_016109 | 16486-16496 |
| 204631_at | NM_017534 | 4867-4877 | 221132_at | NM_016369 | 16497-16507 |
| 204636_at | NM_000494 | 4878-4888 | 221133_s_at | NM_016369 | 16508-16518 |
| 204653_at | BF343007 | 4889-4899 | 221204_s_at | NM_018058 | 16519-16529 |
| 204654_s_at | NM_003220 | 4900-4910 | 221215_s_at | NM_020639 | 16530-16540 |
| 204661_at | NM_001803 | 4911-4921 | 221236_s_at | NM_030795 | 16541-16551 |
| 204667_at | NM_004496 | 4922-4932 | 221239_s_at | NM_030764 | 16552-16562 |
| 204673_at | NM_002457 | 4933-4943 | 221241_s_at | NM_030766 | 16563-16573 |
| 204678_s_at | U90065 | 4944-4954 | 221424_s_at | NM_030774 | 16574-16584 |
| 204697_s_at | NM_001275 | 4955-4965 | 221530_s_at | BE857425 | 16585-16595 |
| 204713_s_at | AA910306 | 4966-4976 | 221539_at | AB044548 | 16596-16606 |
| 204714_s_at | NM_000130 | 4977-4987 | 221571_at | AI721219 | 16607-16617 |
| 204724_s_at | NM_001853 | 4988-4998 | 221577_x_at | AF003934 | 16618-16628 |
| 204725_s_at | NM_006153 | 4999-5009 | 221602_s_at | AF057557 | 16629-16639 |
| 204733_at | NM_002774 | 5010-5020 | 221623_at | AF229053 | 16640-16650 |
| 204734_at | NM_002275 | 5021-5031 | 221651_x_at | BC005332 | 16651-16659 |
| 204736_s_at | NM_001897 | 5032-5042 | 221671_x_at | M63438 | 16660-16660 |
| 204769_s_at | M74447 | 5043-5053 | 221718_s_at | M90360 | 373-383 |
| 204776_at | NM_003248 | 5054-5064 | 221795_at | AI346341 | 16661-16671 |
| 204777_s_at | NM_002371 | 5065-5075 | 221796_at | AA707199 | 16672-16682 |
| 204810_s_at | NM_001824 | 5076-5086 | 221854_at | AI378979 | 16683-16693 |
| 204811_s_at | NM_006030 | 5087-5097 | 221861_at | AL157484 | 16694-16704 |
| 204818_at | NM_002153 | 5098-5108 | 221879_at | AA886335 | 16705-16715 |
| 204836_at | NM_000170 | 5109-5119 | 221900_at | AI806793 | 16716-16726 |
| 204844_at | L12468 | 5120-5130 | 221950_at | AI478455 | 16727-16737 |
| 204845_s_at | NM_001977 | 5131-5141 | 222008_at | NM_001851 | 16738-16748 |
| 204850_s_at | NM_000555 | 5142-5152 | 222020_s_at | AW117456 | 16749-16759 |
| 204851_s_at | AF040254 | 5153-5163 | 222023_at | AK022014 | 16760-16770 |
| 204854_at | NM_014262 | 5164-5174 | 222024_s_at | AK022014 | 16771-16781 |
| 204855_at | NM_002639 | 5175-5185 | 222071_s_at | BE552428 | 16782-16792 |
| 204859_s_at | NM_013229 | 5186-5196 | 222083_at | AW024233 | 16793-16803 |
| 204869_at | AL031664 | 5197-5207 | 222103_at | AI434345 | 16804-16814 |
| 204870_s_at | NM_002594 | 5208-5218 | 222242_s_at | AF243527 | 16815-16825 |
| 204874_x_at | NM_003933 | 5219-5229 | 222281_s_at | AW517716 | 16826-16836 |
| 204885_s_at | NM_005823 | 5230-5240 | 222294_s_at | AW971415 | 16837-16847 |
| 204931_at | NM_003206 | 5241-5251 | 222325_at | AW974812 | 16848-16858 |
| 204942_s_at | NM_000695 | 5252-5262 | 222334_at | AW979289 | 16859-16869 |
| 204951_at | NM_004310 | 5263-5273 | 222392_x_at | AJ251830 | 16870-16880 |
| 204952_at | NM_014400 | 5274-5284 | 222547_at | AL561281 | 16881-16891 |
| 204955_at | NM_006307 | 5285-5295 | 222548_s_at | AL561281 | 16892-16902 |
| 204960_at | NM_005608 | 5296-5306 | 222592_s_at | AW173691 | 16903-16913 |
| 204961_s_at | NM_000265 | 5307-5317 | 222675_s_at | AA628400 | 16914-16924 |
| 204965_at | NM_000583 | 5318-5328 | 222712_s_at | AW451240 | 16925-16935 |
| 204971_at | NM_005213 | 5329-5339 | 222764_at | AI928342 | 16936-16946 |
| 204987_at | NM_002216 | 5340-5350 | 222773_s_at | AA554045 | 16947-16957 |
| 204988_at | NM_005141 | 5351-5361 | 222780_s_at | AI870583 | 16958-16968 |
| 204995_at | AL567411 | 5362-5372 | 222797_at | BF508726 | 16969-16979 |
| 205009_at | NM_003225 | 5373-5383 | 222830_at | BE566136 | 16980-16990 |
| 205033_s_at | NM_004084 | 5384-5394 | 222861_x_at | NM_012168 | 16991-17001 |
| 205040_at | NM_000607 | 5395-5405 | 222871_at | BF791631 | 17002-17012 |
| 205041_s_at | NM_000607 | 5406-5416 | 222892_s_at | AI087937 | 17013-17023 |
| 205043_at | NM_000492 | 5417-5427 | 222901_s_at | AF153815 | 17024-17034 |
| 205049_s_at | NM_001783 | 5428-5438 | 222904_s_at | AW469181 | 17035-17045 |
| 205064_at | NM_003125 | 5439-5449 | 222912_at | BE207758 | 17046-17056 |
| 205066_s_at | NM_006208 | 5450-5460 | 222919_at | AA192306 | 17057-17067 |
| 205081_at | NM_001311 | 5461-5471 | 222920_s_at | BG231515 | 17068-17078 |
| 205102_at | NM_005656 | 5472-5482 | 222938_x_at | AI685421 | 17079-17089 |
| 205103_at | NM_006365 | 5483-5493 | 222939_s_at | N30257 | 17090-17100 |
| 205108_s_at | NM_000384 | 5494-5504 | 222943_at | AW235567 | 17101-17111 |
| 205109_s_at | NM_015320 | 5505-5515 | 223049_at | AF246238 | 17112-17122 |
| 205114_s_at | NM_002983 | 5516-5526 | 223121_s_at | AW003584 | 17123-17133 |
| 205122_at | BF439316 | 5527-5537 | 223122_s_at | AF311912 | 111-121 |
| 205127_at | NM_000962 | 5538-5548 | 223199_at | AA404592 | 17134-17144 |
| 205128_x_at | NM_000962 | 5549-5559 | 223232_s_at | AI768894 | 17145-17155 |
| 205132_at | NM_005159 | 5560-5570 | 223278_at | M86849 | 17156-17166 |
| 205143_at | NM_004386 | 5571-5581 | 223319_at | AF272663 | 17167-17177 |
| 205152_at | AI003579 | 5582-5592 | 223423_at | BC000181 | 17178-17188 |
| 205157_s_at | NM_000422 | 5593-5603 | 223437_at | N48315 | 17189-17199 |
| 205161_s_at | NM_003847 | 5604-5614 | 223447_at | AY007243 | 17200-17210 |
| 205163_at | NM_013292 | 5615-5625 | 223467_at | AF069506 | 17211-17221 |
| 205177_at | NM_003281 | 5626-5636 | 223496_s_at | AL136609 | 17222-17232 |
| 205185_at | NM_006846 | 5637-5647 | 223536_at | AL136559 | 17233-17243 |
| 205189_s_at | NM_000136 | 5648-5658 | 223551_at | AF225513 | 17244-17254 |
| 205190_at | NM_002670 | 5659-5669 | 223557_s_at | AB017269 | 17255-17265 |
| 205200_at | NM_003278 | 5670-5680 | 223572_at | AB042554 | 17266-17276 |
| 205213_at | NM_014716 | 5681-5691 | 223579_s_at | AF119905 | 17277-17287 |
| 205216_s_at | NM_000042 | 5692-5702 | 223582_at | AF055084 | 17288-17298 |
| 205220_at | NM_006018 | 5703-5713 | 223597_at | AB036706 | 17299-17309 |
| 205222_at | NM_001966 | 5714-5724 | 223603_at | AB026054 | 17310-17320 |
| 205225_at | NM_000125 | 5725-5735 | 223610_at | BC002776 | 17321-17331 |
| 205234_at | NM_004696 | 5736-5746 | 223623_at | AF325503 | 17332-17342 |
| 205239_at | NM_001657 | 5747-5757 | 223631_s_at | AF213678 | 17343-17353 |
| 205249_at | NM_000399 | 5758-5768 | 223634_at | AF279143 | 17354-17364 |
| 205253_at | NM_002585 | 5769-5779 | 223673_at | AF332192 | 17365-17375 |
| 205257_s_at | NM_001635 | 5780-5790 | 223678_s_at | M13686 | 17376-17386 |
| 205261_at | NM_002630 | 5791-5801 | 223687_s_at | AA723810 | 17387-17397 |
| 205266_at | NM_002309 | 5802-5812 | 223694_at | AF220032 | 17398-17408 |
| 205267_at | NM_006235 | 5813-5823 | 223708_at | AF329838 | 17409-17419 |
| 205286_at | U85658 | 5824-5834 | 223741_s_at | BC004233 | 17420-17430 |
| 205297_s_at | NM_000626 | 5835-5845 | 223749_at | AF329836 | 17431-17441 |
| 205302_at | NM_000596 | 5846-5856 | 223750_s_at | AW665250 | 17442-17452 |
| 205313_at | NM_000458 | 5857-5867 | 223751_x_at | AF296673 | 17453-17463 |
| 205319_at | NM_005672 | 5868-5878 | 223753_s_at | AF312769 | 17464-17474 |
| 205320_at | NM_005883 | 5879-5889 | 223754_at | BC005083 | 17475-17485 |
| 205337_at | AL139318 | 5890-5900 | 223784_at | AF229179 | 17486-17496 |
| 205343_at | NM_001056 | 5901-5911 | 223786_at | AF280086 | 17497-17507 |
| 205344_at | NM_006574 | 5912-5922 | 223806_s_at | AF090386 | 17508-17518 |
| 205348_s_at | NM_004411 | 5923-5933 | 223810_at | AF252283 | 17519-17529 |
| 205349_at | NM_002068 | 5934-5944 | 223820_at | AY007436 | 17530-17540 |
| 205358_at | NM_000826 | 5945-5955 | 223843_at | AB007830 | 17541-17551 |
| 205363_at | NM_003986 | 5956-5966 | 223864_at | AF269087 | 17552-17562 |
| 205373_at | NM_004389 | 5967-5977 | 223877_at | AF329839 | 17563-17573 |
| 205380_at | NM_002614 | 5978-5988 | 223913_s_at | AB058892 | 17574-17584 |
| 205382_s_at | NM_001928 | 5989-5999 | 223969_s_at | AF323084 | 17585-17595 |
| 205388_at | NM_003279 | 6000-6010 | 224146_s_at | AF352582 | 17596-17606 |
| 205390_s_at | NM_000037 | 6011-6021 | 224179_s_at | AF230095 | 17607-17617 |
| 205402_x_at | NM_002770 | 6022-6032 | 224204_x_at | AF231339 | 17618-17625 |
| 205413_at | NM_001584 | 6033-6043 | 224209_s_at | AF019638 | 17626-17636 |
| 205417_s_at | NM_004393 | 195-205 | 224329_s_at | AB049591 | 17637-17647 |
| 205422_s_at | NM_004791 | 6044-6054 | 224342_x_at | L14452 | 17648-17657 |
| 205430_at | AL133386 | 6055-6065 | 224355_s_at | AF237905 | 17658-17668 |
| 205433_at | NM_000055 | 6066-6076 | 224361_s_at | AF250309 | 17669-17676 |
| 205444_at | NM_004320 | 6077-6087 | 224367_at | AF251053 | 17677-17687 |
| 205473_at | NM_001692 | 6088-6098 | 224393_s_at | AF307451 | 17688-17698 |
| 205475_at | NM_007281 | 6099-6109 | 224396_s_at | AF316824 | 17699-17709 |
| 205476_at | NM_004591 | 6110-6120 | 224428_s_at | AY029179 | 17710-17720 |
| 205477_s_at | NM_001633 | 6121-6131 | 224458_at | BC006115 | 17721-17731 |
| 205485_at | NM_000540 | 6132-6142 | 224476_s_at | BC006219 | 17732-17742 |
| 205487_s_at | NM_016267 | 6143-6153 | 224482_s_at | BC006240 | 17743-17753 |
| 205490_x_at | BF060667 | 6154-6164 | 224488_s_at | BC006262 | 17754-17764 |
| 205500_at | NM_001735 | 6165-6175 | 224499_s_at | BC006296 | 17765-17775 |
| 205504_at | NM_000061 | 6176-6186 | 224506_s_at | BC006362 | 17776-17786 |
| 205506_at | NM_007127 | 6187-6197 | 224560_at | BF107565 | 17787-17797 |
| 205509_at | NM_001871 | 6198-6208 | 224590_at | BE644917 | 17798-17808 |
| 205513_at | NM_001062 | 6209-6219 | 224650_at | AL117612 | 17809-17819 |
| 205517_at | AV700724 | 6220-6230 | 224681_at | BG028884 | 17820-17830 |
| 205523_at | U43328 | 6231-6241 | 224793_s_at | AA604375 | 17831-17841 |
| 205524_s_at | NM_001884 | 6242-6252 | 224813_at | AL523820 | 17842-17852 |
| 205532_s_at | AU151483 | 6253-6263 | 224823_at | AA526844 | 17853-17863 |
| 205544_s_at | NM_001877 | 6264-6274 | 224861_at | AA628423 | 17864-17874 |
| 205549_at | NM_006198 | 6275-6285 | 224862_at | BF969428 | 17875-17885 |
| 205564_at | NM_007003 | 6286-6296 | 224891_at | AV725666 | 17886-17896 |
| 205576_at | NM_000185 | 6297-6307 | 224918_x_at | AI220117 | 17897-17907 |
| 205577_at | NM_005609 | 6308-6318 | 224935_at | BG165815 | 17908-17918 |
| 205582_s_at | NM_004121 | 6319-6329 | 225016_at | N48299 | 17919-17929 |
| 205595_at | NM_001944 | 6330-6340 | 225093_at | N66570 | 17930-17940 |
| 205597_at | NM_025257 | 6341-6351 | 225144_at | AI457436 | 17941-17951 |
| 205606_at | NM_002336 | 6352-6362 | 225147_at | AL521959 | 17952-17962 |
| 205615_at | NM_001868 | 6363-6373 | 225211_at | AW139723 | 17963-17973 |
| 205623_at | NM_000691 | 6374-6384 | 225262_at | AI670862 | 17974-17984 |
| 205624_at | NM_001870 | 6385-6395 | 225275_at | AA053711 | 17985-17995 |
| 205626_s_at | NM_004929 | 6396-6406 | 225285_at | AK025615 | 17996-18006 |
| 205630_at | NM_000756 | 6407-6417 | 225330_at | AL044092 | 18007-18017 |
| 205632_s_at | NM_003558 | 6418-6428 | 225380_at | BF528878 | 18018-18028 |
| 205638_at | NM_001704 | 6429-6439 | 225433_at | AU144104 | 18029-18039 |
| 205649_s_at | NM_000508 | 6440-6450 | 225482_at | AL533416 | 18040-18050 |
| 205650_s_at | NM_021871 | 6451-6461 | 225491_at | AL157452 | 18051-18061 |
| 205654_at | NM_000715 | 6462-6472 | 225558_at | R38084 | 18062-18072 |
| 205670_at | NM_004861 | 6473-6483 | 225609_at | AI888037 | 18073-18083 |
| 205674_x_at | NM_001680 | 6484-6494 | 225645_at | AI763378 | 18084-18094 |
| 205675_at | AI623321 | 6495-6505 | 225667_s_at | AI601101 | 18095-18105 |
| 205676_at | NM_000785 | 6506-6516 | 225728_at | AI659533 | 18106-18116 |
| 205683_x_at | NM_003294 | 6517-6527 | 225745_at | AV725248 | 18117-18127 |
| 205693_at | NM_006757 | 6528-6538 | 225757_s_at | AU147564 | 18128-18138 |
| 205698_s_at | NM_002758 | 6539-6549 | 225809_at | AI659927 | 18139-18149 |
| 205710_at | NM_004525 | 6550-6560 | 225835_at | AK025062 | 18150-18160 |
| 205719_s_at | NM_000277 | 6561-6571 | 225846_at | BF001941 | 18161-18171 |
| 205721_at | U97145 | 6572-6582 | 225859_at | N30645 | 18172-18182 |
| 205724_at | NM_000299 | 6583-6593 | 225911_at | AL138410 | 18183-18193 |
| 205725_at | NM_003357 | 6594-6604 | 225958_at | AI554106 | 18194-18204 |
| 205728_at | AL022718 | 6605-6615 | 225985_at | AI935917 | 18205-18215 |
| 205736_at | NM_000290 | 6616-6626 | 225987_at | AA650281 | 18216-18226 |
| 205737_at | NM_004518 | 6627-6637 | 225996_at | AV709727 | 18227-18237 |
| 205753_at | NM_000567 | 6638-6648 | 226048_at | N92719 | 18238-18248 |
| 205754_at | NM_000506 | 6649-6659 | 226066_at | AL117653 | 18249-18259 |
| 205755_at | NM_002217 | 6660-6670 | 226067_at | AL355392 | 18260-18270 |
| 205767_at | NM_001432 | 6671-6681 | 226068_at | BF593625 | 18271-18281 |
| 205770_at | NM_000637 | 6682-6692 | 226084_at | AA554833 | 18282-18292 |
| 205778_at | NM_005046 | 6693-6703 | 226096_at | AI760132 | 18293-18303 |
| 205780_at | NM_001197 | 6704-6714 | 226189_at | BF513121 | 18304-18314 |
| 205792_at | NM_003881 | 6715-6725 | 226210_s_at | AI291123 | 18315-18325 |
| 205799_s_at | M95548 | 6726-6736 | 226213_at | AV681807 | 18326-18336 |
| 205809_s_at | BE504979 | 6737-6747 | 226216_at | W84556 | 18337-18347 |
| 205813_s_at | NM_000429 | 6748-6758 | 226226_at | AI282982 | 18348-18358 |
| 205815_at | NM_002580 | 6759-6769 | 226228_at | T15657 | 18359-18369 |
| 205817_at | NM_005982 | 6770-6780 | 226281_at | BF059512 | 18370-18380 |
| 205819_at | NM_006770 | 6781-6791 | 226342_at | AW593244 | 18381-18391 |
| 205820_s_at | NM_000040 | 6792-6802 | 226424_at | AI683754 | 18392-18402 |
| 205822_s_at | NM_002130 | 6803-6813 | 226461_at | AA204719 | 18403-18413 |
| 205825_at | NM_000439 | 6814-6824 | 226462_at | AW134979 | 18414-18424 |
| 205827_at | NM_000729 | 6825-6835 | 226498_at | AA149648 | 18425-18435 |
| 205828_at | NM_002422 | 6836-6846 | 226517_at | AL390172 | 18436-18446 |
| 205833_s_at | AI770098 | 6847-6857 | 226534_at | AI446414 | 18447-18457 |
| 205842_s_at | AF001362 | 6858-6868 | 226535_at | AK026736 | 18458-18468 |
| 205844_at | NM_004666 | 6869-6879 | 226553_at | AI660243 | 18469-18479 |
| 205856_at | NM_015865 | 6880-6890 | 226554_at | AW445134 | 18480-18490 |
| 205860_x_at | NM_004476 | 6891-6901 | 226560_at | AA576959 | 18491-18501 |
| 205861_at | NM_003121 | 6902-6912 | 226623_at | AI829726 | 18502-18512 |
| 205866_at | NM_003665 | 6913-6923 | 226654_at | AF147790 | 18513-18523 |
| 205869_at | NM_002769 | 6924-6934 | 226675_s_at | W80468 | 18524-18534 |
| 205886_at | NM_006507 | 6935-6945 | 226690_at | AW451961 | 18535-18545 |
| 205893_at | NM_014932 | 6946-6956 | 226755_at | AI375939 | 18546-18556 |
| 205899_at | NM_003914 | 6957-6967 | 226766_at | AB046788 | 18557-18567 |
| 205900_at | NM_006121 | 6968-6978 | 226777_at | AA147933 | 18568-18578 |
| 205901_at | NM_006228 | 6979-6989 | 226852_at | AB033092 | 18579-18589 |
| 205902_at | AJ251016 | 6990-7000 | 226856_at | BF793701 | 18590-18600 |
| 205906_at | NM_001454 | 7001-7011 | 226863_at | AI674565 | 18601-18611 |
| 205912_at | NM_000936 | 7012-7022 | 226864_at | BF245954 | 18612-18622 |
| 205913_at | NM_002666 | 7023-7033 | 226907_at | N32557 | 18623-18633 |
| 205916_at | NM_002963 | 7034-7044 | 226913_s_at | BF527050 | 18634-18644 |
| 205924_at | BC005035 | 7045-7055 | 226930_at | AI345957 | 18645-18655 |
| 205925_s_at | NM_002867 | 7056-7066 | 226960_at | AW471176 | 18656-18666 |
| 205927_s_at | NM_001910 | 7067-7077 | 226978_at | AA910945 | 18667-18677 |
| 205929_at | NM_005814 | 7078-7088 | 227030_at | BG231773 | 18678-18688 |
| 205932_s_at | NM_002448 | 7089-7099 | 227048_at | AI990816 | 18689-18699 |
| 205940_at | NM_002470 | 7100-7110 | 227084_at | AW339310 | 18700-18710 |
| 205941_s_at | AI376003 | 7111-7121 | 227099_s_at | AW276078 | 18711-18721 |
| 205951_at | NM_005963 | 7122-7132 | 227123_at | AU156710 | 18722-18732 |
| 205954_at | NM_006917 | 7133-7143 | 227140_at | AI343467 | 18733-18743 |
| 205959_at | NM_002427 | 7144-7154 | 227143_s_at | AA706658 | 122-132 |
| 205969_at | NM_001086 | 7155-7165 | 227156_at | AK025872 | 18744-18754 |
| 205971_s_at | NM_001906 | 7166-7176 | 227168_at | BF475488 | 18755-18765 |
| 205972_at | NM_006841 | 7177-7187 | 227174_at | Z98443 | 18766-18776 |
| 205978_at | NM_004795 | 7188-7198 | 227180_at | AW138767 | 18777-18787 |
| 205979_at | NM_002407 | 7199-7209 | 227183_at | AI417267 | 18788-18798 |
| 205980_s_at | NM_015366 | 7210-7220 | 227198_at | AW085505 | 18799-18809 |
| 205982_x_at | NM_003018 | 7221-7231 | 227238_at | W93847 | 18810-18820 |
| 205983_at | NM_004413 | 7232-7242 | 227241_at | R79759 | 18821-18831 |
| 205999_x_at | AF182273 | 7243-7253 | 227282_at | AB037734 | 18832-18842 |
| 206000_at | NM_005588 | 7254-7264 | 227318_at | AL359605 | 18843-18853 |
| 206001_at | NM_000905 | 7265-7275 | 227336_at | AW576405 | 18854-18864 |
| 206002_at | NM_005756 | 7276-7286 | 227376_at | AW021102 | 18865-18875 |
| 206008_at | NM_000359 | 7287-7297 | 227394_at | W94001 | 18876-18886 |
| 206018_at | NM_005249 | 7298-7308 | 227397_at | AA531086 | 18887-18897 |
| 206022_at | NM_000266 | 7309-7319 | 227401_at | BE856748 | 18898-18908 |
| 206023_at | NM_006681 | 7320-7330 | 227426_at | AV702692 | 18909-18919 |
| 206030_at | NM_000049 | 7331-7341 | 227449_at | AI799018 | 18920-18930 |
| 206032_at | AI797281 | 7342-7352 | 227475_at | AI676059 | 18931-18941 |
| 206033_s_at | NM_001941 | 7353-7363 | 227510_x_at | AL037917 | 18942-18952 |
| 206054_at | NM_000893 | 7364-7374 | 227522_at | AA209487 | 18953-18963 |
| 206065_s_at | NM_001385 | 7375-7385 | 227550_at | AW242720 | 18964-18974 |
| 206067_s_at | NM_024426 | 7386-7396 | 227556_at | AI094580 | 18975-18985 |
| 206075_s_at | NM_001895 | 7397-7407 | 227566_at | AW085558 | 18986-18996 |
| 206106_at | AL022328 | 7408-7418 | 227612_at | R20763 | 18997-19007 |
| 206115_at | NM_004430 | 7419-7429 | 227614_at | W81116 | 19008-19018 |
| 206117_at | NM_000366 | 7430-7440 | 227629_at | AA843963 | 19019-19029 |
| 206119_at | NM_001713 | 7441-7451 | 227662_at | AA541622 | 19030-19040 |
| 206122_at | NM_006942 | 7452-7462 | 227676_at | AW001287 | 19041-19051 |
| 206125_s_at | NM_007196 | 7463-7473 | 227677_at | BF512748 | 19052-19062 |
| 206130_s_at | NM_001181 | 7474-7484 | 227705_at | BF591534 | 19063-19073 |
| 206135_at | NM_014682 | 7485-7495 | 227733_at | AA928939 | 19074-19084 |
| 206143_at | NM_000111 | 7496-7506 | 227735_s_at | AA553959 | 133-143 |
| 206149_at | NM_022097 | 7507-7517 | 227736_at | AA553959 | 144-154 |
| 206151_x_at | NM_007352 | 7518-7528 | 227769_at | AI703476 | 19085-19095 |
| 206156_at | NM_005268 | 7529-7539 | 227798_at | AU146891 | 19096-19106 |
| 206157_at | NM_002852 | 7540-7550 | 227803_at | AA609053 | 19107-19117 |
| 206164_at | NM_006536 | 7551-7561 | 227817_at | R51324 | 19118-19128 |
| 206165_s_at | NM_006536 | 7562-7572 | 227823_at | BE348679 | 19129-19139 |
| 206166_s_at | AF043977 | 7573-7583 | 227826_s_at | AW138143 | 19140-19150 |
| 206167_s_at | NM_001174 | 7584-7594 | 227827_at | AW138143 | 19151-19161 |
| 206177_s_at | NM_000045 | 7595-7605 | 227848_at | AI218954 | 19162-19172 |
| 206179_s_at | NM_007030 | 7606-7616 | 227850_x_at | AW084544 | 19173-19183 |
| 206190_at | NM_005291 | 7617-7627 | 227867_at | AA005361 | 19184-19194 |
| 206191_at | NM_001248 | 7628-7638 | 227892_at | AA855042 | 19195-19205 |
| 206198_s_at | L31792 | 7639-7649 | 227897_at | N20927 | 19206-19216 |
| 206199_at | NM_006890 | 7650-7660 | 227952_at | AI580142 | 19217-19227 |
| 206201_s_at | NM_005924 | 7661-7671 | 227971_at | AI653107 | 19228-19238 |
| 206207_at | NM_001828 | 7672-7682 | 227984_at | BE464483 | 19239-19246 |
| 206209_s_at | NM_000717 | 7683-7693 | 228004_at | AL121722 | 19247-19257 |
| 206210_s_at | NM_000078 | 7694-7704 | 228035_at | AA453640 | 19258-19268 |
| 206226_at | NM_000412 | 7705-7715 | 228038_at | AI669815 | 19269-19279 |
| 206227_at | NM_003613 | 7716-7726 | 228051_at | AI979261 | 19280-19290 |
| 206228_at | AW769732 | 7727-7737 | 228056_s_at | AI763426 | 19291-19301 |
| 206237_s_at | NM_013957 | 7738-7748 | 228133_s_at | BF732767 | 19302-19311 |
| 206239_s_at | NM_003122 | 7749-7759 | 228170_at | AL355743 | 19312-19322 |
| 206242_at | NM_003963 | 7760-7770 | 228173_at | AA810695 | 19323-19333 |
| 206249_at | NM_004721 | 7771-7781 | 228188_at | AI860150 | 19334-19344 |
| 206255_at | NM_001715 | 7782-7792 | 228195_at | BE645119 | 19345-19355 |
| 206259_at | NM_000312 | 7793-7803 | 228232_s_at | NM_014312 | 19356-19366 |
| 206260_at | NM_003241 | 7804-7814 | 228284_at | BE302305 | 19367-19377 |
| 206262_at | NM_000669 | 7815-7825 | 228329_at | AA700440 | 19378-19388 |
| 206268_at | NM_020997 | 7826-7836 | 228335_at | AW264204 | 19389-19399 |
| 206276_at | NM_003695 | 7837-7847 | 228360_at | BF060747 | 19400-19410 |
| 206282_at | NM_002500 | 7848-7858 | 228367_at | BE551416 | 19411-19421 |
| 206286_s_at | NM_003212 | 7859-7869 | 228377_at | AB037805 | 19422-19432 |
| 206287_s_at | NM_002218 | 7870-7880 | 228399_at | AI569974 | 19433-19443 |
| 206292_s_at | NM_003167 | 7881-7891 | 228462_at | AI928035 | 19444-19454 |
| 206293_at | U08024 | 7892-7902 | 228463_at | R99562 | 19455-19465 |
| 206296_x_at | NM_007181 | 7903-7913 | 228481_at | BG541187 | 19466-19476 |
| 206298_at | NM_021226 | 7914-7924 | 228494_at | AI888150 | 19477-19487 |
| 206312_at | NM_004963 | 7925-7935 | 228501_at | BF055343 | 19488-19498 |
| 206334_at | NM_004190 | 7936-7946 | 228504_at | AI828648 | 19499-19509 |
| 206340_at | NM_005123 | 7947-7957 | 228518_at | AW575313 | 19510-19520 |
| 206373_at | NM_003412 | 7958-7968 | 228554_at | AL137566 | 19521-19531 |
| 206376_at | NM_018057 | 7969-7979 | 228575_at | AL578102 | 19532-19542 |
| 206378_at | NM_002411 | 7980-7990 | 228581_at | AW071744 | 19543-19553 |
| 206380_s_at | NM_002621 | 7991-8001 | 228592_at | AW474852 | 19554-19564 |
| 206385_s_at | NM_020987 | 8002-8012 | 228598_at | AL538781 | 19565-19575 |
| 206387_at | U51096 | 8013-8023 | 228608_at | N49852 | 19576-19586 |
| 206393_at | NM_003282 | 8024-8034 | 228621_at | AA948096 | 19587-19597 |
| 206394_at | NM_004533 | 8035-8045 | 228658_at | R54042 | 19598-19608 |
| 206397_x_at | NM_001492 | 8046-8056 | 228670_at | BF197089 | 19609-19619 |
| 206398_s_at | NM_001770 | 8057-8067 | 228715_at | AV725825 | 19620-19630 |
| 206400_at | NM_002307 | 8068-8078 | 228724_at | N49237 | 19631-19641 |
| 206401_s_at | J03778 | 8079-8089 | 228737_at | AA211909 | 19642-19652 |
| 206408_at | NM_015564 | 8090-8100 | 228739_at | AI139413 | 19653-19663 |
| 206418_at | NM_007052 | 8101-8111 | 228780_at | AW149422 | 19664-19674 |
| 206421_s_at | NM_003784 | 8112-8122 | 228794_at | AA211780 | 19675-19685 |
| 206422_at | NM_002054 | 8123-8133 | 228796_at | BE645967 | 19686-19696 |
| 206427_s_at | U06654 | 8134-8144 | 228806_at | AI218580 | 19697-19707 |
| 206430_at | NM_001804 | 8145-8155 | 228834_at | BF240286 | 19708-19718 |
| 206434_at | NM_016950 | 8156-8166 | 228912_at | AI436136 | 19719-19729 |
| 206439_at | NM_004950 | 8167-8177 | 228955_at | AL041761 | 19730-19740 |
| 206446_s_at | NM_001971 | 8178-8188 | 228969_at | AI922323 | 19741-19751 |
| 206447_at | NM_001971 | 8189-8199 | 228979_at | BE218152 | 19752-19762 |
| 206457_s_at | NM_000792 | 8200-8210 | 228984_at | AB037815 | 19763-19773 |
| 206463_s_at | NM_005794 | 8211-8221 | 229030_at | AW242997 | 19774-19784 |
| 206466_at | AB014531 | 8222-8232 | 229088_at | BF591996 | 19785-19795 |
| 206484_s_at | NM_003399 | 8233-8243 | 229095_s_at | AI797263 | 19796-19806 |
| 206496_at | NM_006894 | 8244-8254 | 229096_at | AI797263 | 19807-19817 |
| 206502_s_at | NM_002196 | 8255-8265 | 229147_at | AW070877 | 19818-19828 |
| 206504_at | NM_000782 | 8266-8276 | 229150_at | AI810764 | 19829-19839 |
| 206509_at | NM_002652 | 8277-8287 | 229151_at | BE673587 | 19840-19850 |
| 206515_at | NM_000896 | 8288-8298 | 229160_at | AI967987 | 19851-19861 |
| 206517_at | NM_004062 | 8299-8309 | 229163_at | N75559 | 19862-19872 |
| 206536_s_at | U32974 | 8310-8320 | 229168_at | AI690433 | 19873-19883 |
| 206552_s_at | NM_003182 | 8321-8331 | 229177_at | AI823572 | 19884-19894 |
| 206560_s_at | NM_006533 | 8332-8342 | 229212_at | BE220341 | 19895-19905 |
| 206561_s_at | NM_020299 | 8343-8353 | 229215_at | AI393930 | 19906-19916 |
| 206586_at | NM_001841 | 8354-8364 | 229218_at | AA628535 | 19917-19927 |
| 206642_at | NM_001942 | 8365-8375 | 229221_at | BE467023 | 19928-19938 |
| 206651_s_at | NM_016413 | 8376-8386 | 229229_at | AJ292204 | 19939-19949 |
| 206655_s_at | NM_000407 | 8387-8397 | 229245_at | AA535361 | 19950-19960 |
| 206657_s_at | NM_002478 | 8398-8408 | 229259_at | AL133013 | 19961-19971 |
| 206658_at | NM_030570 | 8409-8419 | 229271_x_at | BG028597 | 19972-19982 |
| 206664_at | NM_001041 | 8420-8430 | 229273_at | AU152837 | 19983-19993 |
| 206680_at | NM_005894 | 8431-8441 | 229281_at | N51682 | 19994-20004 |
| 206681_x_at | NM_001502 | 8442-8452 | 229290_at | AI692575 | 20005-20015 |
| 206687_s_at | NM_002831 | 8453-8463 | 229296_at | AI659477 | 20016-20026 |
| 206690_at | NM_001094 | 8464-8474 | 229300_at | AW590679 | 20027-20037 |
| 206694_at | NM_006229 | 8475-8485 | 229309_at | AI625747 | 20038-20048 |
| 206696_at | NM_000273 | 8486-8496 | 229335_at | BE645821 | 20049-20059 |
| 206698_at | NM_021083 | 8497-8507 | 229358_at | AA628967 | 20060-20070 |
| 206701_x_at | NM_003991 | 8508-8518 | 229374_at | AI758962 | 20071-20081 |
| 206717_at | NM_002472 | 8519-8529 | 229400_at | AW299531 | 20082-20092 |
| 206727_at | K02766 | 8530-8540 | 229459_at | AV723914 | 20093-20103 |
| 206743_s_at | NM_001671 | 8541-8551 | 229476_s_at | AW272342 | 20104-20114 |
| 206750_at | NM_002360 | 8552-8562 | 229477_at | AW272342 | 20115-20125 |
| 206771_at | NM_006953 | 8563-8573 | 229481_at | AI990367 | 20126-20136 |
| 206773_at | NM_002347 | 8574-8584 | 229529_at | AI827830 | 20137-20147 |
| 206775_at | NM_001081 | 8585-8595 | 229540_at | R45471 | 20148-20158 |
| 206797_at | NM_000015 | 8596-8606 | 229542_at | AW590326 | 20159-20169 |
| 206803_at | NM_024411 | 8607-8617 | 229566_at | AA149250 | 20170-20180 |
| 206826_at | NM_002677 | 8618-8628 | 229569_at | AW572379 | 20181-20191 |
| 206827_s_at | NM_014274 | 8629-8639 | 229578_at | AA716165 | 20192-20202 |
| 206836_at | NM_001044 | 8640-8650 | 229580_at | R71596 | 20203-20213 |
| 206858_s_at | NM_004503 | 8651-8661 | 229599_at | AA675917 | 20214-20224 |
| 206869_at | NM_001267 | 8662-8672 | 229638_at | AI681917 | 20225-20235 |
| 206882_at | NM_005071 | 8673-8683 | 229655_at | N66656 | 20236-20246 |
| 206884_s_at | NM_003843 | 8684-8694 | 229734_at | BF507379 | 20247-20257 |
| 206893_at | NM_002968 | 8695-8705 | 229777_at | AA863031 | 20258-20268 |
| 206898_at | NM_021153 | 8706-8716 | 229782_at | BE468066 | 20269-20279 |
| 206912_at | NM_004473 | 8717-8727 | 229799_s_at | AI569787 | 20280-20290 |
| 206913_at | NM_001701 | 8728-8738 | 229800_at | AI129626 | 20291-20301 |
| 206915_at | NM_002509 | 8739-8749 | 229818_at | AL359592 | 20302-20312 |
| 206935_at | NM_002590 | 8750-8760 | 229875_at | AI363193 | 20313-20323 |
| 206963_s_at | NM_016347 | 8761-8771 | 229889_at | AW137009 | 20324-20334 |
| 206975_at | NM_000595 | 8772-8782 | 229921_at | BF196255 | 20335-20345 |
| 206979_at | NM_000066 | 8783-8793 | 229927_at | BE222220 | 20346-20356 |
| 207004_at | NM_000657 | 8794-8804 | 229944_at | AU153412 | 20357-20367 |
| 207010_at | NM_000812 | 8805-8815 | 230022_at | BF057185 | 20368-20378 |
| 207039_at | NM_000077 | 8816-8826 | 230075_at | AV724323 | 20379-20389 |
| 207052_at | NM_012206 | 8827-8837 | 230100_x_at | AU147145 | 20390-20400 |
| 207058_s_at | NM_004562 | 8838-8848 | 230105_at | BF062550 | 20401-20411 |
| 207066_at | NM_002152 | 8849-8859 | 230112_at | AB037820 | 20412-20422 |
| 207069_s_at | NM_005585 | 8860-8870 | 230135_at | AI822137 | 20423-20433 |
| 207074_s_at | NM_003053 | 8871-8881 | 230144_at | AW294729 | 20434-20444 |
| 207086_x_at | NM_001474 | 8882-8892 | 230147_at | AI378647 | 20445-20455 |
| 207093_s_at | NM_002544 | 8893-8903 | 230158_at | AA758751 | 20456-20466 |
| 207121_s_at | NM_002748 | 8904-8914 | 230163_at | AW263087 | 20467-20477 |
| 207134_x_at | NM_024164 | 8915-8915 | 230184_at | AL035834 | 20478-20488 |
| 207139_at | NM_000704 | 8916-8926 | 230188_at | AW138350 | 20489-20499 |
| 207144_s_at | NM_004143 | 8927-8937 | 230193_at | AI479075 | 20500-20510 |
| 207148_x_at | NM_016599 | 8938-8948 | 230220_at | AI681025 | 20511-20521 |
| 207175_at | NM_004797 | 8949-8959 | 230242_at | AA634220 | 20522-20532 |
| 207181_s_at | NM_001227 | 8960-8970 | 230271_at | BG150301 | 20533-20543 |
| 207200_at | NM_000531 | 8971-8981 | 230272_at | AA464844 | 20544-20554 |
| 207202_s_at | NM_003889 | 8982-8992 | 230276_at | AI934342 | 20555-20565 |
| 207203_s_at | AF061056 | 8993-9003 | 230290_at | BE674338 | 20566-20576 |
| 207214_at | NM_014471 | 9004-9014 | 230309_at | BE876610 | 20577-20587 |
| 207217_s_at | NM_013955 | 9015-9025 | 230318_at | T62088 | 20588-20598 |
| 207218_at | NM_000133 | 9026-9036 | 230319_at | AI222435 | 20599-20609 |
| 207233_s_at | NM_000248 | 9037-9047 | 230323_s_at | AW242836 | 20610-20620 |
| 207238_s_at | NM_002838 | 9048-9058 | 230378_at | AA742697 | 20621-20631 |
| 207256_at | NM_000242 | 9059-9069 | 230412_at | BF196935 | 20632-20642 |
| 207259_at | NM_017928 | 9070-9080 | 230432_at | AI733124 | 20643-20653 |
| 207293_s_at | U16957 | 9081-9091 | 230438_at | AI039005 | 20654-20664 |
| 207298_at | NM_006632 | 9092-9102 | 230464_at | AI814092 | 20665-20675 |
| 207300_s_at | NM_000131 | 9103-9113 | 230472_at | AI870306 | 20676-20686 |
| 207302_at | NM_000231 | 9114-9124 | 230496_at | BE046923 | 20687-20697 |
| 207316_at | NM_001523 | 9125-9135 | 230554_at | AV696234 | 20698-20708 |
| 207323_s_at | NM_002385 | 9136-9146 | 230560_at | N21096 | 20709-20719 |
| 207324_s_at | NM_004948 | 9147-9157 | 230577_at | AW014022 | 20720-20730 |
| 207356_at | NM_004942 | 9158-9168 | 230585_at | AI632692 | 20731-20741 |
| 207362_at | NM_013309 | 9169-9179 | 230595_at | BF677651 | 20742-20752 |
| 207380_x_at | NM_013954 | 9180-9190 | 230602_at | AW025340 | 20753-20763 |
| 207384_at | NM_005091 | 9191-9201 | 230673_at | AV706971 | 20764-20774 |
| 207392_x_at | NM_001076 | 9202-9212 | 230741_at | AI655467 | 20775-20785 |
| 207406_at | NM_000780 | 9213-9223 | 230772_at | AA639753 | 20786-20796 |
| 207412_x_at | NM_001808 | 9224-9234 | 230776_at | N59856 | 20797-20807 |
| 207414_s_at | NM_002570 | 9235-9245 | 230781_at | AI143988 | 20808-20818 |
| 207429_at | NM_003058 | 9246-9256 | 230784_at | BG498699 | 20819-20829 |
| 207430_s_at | NM_002443 | 9257-9267 | 230788_at | BF059748 | 20830-20840 |
| 207434_s_at | NM_021603 | 9268-9275 | 230805_at | AA749202 | 20841-20851 |
| 207457_s_at | NM_021246 | 9276-9286 | 230835_at | W69083 | 20852-20862 |
| 207463_x_at | NM_002771 | 9287-9295 | 230863_at | R73030 | 20863-20873 |
| 207469_s_at | NM_003662 | 9296-9306 | 230865_at | N29837 | 20874-20884 |
| 207522_s_at | NM_005173 | 9307-9317 | 230867_at | AI742521 | 20885-20895 |
| 207529_at | NM_021010 | 9318-9328 | 230882_at | AA129217 | 20896-20906 |
| 207544_s_at | NM_000672 | 9329-9339 | 230896_at | AA833830 | 20907-20917 |
| 207558_s_at | NM_000325 | 9340-9350 | 230915_at | AI741629 | 20918-20928 |
| 207591_s_at | NM_006015 | 9351-9361 | 230920_at | BF060736 | 20929-20939 |
| 207612_at | NM_003393 | 9362-9372 | 230923_at | AI824004 | 20940-20950 |
| 207655_s_at | NM_013314 | 9373-9383 | 230942_at | AI147740 | 20951-20961 |
| 207663_x_at | NM_001473 | 9384-9386 | 230943_at | AI821669 | 20962-20972 |
| 207686_s_at | NM_001228 | 9387-9397 | 230980_x_at | AI307713 | 20973-20983 |
| 207695_s_at | NM_001555 | 9398-9408 | 231029_at | AI740541 | 20984-20994 |
| 207738_s_at | NM_013436 | 9409-9419 | 231033_at | AI819863 | 20995-21005 |
| 207739_s_at | NM_001472 | 9420-9428 | 231040_at | AW512988 | 21006-21016 |
| 207741_x_at | NM_003293 | 9429-9436 | 231063_at | AW014518 | 21017-21027 |
| 207782_s_at | NM_007319 | 9437-9447 | 231070_at | BF431199 | 21028-21038 |
| 207814_at | NM_001926 | 9448-9458 | 231077_at | AI798832 | 21039-21049 |
| 207819_s_at | NM_000443 | 9459-9469 | 231148_at | AI806131 | 21050-21060 |
| 207827_x_at | L36675 | 9470-9480 | 231175_at | N48613 | 21061-21071 |
| 207847_s_at | NM_002456 | 9481-9491 | 231181_at | AI683621 | 21072-21082 |
| 207850_at | NM_002090 | 9492-9502 | 231187_at | AI206039 | 21083-21093 |
| 207858_s_at | NM_000298 | 9503-9513 | 231192_at | AW274018 | 21094-21104 |
| 207924_x_at | NM_013992 | 9514-9524 | 231240_at | AI038059 | 21105-21115 |
| 207935_s_at | NM_002274 | 9525-9535 | 231250_at | AI394574 | 21116-21126 |
| 207957_s_at | NM_002738 | 9536-9546 | 231259_s_at | BE467688 | 21127-21137 |
| 208078_s_at | NM_030751 | 9547-9557 | 231315_at | AI807728 | 21138-21148 |
| 208126_s_at | NM_000772 | 9558-9568 | 231331_at | AI085377 | 21149-21159 |
| 208131_s_at | NM_000961 | 9569-9579 | 231336_at | AI703256 | 21160-21170 |
| 208147_s_at | NM_030878 | 9580-9590 | 231341_at | BE670584 | 21171-21181 |
| 208153_s_at | NM_001447 | 9591-9601 | 231348_s_at | BF508869 | 21182-21192 |
| 208168_s_at | NM_003465 | 9602-9612 | 231398_at | AA777852 | 21193-21203 |
| 208170_s_at | NM_007028 | 9613-9623 | 231430_at | AW205640 | 21204-21214 |
| 208195_at | NM_003319 | 9624-9634 | 231439_at | AA922936 | 21215-21225 |
| 208198_x_at | NM_014512 | 9635-9645 | 231489_x_at | H12214 | 21226-21236 |
| 208209_s_at | NM_000716 | 9646-9656 | 231542_at | AL157421 | 21237-21247 |
| 208235_x_at | NM_021123 | 9657-9659 | 231579_s_at | BE968786 | 21248-21258 |
| 208250_s_at | NM_004406 | 9660-9670 | 231626_at | BE220053 | 21259-21269 |
| 208300_at | NM_002842 | 9671-9681 | 231646_at | AW473496 | 21270-21280 |
| 208305_at | NM_000926 | 9682-9692 | 231666_at | AA194168 | 21281-21291 |
| 208323_s_at | NM_004306 | 9693-9703 | 231678_s_at | AV651117 | 21292-21302 |
| 208367_x_at | NM_000776 | 9704-9711 | 231693_at | AV655991 | 21303-21313 |
| 208451_s_at | NM_000592 | 9712-9722 | 231711_at | BF592752 | 21314-21324 |
| 208471_at | NM_020995 | 9723-9733 | 231721_at | AF356518 | 21325-21335 |
| 208473_s_at | NM_016295 | 9734-9743 | 231728_at | NM_004058 | 21336-21346 |
| 208477_at | NM_004976 | 9744-9754 | 231729_s_at | NM_004058 | 21347-21357 |
| 208502_s_at | NM_002653 | 9755-9765 | 231736_x_at | NM_020300 | 21358-21362 |
| 208505_s_at | NM_000511 | 9766-9776 | 231771_at | AI694073 | 21363-21373 |
| 208539_x_at | NM_006945 | 9777-9787 | 231783_at | AI500293 | 21374-21384 |
| 208621_s_at | BF663141 | 9788-9798 | 231790_at | AA676742 | 21385-21395 |
| 208643_s_at | J04977 | 9799-9809 | 231814_at | AK025404 | 21396-21406 |
| 208650_s_at | BG327863 | 9810-9820 | 231856_at | AB033070 | 21407-21417 |
| 208651_x_at | M58664 | 9821-9831 | 231867_at | AB032953 | 21418-21428 |
| 208683_at | M23254 | 9832-9842 | 231898_x_at | AW026426 | 21429-21439 |
| 208694_at | U47077 | 9843-9853 | 231904_at | AU122448 | 21440-21450 |
| 208711_s_at | BC000076 | 9854-9864 | 231935_at | AL133109 | 21451-21461 |
| 208712_at | M73554 | 9865-9875 | 231941_s_at | AB037780 | 21462-21472 |
| 208724_s_at | BC000905 | 9876-9886 | 231993_at | AK026784 | 21473-21483 |
| 208726_s_at | BC000461 | 9887-9897 | 232010_at | AA129444 | 21484-21494 |
| 208731_at | AU158062 | 9898-9908 | 232056_at | AW470178 | 21495-21505 |
| 208750_s_at | AA580004 | 9909-9919 | 232082_x_at | BF575466 | 21506-21514 |
| 208760_at | AL031714 | 9920-9930 | 232116_at | AL137763 | 21515-21525 |
| 208775_at | D89729 | 9931-9941 | 232149_s_at | BF056507 | 21526-21536 |
| 208799_at | BC004146 | 320-330 | 232151_at | AL359055 | 21537-21547 |
| 208820_at | AL037339 | 9942-9952 | 232164_s_at | AL137725 | 21548-21558 |
| 208850_s_at | AL558479 | 9953-9963 | 232165_at | AL137725 | 21559-21569 |
| 208852_s_at | AI761759 | 9964-9974 | 232176_at | R70320 | 21570-21580 |
| 208853_s_at | L18887 | 9975-9985 | 232202_at | AK024927 | 21581-21591 |
| 208865_at | BG534245 | 9986-9996 | 232286_at | AA572675 | 21592-21602 |
| 208867_s_at | AF119911 | 9997-10007 | 232306_at | BG289314 | 21603-21613 |
| 208891_at | BC003143 | 11-Jan | 232318_s_at | AI680459 | 21614-21624 |
| 208892_s_at | BC003143 | 78-88 | 232321_at | AK026404 | 21625-21635 |
| 208992_s_at | BC000627 | 10008-10018 | 232352_at | AK001022 | 21636-21646 |
| 209008_x_at | U76549 | 10019-10029 | 232424_at | AI623202 | 21647-21657 |
| 209012_at | AV718192 | 10030-10040 | 232478_at | AU146021 | 21658-21668 |
| 209051_s_at | AF295773 | 10041-10051 | 232481_s_at | AL137517 | 21669-21679 |
| 209061_at | AI761748 | 10052-10062 | 232482_at | AF311306 | 21680-21690 |
| 209072_at | M13577 | 10063-10073 | 232523_at | AU144892 | 21691-21701 |
| 209074_s_at | AL050264 | 10074-10084 | 232531_at | AL137578 | 21702-21712 |
| 209114_at | AF133425 | 395-405 | 232546_at | AL136528 | 21713-21723 |
| 209122_at | BC005127 | 10085-10095 | 232578_at | BG547464 | 21724-21734 |
| 209125_at | J00269 | 10096-10106 | 232707_at | AK025181 | 21735-21745 |
| 209126_x_at | L42612 | 10107-10117 | 232737_s_at | AL157377 | 21746-21756 |
| 209135_at | AF289489 | 10118-10128 | 232765_x_at | AI985918 | 21757-21767 |
| 209154_at | AF234997 | 10129-10139 | 232955_at | AU144397 | 21768-21778 |
| 209156_s_at | AY029208 | 10140-10150 | 233064_at | AL365406 | 21779-21789 |
| 209160_at | AB018580 | 10151-10161 | 233364_s_at | AK021804 | 21790-21800 |
| 209167_at | AI419030 | 10162-10172 | 233446_at | AU145336 | 21801-21811 |
| 209168_at | AW148844 | 10173-10183 | 233499_at | AI366175 | 21812-21822 |
| 209169_at | N63576 | 10184-10194 | 233849_s_at | AK023014 | 21823-21833 |
| 209170_s_at | AF016004 | 10195-10205 | 233944_at | AU147118 | 21834-21844 |
| 209190_s_at | AF051782 | 10206-10216 | 233949_s_at | AI160292 | 21845-21855 |
| 209192_x_at | BC000166 | 10217-10227 | 233950_at | AK000873 | 21856-21866 |
| 209197_at | AA626780 | 10228-10238 | 233985_x_at | AV706485 | 21867-21877 |
| 209211_at | AF132818 | 10239-10249 | 234350_at | AF127125 | 21878-21888 |
| 209242_at | AL042588 | 10250-10260 | 234366_x_at | AF103591 | 21889-21899 |
| 209243_s_at | AF208967 | 10261-10271 | 234719_at | AK024889 | 21900-21910 |
| 209260_at | BC000329 | 10272-10282 | 235004_at | AI677701 | 21911-21921 |
| 209270_at | L25541 | 10283-10293 | 235075_at | AI813438 | 21922-21932 |
| 209283_at | AF007162 | 10294-10304 | 235077_at | BF956762 | 21933-21943 |
| 209291_at | AW157094 | 10305-10315 | 235118_at | AV724769 | 21944-21954 |
| 209292_at | AL022726 | 10316-10326 | 235127_at | AI699994 | 21955-21965 |
| 209301_at | M36532 | 10327-10337 | 235147_at | R56118 | 21966-21976 |
| 209309_at | D90427 | 10338-10348 | 235205_at | BF109660 | 21977-21987 |
| 209310_s_at | U25804 | 10349-10359 | 235251_at | AW292765 | 21988-21998 |
| 209341_s_at | AU153366 | 331-341 | 235272_at | AI814274 | 21999-22009 |
| 209343_at | BC002449 | 10360-10370 | 235342_at | AI808090 | 22010-22020 |
| 209349_at | U63139 | 10371-10381 | 235355_at | AL037998 | 22021-22031 |
| 209351_at | BC002690 | 10382-10392 | 235383_at | AA552060 | 22032-22042 |
| 209364_at | U66879 | 10393-10403 | 235400_at | AL560266 | 22043-22053 |
| 209368_at | AF233336 | 10404-10414 | 235417_at | BF689253 | 22054-22064 |
| 209436_at | AB018305 | 10415-10425 | 235445_at | BF965166 | 22065-22075 |
| 209441_at | AY009093 | 10426-10436 | 235460_at | AW149670 | 22076-22086 |
| 209442_x_at | AL136710 | 10437-10447 | 235465_at | N66614 | 22087-22097 |
| 209462_at | U48437 | 10448-10458 | 235503_at | BF589787 | 22098-22108 |
| 209466_x_at | M57399 | 10459-10469 | 235548_at | BG326592 | 22109-22119 |
| 209469_at | BF939489 | 10470-10480 | 235568_at | BF433657 | 22120-22130 |
| 209470_s_at | D49958 | 10481-10491 | 235591_at | R62424 | 22131-22141 |
| 209498_at | X16354 | 10492-10502 | 235639_at | AL137939 | 22142-22152 |
| 209514_s_at | BE502030 | 10503-10513 | 235651_at | AV741130 | 22153-22163 |
| 209515_s_at | U38654 | 10514-10524 | 235700_at | AI581344 | 22164-22174 |
| 209552_at | BC001060 | 10525-10535 | 235766_x_at | AA743462 | 22175-22182 |
| 209560_s_at | U15979 | 10536-10546 | 235774_at | AV699047 | 22183-22193 |
| 209569_x_at | NM_014392 | 10547-10557 | 235892_at | AI620881 | 22194-22204 |
| 209570_s_at | BC001745 | 10558-10568 | 235927_at | BE350122 | 22205-22215 |
| 209587_at | U70370 | 10569-10579 | 235976_at | AI680986 | 22216-22226 |
| 209602_s_at | AI796169 | 10580-10590 | 235977_at | BF433341 | 22227-22237 |
| 209603_at | AI796169 | 10591-10601 | 236017_at | AI199453 | 22238-22248 |
| 209604_s_at | BC003070 | 10602-10612 | 236028_at | BE466675 | 22249-22259 |
| 209616_s_at | S73751 | 10613-10623 | 236029_at | AI283093 | 22260-22270 |
| 209617_s_at | AF035302 | 10624-10634 | 236085_at | AI925136 | 22271-22281 |
| 209618_at | U96136 | 10635-10645 | 236119_s_at | AA456642 | 22282-22292 |
| 209644_x_at | U38945 | 10646-10656 | 236121_at | AI805082 | 22293-22303 |
| 209660_at | AF162690 | 10657-10667 | 236131_at | AW452631 | 22304-22314 |
| 209663_s_at | AF072132 | 10668-10678 | 236163_at | AW136983 | 22315-22325 |
| 209683_at | AA243659 | 10679-10689 | 236256_at | AW993690 | 22326-22336 |
| 209685_s_at | M13975 | 10690-10700 | 236264_at | BF511741 | 22337-22347 |
| 209686_at | BC001766 | 10701-10711 | 236361_at | BF432376 | 22348-22358 |
| 209692_at | U71207 | 10712-10722 | 236444_x_at | BE785577 | 22359-22369 |
| 209699_x_at | U05598 | 10723-10726 | 236523_at | BF435831 | 22370-22380 |
| 209706_at | AF247704 | 10727-10737 | 236534_at | W69365 | 22381-22391 |
| 209719_x_at | U19556 | 10738-10748 | 236538_at | BE219628 | 22392-22402 |
| 209720_s_at | BC005224 | 10749-10759 | 236761_at | AI939602 | 22403-22413 |
| 209742_s_at | AF020768 | 10760-10770 | 236773_at | AI635931 | 22414-22424 |
| 209752_at | AF172331 | 10771-10781 | 236860_at | BF968482 | 22425-22435 |
| 209757_s_at | BC002712 | 10782-10792 | 236926_at | AW074836 | 22436-22446 |
| 209771_x_at | AA761181 | 10793-10799 | 236972_at | AI351421 | 22447-22457 |
| 209772_s_at | X69397 | 10800-10810 | 237017_s_at | T73002 | 22458-22468 |
| 209790_s_at | BC000305 | 10811-10821 | 237030_at | AI659898 | 22469-22479 |
| 209794_at | AB007871 | 10822-10832 | 237058_x_at | AI802118 | 22480-22490 |
| 209799_at | AF100763 | 10833-10843 | 237077_at | AI821895 | 22491-22501 |
| 209800_at | AF061812 | 10844-10854 | 237086_at | AI693336 | 22502-22512 |
| 209810_at | J02761 | 10855-10865 | 237206_at | AI452798 | 22513-22523 |
| 209813_x_at | M16768 | 10866-10876 | 237328_at | AI927063 | 22524-22534 |
| 209815_at | BG054916 | 10877-10887 | 237339_at | AI668620 | 22535-22545 |
| 209824_s_at | AB000812 | 10888-10898 | 237350_at | AW027968 | 22546-22556 |
| 209827_s_at | NM_004513 | 10899-10909 | 237351_at | AI732190 | 22557-22567 |
| 209835_x_at | BC004372 | 10910-10916 | 237395_at | AV700083 | 22568-22578 |
| 209839_at | AL136712 | 10917-10927 | 237466_s_at | AW444502 | 22579-22589 |
| 209842_at | AI367319 | 10928-10938 | 237530_at | T77543 | 22590-22600 |
| 209843_s_at | BC002824 | 10939-10949 | 237732_at | AI432195 | 22601-22611 |
| 209844_at | U57052 | 10950-10960 | 237736_at | AI569844 | 22612-22622 |
| 209847_at | U07969 | 10961-10971 | 237810_at | AW003929 | 22623-22633 |
| 209848_s_at | U01874 | 10972-10982 | 238003_at | AI885128 | 22634-22644 |
| 209854_s_at | AA595465 | 10983-10993 | 238017_at | AI440266 | 22645-22655 |
| 209855_s_at | AF188747 | 10994-11004 | 238021_s_at | AA954994 | 22656-22666 |
| 209856_x_at | U31089 | 206-216 | 238047_at | AA405456 | 22667-22677 |
| 209863_s_at | AF091627 | 11005-11015 | 238143_at | AW001557 | 22678-22688 |
| 209871_s_at | AB014719 | 11016-11026 | 238165_at | AW665629 | 22689-22699 |
| 209875_s_at | M83248 | 89-99 | 238206_at | AI089319 | 22700-22710 |
| 209877_at | AF010126 | 11027-11037 | 238231_at | AV700263 | 22711-22721 |
| 209888_s_at | M20643 | 11038-11048 | 238452_at | AI393356 | 22722-22732 |
| 209902_at | U49844 | 11049-11059 | 238460_at | AI590662 | 22733-22743 |
| 209904_at | AF020769 | 11060-11070 | 238481_at | AW512787 | 22744-22754 |
| 209905_at | AI246769 | 11071-11081 | 238516_at | BF247383 | 22755-22765 |
| 209924_at | AB000221 | 11082-11092 | 238567_at | AW779536 | 22766-22776 |
| 209932_s_at | U90223 | 11093-11103 | 238575_at | AI094626 | 22777-22787 |
| 209937_at | BC001386 | 11104-11114 | 238584_at | W52934 | 22788-22798 |
| 209939_x_at | AF005775 | 342-350 | 238603_at | AI611973 | 22799-22809 |
| 209939_x_at | AF005775 | 182-183 | 238657_at | T86344 | 22810-22820 |
| 209950_s_at | BC004300 | 11115-11125 | 238689_at | BG426455 | 22821-22831 |
| 209975_at | AF182276 | 11126-11135 | 238698_at | AI659225 | 22832-22842 |
| 209976_s_at | AF182276 | 11136-11146 | 238699_s_at | AI659225 | 22843-22853 |
| 209977_at | M74220 | 11147-11157 | 238815_at | BF529195 | 22854-22864 |
| 209978_s_at | M74220 | 11158-11168 | 238850_at | AW015083 | 22865-22875 |
| 209990_s_at | AF056085 | 11169-11179 | 238878_at | AA496211 | 22876-22886 |
| 209991_x_at | AF069755 | 11180-11190 | 238956_at | AA502384 | 22887-22897 |
| 209995_s_at | BC003574 | 11191-11201 | 239006_at | AI758950 | 22898-22908 |
| 210002_at | D87811 | 11202-11212 | 239144_at | AA835648 | 22909-22919 |
| 210010_s_at | U25147 | 11213-11223 | 239202_at | BE552383 | 22920-22930 |
| 210013_at | BC005395 | 11224-11234 | 239230_at | AW079166 | 22931-22941 |
| 210020_x_at | M58026 | 11235-11245 | 239270_at | AL133721 | 22942-22952 |
| 210055_at | BE045816 | 11246-11256 | 239332_at | AW079559 | 22953-22963 |
| 210058_at | BC000433 | 11257-11267 | 239381_at | AU155415 | 22964-22974 |
| 210059_s_at | BC000433 | 11268-11278 | 239430_at | AA195677 | 22975-22985 |
| 210064_s_at | NM_006952 | 11279-11289 | 239537_at | AW589904 | 22986-22996 |
| 210065_s_at | AB002155 | 11290-11300 | 239595_at | AA569032 | 22997-23007 |
| 210066_s_at | D63412 | 11301-11311 | 239667_at | AW000967 | 23008-23018 |
| 210068_s_at | U63622 | 11312-11322 | 239707_at | BF510408 | 23019-23029 |
| 210084_x_at | AF206665 | 11323-11327 | 239767_at | W72323 | 23030-23040 |
| 210096_at | J02871 | 11328-11338 | 239805_at | AW136060 | 23041-23051 |
| 210105_s_at | M14333 | 11339-11349 | 239853_at | AI279514 | 23052-23062 |
| 210107_at | AF127036 | 11350-11360 | 239858_at | AI973051 | 23063-23073 |
| 210118_s_at | M15329 | 11361-11371 | 239860_at | AI311917 | 23074-23084 |
| 210133_at | D49372 | 11372-11382 | 239884_at | BE467579 | 23085-23095 |
| 210135_s_at | AF022654 | 11383-11393 | 239911_at | H49805 | 23096-23106 |
| 210138_at | AF074979 | 11394-11404 | 239990_at | AI821426 | 23107-23117 |
| 210143_at | AF196478 | 11405-11415 | 240033_at | BF447999 | 23118-23128 |
| 210159_s_at | AF230386 | 11416-11426 | 240045_at | AI694242 | 23129-23139 |
| 210162_s_at | U08015 | 11427-11437 | 240161_s_at | AI470220 | 23140-23150 |
| 210170_at | BC001017 | 11438-11448 | 240192_at | AI631850 | 23151-23161 |
| 210198_s_at | BC002665 | 11449-11459 | 240236_at | N50117 | 23162-23172 |
| 210213_s_at | AF022229 | 11460-11470 | 240242_at | BE222843 | 23173-23183 |
| 210215_at | AF067864 | 11471-11481 | 240253_at | BF508634 | 23184-23194 |
| 210216_x_at | AF084513 | 11482-11488 | 240275_at | AI936559 | 23195-23205 |
| 210239_at | U90304 | 11489-11499 | 240303_at | BG484769 | 23206-23216 |
| 210240_s_at | U20498 | 11500-11510 | 240331_at | AI820961 | 23217-23227 |
| 210246_s_at | AF087138 | 11511-11521 | 240433_x_at | H39185 | 23228-23238 |
| 210248_at | D83175 | 11522-11532 | 241137_at | AW338320 | 23239-23249 |
| 210263_at | AF029780 | 11533-11543 | 241291_at | AI922102 | 23250-23260 |
| 210289_at | AB013094 | 11544-11554 | 241314_at | AI732874 | 23261-23271 |
| 210297_s_at | U22178 | 11555-11565 | 241350_at | AL533913 | 23272-23282 |
| 210302_s_at | AF262032 | 11566-11576 | 241382_at | W22165 | 23283-23293 |
| 210326_at | D13368 | 11577-11587 | 241450_at | AI224952 | 23294-23304 |
| 210327_s_at | D13368 | 11588-11598 | 241813_at | BG252318 | 23305-23315 |
| 210328_at | AF101477 | 11599-11609 | 241914_s_at | AA804293 | 23316-23326 |
| 210337_s_at | U18197 | 11610-11620 | 241966_at | N67810 | 23327-23337 |
| 210339_s_at | BC005196 | 11621-11631 | 241987_x_at | BF029081 | 23338-23348 |
| 210342_s_at | M17755 | 11632-11642 | 242169_at | AA703201 | 23349-23359 |
| 210383_at | AF225985 | 11643-11653 | 242266_x_at | AW973803 | 23360-23368 |
| 210390_s_at | AF031587 | 11654-11664 | 242344_at | AA772920 | 23369-23379 |
| 210413_x_at | U19557 | 11665-11672 | 242406_at | AI870547 | 23380-23390 |
| 210432_s_at | AF225986 | 11673-11683 | 242468_at | AA767317 | 23391-23401 |
| 210446_at | M30601 | 11684-11694 | 242509_at | R71072 | 23402-23412 |
| 210448_s_at | U49396 | 11695-11705 | 242601_at | AA600175 | 23413-23423 |
| 210512_s_at | AF022375 | 100-110 | 242649_x_at | AI928428 | 23424-23434 |
| 210563_x_at | U97075 | 11706-11707 | 242660_at | AA846789 | 23435-23445 |
| 210564_x_at | AF009619 | 217-218 | 242733_at | AI457588 | 23446-23456 |
| 210587_at | BC005161 | 11708-11718 | 242785_at | BF663308 | 23457-23467 |
| 210621_s_at | M23612 | 11719-11729 | 242817_at | BE672390 | 23468-23478 |
| 210627_s_at | BC002804 | 11730-11740 | 242856_at | AI291804 | 23479-23489 |
| 210643_at | AF053712 | 11741-11751 | 242940_x_at | AA040332 | 23490-23500 |
| 210655_s_at | AF041336 | 11752-11762 | 243168_at | AI916532 | 23501-23511 |
| 210673_x_at | D50740 | 11763-11773 | 243231_at | N62096 | 23512-23522 |
| 210688_s_at | BC000185 | 11774-11784 | 243241_at | AW341473 | 23523-23533 |
| 210735_s_at | BC000278 | 11785-11795 | 243339_at | AI796076 | 23534-23544 |
| 210754_s_at | M79321 | 406-416 | 243346_at | BF109621 | 23545-23555 |
| 210756_s_at | AF308601 | 11796-11806 | 243409_at | AI005407 | 23556-23566 |
| 210794_s_at | AF119863 | 11807-11817 | 243483_at | AI272941 | 23567-23577 |
| 210798_x_at | AB008047 | 11818-11828 | 243489_at | BF514098 | 23578-23588 |
| 210808_s_at | AF166327 | 11829-11839 | 243669_s_at | AA502331 | 23589-23599 |
| 210809_s_at | D13665 | 11840-11850 | 243792_x_at | AI281371 | 23600-23610 |
| 210827_s_at | U73844 | 11851-11861 | 243818_at | T96555 | 23611-23621 |
| 210844_x_at | D14705 | 417-427 | 244023_at | AW467357 | 23622-23632 |
| 210888_s_at | AF116713 | 11862-11872 | 244044_at | AV691872 | 23633-23643 |
| 210896_s_at | AF306765 | 11873-11883 | 244056_at | AW293443 | 23644-23654 |
| 210906_x_at | U34846 | 11884-11892 | 244107_at | AW189097 | 23655-23665 |
| 210916_s_at | AF098641 | 11893-11901 | 244170_at | H05254 | 23666-23676 |
| 210929_s_at | AF130057 | 11902-11912 | 244403_at | R49501 | 23677-23687 |
| 210944_s_at | BC003169 | 11913-11923 | 244472_at | AW291482 | 23688-23698 |
| 210951_x_at | AF125393 | 11924-11928 | 244567_at | BG165613 | 23699-23709 |
| 210971_s_at | AB000815 | 11929-11939 | 244579_at | AI086336 | 23710-23720 |
| 210993_s_at | U54826 | 11940-11950 | 244692_at | AW025687 | 23721-23731 |
| 211002_s_at | AF230389 | 11951-11961 | 244723_at | BF510430 | 23732-23742 |
| 211024_s_at | BC006221 | 11962-11972 | 244739_at | AI051769 | 23743-23753 |
| 211029_x_at | BC006245 | 11973-11983 | 244780_at | AI800110 | 23754-23764 |
| 211062_s_at | BC006393 | 11984-11994 | 244839_at | AW975934 | 23765-23775 |
| 211063_s_at | BC006403 | 11995-12005 | 266_s_at | L33930 | 23776-23790 |
| 211071_s_at | BC006471 | 12006-12016 | 32128_at | Y13710 | 23791-23806 |
| 211105_s_at | U80918 | 12017-12027 | 32625_at | X15357 | 23807-23822 |
| 211144_x_at | M30894 | 12028-12029 | 33322_i_at | X57348 | 23823-23835 |
| 211151_x_at | AF185611 | 12030-12040 | 33323_r_at | X57348 | 23836-23850 |
| 211165_x_at | D31661 | 12041-12051 | 33767_at | X15306 | 23851-23864 |
| 211235_s_at | AF258450 | 12052-12062 | 34210_at | N90866 | 23865-23880 |
| 211298_s_at | AF116645 | 12063-12073 | 34471_at | M36769 | 23881-23895 |
| 211300_s_at | K03199 | 12074-12084 | 35617_at | U29725 | 23896-23911 |
| 211303_x_at | AF261715 | 12085-12089 | 35846_at | M24899 | 23912-23927 |
| 211357_s_at | BC005314 | 12090-12100 | 36711_at | AL021977 | 155-170 |
| 211361_s_at | AJ001696 | 12101-12111 | 37004_at | J02761 | 23928-23942 |
| 211430_s_at | M87789 | 12112-12122 | 37020_at | X56692 | 23943-23958 |
| 211464_x_at | U20537 | 12123-12132 | 37433_at | AF077954 | 23959-23974 |
| 211483_x_at | AF081924 | 12133-12143 | 37512_at | U89281 | 23975-23990 |
| 211536_x_at | AB009358 | 12144-12154 | 37892_at | J04177 | 23991-24004 |
| 211537_x_at | AF218074 | 12155-12158 | 37986_at | M60459 | 24005-24020 |
| 211546_x_at | L36674 | 12159-12162 | 38691_s_at | J03553 | 24021-24036 |
| 211548_s_at | J05594 | 12163-12168 | 39248_at | N74607 | 24037-24052 |
| 211549_s_at | U63296 | 12169-12179 | 39249_at | AB001325 | 24053-24068 |
| 211585_at | U58852 | 12180-12190 | 39966_at | AF059274 | 24069-24084 |
| 211597_s_at | AB059408 | 12191-12201 | 40560_at | U28049 | 461-476 |
| 211630_s_at | L42531 | 12202-12212 | 40562_at | AF011499 | 24085-24100 |
| 211653_x_at | M33376 | 12213-12218 | 40665_at | M83772 | 24101-24115 |
| 211657_at | M18728 | 12219-12229 | 41469_at | L10343 | 24116-24131 |
| 211671_s_at | U01351 | 219-224 | 564_at | M69013 | 24132-24141 |
| 211679_x_at | AF095784 | 12230-12235 | 60474_at | AA469071 | 24142-24156 |
| 211689_s_at | AF270487 | 12236-12246 | AFFX- | AFFX- | 24157-24176 |
| | | | HSAC07/X00351_5_at | HSAC07/X00351_5 | |
| 211711_s_at | BC005821 | 12247-12257 | AFFX- | AFFX- | 24177-24196 |
| | | | HUMISGF3A/M97935_5_at | HUMISGF3A/M97935_5 | |
| 211729_x_at | BC005902 | 12258-12260 | | | |
| 211735_x_at | BC005913 | 12261-12262 | | | |
| 211766_s_at | BC005989 | 12263-12273 | | | |
| 211792_s_at | U17074 | 12274-12284 | | | |

TABLE 3
200 genes used in conjunction with clinical variables to predict breast cancer
recurrence risk status. Cox regression p-value is testing the hypothesis if the expression
data is predictive of survival over and above the clinical variable covariates.

| Affymetrix Probe ID | Genbank Accession | Gene Symbol | p-value | SEQ ID NOS |
|---|---|---|---|---|
| 200005_at | NM_003753 | EIF3D | 0.000724 | 25788-25798 |
| 200684_s_at | AI819709 | UBE2L3 | 0.000414 | 25799-25809 |
| 200717_x_at | NM_000971 | RPL7 | 0.000941 | 25810-25820 |
| 200741_s_at | NM_001030 | RPS27 | 0.000398 | 25821-25831 |
| 200749_at | BF112006 | RAN | 0.000729 | 25832-25842 |
| 200756_x_at | U67280 | CALU | 5.56E−05 | 25843-25853 |
| 200772_x_at | BF686442 | PTMA | 0.00026 | 25854-25864 |
| 200847_s_at | NM_016127 | TMEM66 | 0.000108 | 25865-25875 |
| 200990_at | NM_005762 | TRIM28 | 0.000223 | 25876-25886 |
| 200997_at | NM_002896 | RBM4 | 3.60E−06 | 25887-25897 |
| 201115_at | NM_006230 | POLD2 | 0.000503 | 25898-25908 |
| 201200_at | NM_003851 | CREG1 | 5.54E−05 | 25909-25919 |
| 201277_s_at | NM_004499 | HNRNPAB | 0.00027 | 25920-25930 |
| 201291_s_at | AU159942 | TOP2A | 0.000616 | 25931-25941 |
| 201302_at | NM_001153 | ANXA4 | 1.17E−05 | 25942-25952 |
| 201383_s_at | AL044170 | NBR1 | 0.000565 | 25953-25963 |
| 201416_at | BG528420 | SOX4 | 0.000146 | 25964-25974 |
| 201459_at | NM_006666 | RUVBL2 | 2.80E−06 | 25975-25985 |
| 201494_at | NM_005040 | PRCP | 0.000421 | 25986-25996 |
| 201534_s_at | AF044221 | UBL3 | 0.000486 | 25997-26007 |
| 201571_s_at | AI656493 | DCTD | 3.00E−07 | 26008-26018 |
| 201726_at | BC003376 | ELAVL1 | 0.000735 | 26019-26029 |
| 201865_x_at | AI432196 | NR3C1 | 0.000346 | 171-181 |
| 202026_at | NM_003002 | SDHD | 7.00E−07 | 26030-26040 |
| 202120_x_at | NM_004069 | AP2S1 | 0.000206 | 26041-26051 |
| 202195_s_at | NM_016040 | TMED5 | 0.000708 | 26052-26062 |
| 202502_at | NM_000016 | ACADM | 0.000521 | 26063-26073 |
| 202545_at | NM_006254 | PRKCD | 0.000879 | 26074-26084 |
| 202567_at | NM_004175 | SNRPD3 | 0.00077 | 26085-26095 |
| 202667_s_at | NM_006979 | SLC39A7 | 0.000222 | 26096-26106 |
| 202835_at | BC001046 | TXNL4A | 0.000681 | 26107-26117 |
| 202838_at | NM_000147 | FUCA1 | 0.000398 | 26118-26128 |
| 202865_at | AI695173 | DNAJB12 | 1.29E−05 | 26129-26139 |
| 202871_at | NM_004295 | TRAF4 | 7.20E−05 | 26140-26150 |
| 202978_s_at | AW204564 | CREBZF | 0.000456 | 26151-26161 |
| 203123_s_at | AU154469 | SLC11A2 | 0.000395 | 26162-26172 |
| 203134_at | NM_007166 | PICALM | 0.000635 | 26173-26183 |
| 203266_s_at | NM_003010 | MAP2K4 | 0.00077 | 26184-26194 |
| 203276_at | NM_005573 | LMNB1 | 0.000657 | 26195-26205 |
| 203526_s_at | M74088 | APC | 0.000734 | 184-194 |
| 203606_at | NM_004553 | NDUFS6 | 8.79E−05 | 26206-26216 |
| 203638_s_at | NM_022969 | FGFR2 | 0.000394 | 26217-26227 |
| 203713_s_at | NM_004524 | LLGL2 | 0.000761 | 26228-26238 |
| 203725_at | NM_001924 | GADD45A | 0.000312 | 26239-26249 |
| 203744_at | NM_005342 | HMGB3 | 0.000108 | 26250-26260 |
| 203830_at | NM_022344 | C17orf75 | 1.46E−05 | 26261-26271 |
| 203975_s_at | BF000239 | CHAF1A | 0.000245 | 26272-26282 |
| 204033_at | NM_004237 | TRIP13 | 0.000126 | 26283-26293 |
| 204170_s_at | NM_001827 | CKS2 | 0.000831 | 25777-25787 |
| 204174_at | NM_001629 | ALOX5AP | 0.000501 | 26294-26304 |
| 204178_s_at | NM_006328 | RBM14 | 0.000547 | 26305-26315 |
| 204188_s_at | M57707 | RARG | 3.73E−05 | 26316-26326 |
| 204216_s_at | NM_024824 | ZC3H14 | 0.000647 | 26327-26337 |
| 204236_at | NM_002017 | FLI1 | 0.000182 | 26338-26348 |
| 204313_s_at | AA161486 | CREB1 | 0.000719 | 26349-26359 |
| 204402_at | NM_012265 | RHBDD3 | 0.00075 | 26360-26370 |
| 204767_s_at | BC000323 | FEN1 | 0.000261 | 26371-26381 |
| 204785_x_at | NM_000874 | IFNAR2 | 0.00087 | 26382-26392 |
| 204817_at | NM_012291 | ESPL1 | 0.000155 | 26393-26403 |
| 205083_at | NM_001159 | AOX1 | 3.90E−05 | 26404-26414 |
| 205097_at | AI025519 | SLC26A2 | 0.000632 | 26415-26425 |
| 205233_s_at | NM_000437 | PAFAH2 | 0.000648 | 26426-26436 |
| 205269_at | AI123251 | LCP2 | 0.000196 | 26437-26447 |
| 205417_s_at | NM_004393 | DAG1 | 0.000344 | 195-205 |
| 205436_s_at | NM_002105 | H2AFX | 0.000111 | 26448-26458 |
| 205538_at | NM_003389 | CORO2A | 0.000945 | 26459-26469 |
| 205542_at | NM_012449 | STEAP1 | 3.20E−06 | 26470-26480 |
| 205732_s_at | NM_006540 | NCOA2 | 0.00022 | 26481-26491 |
| 205746_s_at | U86755 | ADAM17 | 0.000743 | 26492-26502 |
| 205898_at | U20350 | CX3CR1 | 0.000518 | 26503-26513 |
| 206313_at | NM_002119 | HLA-DOA | 0.000314 | 26514-26524 |
| 206445_s_at | NM_001536 | PRMT1 | 7.30E−05 | 26525-26535 |
| 206748_s_at | NM_003971 | SPAG9 | 0.000159 | 26536-26546 |
| 206807_s_at | NM_017482 | ADD2 | 0.000267 | 26547-26557 |
| 207057_at | NM_004731 | SLC16A7 | 2.52E−05 | 26558-26568 |
| 207112_s_at | NM_002039 | GAB1 | 3.00E−07 | 26569-26579 |
| 207243_s_at | NM_001743 | | 4.75E−05 | 26580-26590 |
| 207292_s_at | NM_002749 | MAPK7 | 4.58E−05 | 26591-26601 |
| 207304_at | NM_003425 | ZNF45 | 6.25E−05 | 26602-26612 |
| 207319_s_at | NM_003718 | CDK13 | 0.000756 | 26613-26623 |
| 207387_s_at | NM_000167 | GK | 0.000692 | 26624-26634 |
| 207419_s_at | NM_002872 | RAC2 | 0.000137 | 26635-26645 |
| 208074_s_at | NM_021575 | AP2S1 | 0.000205 | 26646-26656 |
| 208228_s_at | M87771 | FGFR2 | 0.000197 | 26657-26667 |
| 208403_x_at | NM_002382 | MAX | 0.000162 | 26668-26678 |
| 208453_s_at | NM_006523 | XPNPEP1 | 0.000762 | 26679-26689 |
| 208503_s_at | NM_021167 | GATAD1 | 4.50E−06 | 26690-26700 |
| 208549_x_at | NM_016171 | PTMAP7 | 8.54E−05 | 26701-26710 |
| 208633_s_at | W61052 | MACF1 | 0.000436 | 26711-26721 |
| 208688_x_at | U78525 | EIF3B | 0.000813 | 26722-26732 |
| 208700_s_at | L12711 | TKT | 2.39E−05 | 26733-26743 |
| 208794_s_at | D26156 | SMARCA4 | 0.00027 | 26744-26754 |
| 208930_s_at | BG032366 | ILF3 | 0.000401 | 26755-26765 |
| 209006_s_at | AF247168 | C1orf63 | 0.000219 | 26766-26776 |
| 209059_s_at | AB002282 | EDF1 | 0.00072 | 26777-26787 |
| 209103_s_at | BC001049 | UFD1L | 0.000718 | 26788-26798 |
| 209302_at | U37689 | POLR2H | 0.000275 | 26799-26809 |
| 209311_at | D87461 | BCL2L2 | 0.000443 | 26810-26820 |
| 209431_s_at | AF254083 | PATZ1 | 9.70E−06 | 26821-26831 |
| 209456_s_at | AB033281 | FBXW11 | 0.000144 | 26832-26842 |
| 209508_x_at | AF005774 | CFLAR | 0.000165 | 26843-26853 |
| 209680_s_at | BC000712 | KIFC1 | 6.35E−05 | 26854-26864 |
| 209750_at | N32859 | NR1D2 | 0.000953 | 26865-26875 |
| 209754_s_at | AF113682 | TMPO | 0.000985 | 26876-26886 |
| 209856_x_at | U31089 | ABI2 | 0.000384 | 206-216 |
| 209939_x_at | AF005775 | CFLAR | 0.000316 | 182-183 |
| 209974_s_at | AF047473 | BUB3 | 0.000211 | 26887-26897 |
| 210282_at | AL136621 | ZMYM2 | 0.00017 | 26898-26908 |
| 210465_s_at | U71300 | SNAPC3 | 0.000233 | 26909-26919 |
| 210564_x_at | AF009619 | CFLAR | 0.000391 | 26920-26925 |
| 210564_x_at | AF009619 | CFLAR | 0.000391 | 217-218 |
| 210687_at | BC000185 | CPT1A | 0.000413 | 26926-26936 |
| 210838_s_at | L17075 | ACVRL1 | 0.000121 | 26937-26947 |
| 210872_x_at | BC001152 | GAS7 | 4.42E−05 | 26948-26958 |
| 210980_s_at | U47674 | ASAH1 | 0.000373 | 26959-26969 |
| 210981_s_at | AF040751 | GRK6 | 0.000279 | 26970-26980 |
| 211047_x_at | BC006337 | AP2S1 | 0.000333 | 26981-26986 |
| 211574_s_at | D84105 | CD46 | 0.000883 | 26987-26997 |
| 211671_s_at | U01351 | NR3C1 | 5.24E−05 | 219-224 |
| 211749_s_at | BC005941 | VAMP3 | 0.000123 | 26998-27008 |
| 211807_x_at | AF152521 | PCDHGB5 | 0.000467 | 27009-27019 |
| 211921_x_at | AF348514 | PTMA | 5.63E−05 | 27020-27025 |
| 211922_s_at | AY028632 | CAT | 0.000272 | 27026-27036 |
| 212008_at | N29889 | UBXN4 | 4.49E−05 | 27037-27047 |
| 212023_s_at | AU147044 | MKI67 | 6.68E−05 | 27048-27058 |
| 212084_at | AV759552 | TEX261 | 0.000814 | 27059-27069 |
| 212087_s_at | AL562733 | ERAL1 | 0.000101 | 27070-27080 |
| 212093_s_at | AI695017 | MTUS1 | 0.000164 | 27081-27091 |
| 212094_at | AL582836 | PEG10 | 8.26E−05 | 225-235 |
| 212181_s_at | AF191654 | NUDT4 | 9.48E−05 | 27092-27102 |
| 212196_at | AW242916 | IL6ST | 0.000294 | 27103-27113 |
| 212224_at | NM_000689 | ALDH1A1 | 7.20E−06 | 236-246 |
| 212241_at | AI632774 | GRINL1A | 0.000473 | 27114-27124 |
| 212324_s_at | BF111962 | VPS13D | 0.000526 | 27125-27135 |
| 212398_at | AI057093 | RDX | 0.000896 | 27136-27146 |
| 212526_at | AK002207 | SPG20 | 0.000331 | 27147-27157 |
| 212656_at | AF110399 | TSFM | 0.000656 | 27158-27168 |
| 212672_at | U82828 | ATM | 0.00075 | 27169-27179 |
| 212742_at | AL530462 | RNF115 | 6.12E−05 | 27180-27190 |
| 213007_at | W74442 | FANCI | 2.69E−05 | 27191-27201 |
| 213008_at | BG403615 | FANCI | 0.000113 | 27202-27212 |
| 213376_at | AI656706 | ZBTB1 | 0.000727 | 27213-27223 |
| 213441_x_at | AI745526 | SPDEF | 0.00043 | 27224-27232 |
| 213441_x_at | AI745526 | SPDEF | 0.00043 | 247-248 |
| 213507_s_at | BG249565 | KPNB1 | 0.00013 | 27233-27243 |
| 213614_x_at | BE786672 | EEF1A1 | 0.000334 | 27244-27254 |
| 213619_at | AV753392 | HNRNPH1 | 0.000102 | 27255-27265 |
| 213698_at | AI805560 | ZMYM6 | 6.90E−05 | 27266-27276 |
| 213702_x_at | AI934569 | ASAH1 | 0.00031 | 27277-27284 |
| 213720_s_at | AI831675 | SMARCA4 | 7.70E−06 | 27285-27295 |
| 214098_at | AB029030 | KIAA1107 | 0.000989 | 27296-27306 |
| 214196_s_at | AA602532 | TPP1 | 4.66E−05 | 27307-27317 |
| 214299_at | AI676092 | TOP3A | 0.000304 | 27318-27328 |
| 214513_s_at | M34356 | CREB1 | 0.000173 | 27329-27339 |
| 214670_at | AA653300 | ZKSCAN1 | 2.94E−05 | 27340-27350 |
| 214710_s_at | BE407516 | CCNB1 | 0.000727 | 27351-27361 |
| 214753_at | AW084068 | N4BP2L2 | 7.44E−05 | 27362-27372 |
| 214843_s_at | AK022864 | USP33 | 0.000271 | 27373-27383 |
| 214845_s_at | AF257659 | CALU | 3.61E−05 | 27384-27390 |
| 214995_s_at | BF508948 | | 6.20E−05 | 27391-27401 |
| 215533_s_at | AF091093 | UBE4B | 2.44E−05 | 27402-27412 |
| 215784_at | AA309511 | CD1E | 9.90E−06 | 27413-27423 |
| 215832_x_at | AV722190 | PICALM | 2.44E−05 | 27424-27434 |
| 217014_s_at | AC004522 | AZGP1 | 8.57E−05 | 249-259 |
| 217370_x_at | S75762 | NR1H3 | 0.000774 | 27435-27445 |
| 217591_at | BF725121 | SKIL | 0.00024 | 27446-27456 |
| 217732_s_at | AF092128 | ITM2B | 0.000378 | 27457-27467 |
| 217806_s_at | NM_015584 | POLDIP2 | 0.000478 | 27468-27478 |
| 218009_s_at | NM_003981 | PRC1 | 5.30E−06 | 27479-27489 |
| 218039_at | NM_016359 | NUSAP1 | 0.000324 | 27490-27500 |
| 218194_at | NM_015523 | REXO2 | 0.000854 | 27501-27511 |
| 218318_s_at | NM_016231 | NLK | 0.000535 | 27512-27522 |
| 218592_s_at | NM_017829 | CECR5 | 6.83E−05 | 27523-27533 |
| 218614_at | NM_018169 | C12orf35 | 0.000769 | 27534-27544 |
| 218659_at | NM_018263 | ASXL2 | 1.00E−07 | 27545-27555 |
| 218755_at | NM_005733 | KIF20A | 0.000986 | 27556-27566 |
| 218924_s_at | NM_004388 | CTBS | 0.000386 | 27567-27577 |
| 219074_at | NM_018241 | TMEM184C | 0.000193 | 27578-27588 |
| 219223_at | NM_017586 | C9orf7 | 0.000695 | 27589-27599 |
| 219288_at | NM_020685 | C3orf14 | 0.000751 | 260-270 |
| 219328_at | NM_022779 | DDX31 | 0.000803 | 27600-27610 |
| 219582_at | NM_024576 | OGFRL1 | 0.000625 | 27611-27621 |
| 219679_s_at | NM_018604 | WAC | 0.000399 | 27622-27632 |
| 219777_at | NM_024711 | GIMAP6 | 0.000612 | 27633-27643 |
| 219924_s_at | NM_007167 | ZMYM6 | 0.000467 | 27644-27654 |
| 219961_s_at | NM_018474 | PLK1S1 | 0.000472 | 27655-27665 |
| 219969_at | NM_018360 | TXLNG | 0.000643 | 27666-27676 |
| 220324_at | NM_024882 | C6orf155 | 2.11E−05 | 27677-27687 |
| 220338_at | NM_018037 | RALGPS2 | 0.000907 | 27688-27698 |
| 220368_s_at | NM_017936 | SMEK1 | 0.000534 | 27699-27709 |
| 220526_s_at | NM_017971 | MRPL20 | 7.92E−05 | 27710-27720 |
| 220985_s_at | NM_030954 | RNF170 | 1.10E−06 | 27721-27731 |
| 221242_at | NM_025051 | | 0.000182 | 27732-27742 |
| 221434_s_at | NM_031210 | C14orf156 | 0.000406 | 27743-27753 |
| 221509_at | AB014731 | DENR | 6.91E−05 | 27754-27764 |
| 221523_s_at | AL138717 | RRAGD | 0.000675 | 27765-27775 |
| 221643_s_at | AF016005 | RERE | 0.000235 | 27776-27786 |
| 221976_s_at | AW207448 | HDGFRP3 | 0.000196 | 27787-27797 |
| 222077_s_at | AU153848 | RACGAP1 | 0.000115 | 27798-27808 |
| 222314_x_at | AW970881 | EGOT | 0.000807 | 27809-27819 |
| 34031_i_at | U90269 | KRIT1 | 4.16E−05 | 27820-27832 |
| 40020_at | AB011536 | CELSR3 | 0.000742 | 27833-27848 |
| 64486_at | AI341234 | CORO1B | 0.000941 | 27849-27864 |

TABLE 6
163 genes used in conjunction with clinical variables to predict colon cancer
recurrence risk status. Cox regression p-value is testing the hypothesis if the expression
data is predictive of survival over and above the clinical variable covariates.

| Affymetrix probe ID | Genbank Accession | Gene Symbol | p-value | SEQ ID NOS |
|---|---|---|---|---|
| 1553954_at | BU682208 | ALG14 | 1.89E−03 | 24197-24207 |
| 1554078_s_at | BC032100 | DNAJA3 | 8.51E−04 | 24208-24218 |
| 1555832_s_at | BU683415 | KLF6 | 5.44E−04 | 24219-24229 |
| 1555950_a_at | CA448665 | CD55 | 2.32E−05 | 24230-24240 |
| 1560089_at | AL833509 | LOC100289019 | 1.72E−03 | 24241-24251 |
| 1560587_s_at | AI718223 | PRDX5 | 8.98E−04 | 24252-24262 |
| 1563796_s_at | AK095998 | EARS2 | 1.51E−04 | 24263-24273 |
| 200006_at | NM_007262 | PARK7 | 1.88E−03 | 24274-24284 |
| 200632_s_at | NM_006096 | NDRG1 | 4.74E−05 | 24285-24295 |
| 200665_s_at | NM_003118 | SPARC | 9.49E−04 | 24296-24306 |
| 200827_at | NM_000302 | PLOD1 | 1.79E−04 | 24307-24317 |
| 200838_at | NM_001908 | CTSB | 1.77E−03 | 24318-24328 |
| 200839_s_at | NM_001908 | CTSB | 1.95E−03 | 24329-24339 |
| 200931_s_at | NM_014000 | VCL | 5.40E−04 | 12-22 |
| 200983_x_at | BF983379 | CD59 | 1.20E−03 | 24340-24350 |
| 201012_at | NM_000700 | ANXA1 | 2.47E−04 | 24351-24361 |
| 201141_at | NM_002510 | GPNMB | 1.82E−03 | 24362-24372 |
| 201170_s_at | NM_003670 | BHLHE40 | 5.20E−06 | 24373-24383 |
| 201185_at | NM_002775 | HTRA1 | 5.72E−04 | 24384-24394 |
| 201261_x_at | BC002416 | BGN | 1.47E−04 | 24395-24405 |
| 201289_at | NM_001554 | CYR61 | 7.00E−04 | 24406-24416 |
| 201323_at | NM_006824 | EBNA1BP2 | 1.65E−03 | 24417-24427 |
| 201422_at | NM_006332 | IFI30 | 6.79E−04 | 24428-24438 |
| 201426_s_at | AI922599 | VIM | 1.67E−03 | 24439-24449 |
| 201578_at | NM_005397 | PODXL | 1.27E−03 | 24450-24460 |
| 201590_x_at | NM_004039 | ANXA2 | 5.77E−04 | 24461-24471 |
| 201666_at | NM_003254 | TIMP1 | 3.55E−04 | 23-33 |
| 201925_s_at | NM_000574 | CD55 | 2.78E−05 | 24472-24482 |
| 201926_s_at | BC001288 | CD55 | 2.68E−05 | 24483-24491 |
| 201939_at | NM_006622 | PLK2 | 1.45E−03 | 24492-24502 |
| 201951_at | BF242905 | ALCAM | 2.13E−04 | 24503-24513 |
| 202068_s_at | NM_000527 | LDLR | 1.02E−04 | 34-44 |
| 202237_at | NM_006169 | NNMT | 1.80E−03 | 24514-24524 |
| 202238_s_at | NM_006169 | NNMT | 1.80E−03 | 24525-24535 |
| 202419_at | NM_002035 | KDSR | 4.95E−04 | 24536-24546 |
| 202457_s_at | AA911231 | PPP3CA | 1.90E−03 | 45-55 |
| 202478_at | NM_021643 | TRIB2 | 7.90E−04 | 24547-24557 |
| 202839_s_at | NM_004146 | NDUFB7 | 6.09E−04 | 24558-24568 |
| 202887_s_at | NM_019058 | DDIT4 | 8.94E−05 | 24569-24579 |
| 202904_s_at | NM_012322 | LSM5 | 1.97E−03 | 24580-24590 |
| 202939_at | NM_005857 | ZMPSTE24 | 1.79E−03 | 24591-24601 |
| 202949_s_at | NM_001450 | FHL2 | 2.82E−04 | 56-66 |
| 203072_at | NM_004998 | MYO1E | 8.77E−04 | 24602-24612 |
| 203083_at | NM_003247 | THBS2 | 1.23E−04 | 24613-24623 |
| 203382_s_at | NM_000041 | APOE | 4.30E−04 | 24624-24634 |
| 203476_at | NM_006670 | TPBG | 1.50E−04 | 24635-24645 |
| 203895_at | AL535113 | PLCB4 | 6.44E−04 | 67-77 |
| 204264_at | NM_000098 | CPT2 | 9.97E−04 | 24646-24656 |
| 204472_at | NM_005261 | GEM | 4.33E−04 | 24657-24667 |
| 204620_s_at | NM_004385 | VCAN | 5.28E−04 | 24668-24678 |
| 204679_at | NM_002245 | KCNK1 | 1.58E−03 | 24679-24689 |
| 205677_s_at | NM_005887 | DLEU1 | 7.15E−04 | 24690-24700 |
| 205963_s_at | NM_005147 | DNAJA3 | 4.48E−04 | 24701-24709 |
| 207543_s_at | NM_000917 | P4HA1 | 1.62E−05 | 24710-24720 |
| 207574_s_at | NM_015675 | GADD45B | 4.19E−04 | 24721-24731 |
| 208891_at | BC003143 | DUSP6 | 5.66E−04 | 1-11 |
| 208892_s_at | BC003143 | DUSP6 | 1.70E−03 | 78-88 |
| 208893_s_at | BC005047 | DUSP6 | 1.45E−03 | 24732-24742 |
| 208918_s_at | AI334128 | NADK | 7.87E−04 | 24743-24753 |
| 208961_s_at | AB017493 | KLF6 | 1.75E−03 | 24754-24764 |
| 209043_at | AF033026 | PAPSS1 | 4.70E−04 | 24765-24775 |
| 209101_at | M92934 | CTGF | 8.53E−05 | 24776-24786 |
| 209184_s_at | BF700086 | IRS2 | 8.39E−04 | 24787-24797 |
| 209185_s_at | AF073310 | IRS2 | 5.24E−04 | 24798-24808 |
| 209193_at | M24779 | PIM1 | 7.01E−04 | 24809-24819 |
| 209345_s_at | AL561930 | PI4K2A | 1.53E−03 | 24820-24830 |
| 209386_at | AI346835 | TM4SF1 | 2.74E−05 | 24831-24841 |
| 209387_s_at | M90657 | TM4SF1 | 1.10E−03 | 24842-24852 |
| 209457_at | U16996 | DUSP5 | 1.71E−03 | 24853-24863 |
| 209545_s_at | AF064824 | RIPK2 | 1.57E−03 | 24864-24874 |
| 209624_s_at | AB050049 | MCCC2 | 1.21E−03 | 24875-24885 |
| 209711_at | N80922 | SLC35D1 | 1.70E−04 | 24886-24896 |
| 209875_s_at | M83248 | SPP1 | 1.88E−04 | 89-99 |
| 210095_s_at | M31159 | IGFBP3 | 6.96E−04 | 24897-24907 |
| 210275_s_at | AF062347 | ZFAND5 | 6.18E−04 | 24908-24918 |
| 210427_x_at | BC001388 | ANXA2 | 1.57E−03 | 24919-24919 |
| 210495_x_at | AF130095 | FN1 | 4.08E−05 | 24920-24930 |
| 210512_s_at | AF022375 | VEGFA | 3.54E−05 | 100-110 |
| 210517_s_at | AB003476 | AKAP12 | 1.99E−04 | 24931-24941 |
| 210592_s_at | M55580 | SAT1 | 7.13E−04 | 24942-24952 |
| 210652_s_at | BC004399 | TTC39A | 1.64E−03 | 24953-24963 |
| 210845_s_at | U08839 | PLAUR | 1.20E−04 | 24964-24974 |
| 211074_at | AF000381 | FOLR1 | 1.81E−05 | 24975-24985 |
| 211719_x_at | BC005858 | FN1 | 1.91E−04 | 24986-24988 |
| 211924_s_at | AY029180 | PLAUR | 1.10E−03 | 24989-24999 |
| 211928_at | AB002323 | DYNC1H1 | 1.01E−03 | 25000-25010 |
| 211988_at | BG289800 | SMARCE1 | 1.51E−03 | 25011-25021 |
| 212013_at | D86983 | PXDN | 2.74E−04 | 25022-25032 |
| 212143_s_at | BF340228 | IGFBP3 | 1.82E−03 | 25033-25043 |
| 212171_x_at | H95344 | VEGFA | 8.33E−04 | 25044-25054 |
| 212463_at | BE379006 | CD59 | 1.02E−03 | 25055-25065 |
| 212464_s_at | X02761 | FN1 | 3.36E−05 | 25066-25072 |
| 212501_at | AL564683 | CEBPB | 8.65E−04 | 25073-25083 |
| 212632_at | N32035 | STX7 | 8.03E−04 | 25084-25094 |
| 212884_x_at | AI358867 | APOE | 2.19E−04 | 25095-25104 |
| 213274_s_at | AA020826 | CTSB | 1.77E−03 | 25105-25115 |
| 213503_x_at | BE908217 | ANXA2 | 7.82E−04 | 25116-25116 |
| 213905_x_at | AA845258 | BGN | 2.69E−04 | 25117-25120 |
| 214581_x_at | BE568134 | TNFRSF21 | 1.24E−03 | 25121-25131 |
| 214620_x_at | BF038548 | PAM | 6.78E−04 | 25132-25142 |
| 214866_at | X74039 | PLAUR | 4.11E−04 | 25143-25153 |
| 215033_at | AI189753 | TM4SF1 | 2.05E−05 | 25154-25164 |
| 215034_s_at | AI189753 | TM4SF1 | 2.05E−05 | 25165-25175 |
| 215792_s_at | AL109978 | DNAJC11 | 1.81E−03 | 25176-25186 |
| 216392_s_at | AK021846 | SEC23IP | 5.52E−04 | 25187-25197 |
| 216442_x_at | AK026737 | FN1 | 2.37E−05 | 25198-25198 |
| 217762_s_at | BE789881 | RAB31 | 1.32E−03 | 25199-25209 |
| 217773_s_at | NM_002489 | NDUFA4 | 1.86E−05 | 25210-25220 |
| 217996_at | AA576961 | PHLDA1 | 4.74E−04 | 25221-25231 |
| 218213_s_at | NM_014206 | C11orf10 | 1.63E−03 | 25232-25242 |
| 218698_at | NM_015957 | APIP | 1.77E−03 | 25243-25253 |
| 218856_at | NM_016629 | TNFRSF21 | 8.15E−04 | 25254-25264 |
| 218902_at | NM_017617 | NOTCH1 | 5.32E−04 | 25265-25275 |
| 219038_at | NM_024657 | MORC4 | 6.74E−04 | 25276-25286 |
| 219206_x_at | NM_016056 | TMBIM4 | 1.51E−03 | 25287-25297 |
| 219539_at | NM_024775 | GEMIN6 | 1.92E−03 | 25298-25308 |
| 221419_s_at | NM_013307 | | 5.04E−04 | 25309-25319 |
| 221479_s_at | AF060922 | BNIP3L | 2.06E−04 | 25320-25330 |
| 221563_at | N36770 | DUSP10 | 7.92E−04 | 25331-25341 |
| 221648_s_at | AK025651 | | 1.07E−03 | 25342-25352 |
| 221656_s_at | BC003073 | ARHGEF10L | 1.20E−03 | 25353-25363 |
| 221730_at | NM_000393 | COL5A2 | 1.86E−03 | 25364-25374 |
| 221731_x_at | BF218922 | VCAN | 1.88E−03 | 25375-25382 |
| 221745_at | BE538424 | DCAF7 | 1.75E−03 | 25383-25393 |
| 222421_at | BF435617 | UBE2H | 1.66E−03 | 25394-25404 |
| 222994_at | AF197952 | PRDX5 | 1.02E−03 | 25405-25414 |
| 223003_at | AF061732 | C19orf43 | 1.67E−03 | 25415-25425 |
| 223122_s_at | AF311912 | SFRP2 | 3.15E−05 | 111-121 |
| 223163_s_at | BC000190 | ZC3HC1 | 1.94E−03 | 25426-25436 |
| 223312_at | BC005069 | C2orf7 | 4.95E−05 | 25437-25447 |
| 223454_at | AF275260 | CXCL16 | 8.98E−04 | 25448-25458 |
| 223455_at | BG493862 | TCHP | 3.80E−04 | 25459-25469 |
| 224602_at | BF244081 | C4orf3 | 1.61E−03 | 25470-25480 |
| 224606_at | BG250721 | KLF6 | 1.91E−04 | 25481-25491 |
| 224657_at | AL034417 | ERRFI1 | 1.29E−03 | 25492-25502 |
| 224777_s_at | BG386322 | PAFAH1B2 | 1.81E−03 | 25503-25513 |
| 224806_at | BE563152 | TRIM25 | 1.54E−04 | 25514-25524 |
| 224890_s_at | BE727643 | C7orf59 | 1.32E−03 | 25525-25535 |
| 224911_s_at | AA722799 | DCBLD2 | 1.74E−03 | 25536-25546 |
| 225010_at | AK024913 | CCDC6 | 1.49E−03 | 25547-25557 |
| 225011_at | AK026351 | PRKAR2A | 4.84E−04 | 25558-25568 |
| 225337_at | AI346910 | ABHD2 | 1.55E−03 | 25569-25579 |
| 225494_at | BG478726 | DYNLL2 | 1.17E−04 | 25580-25590 |
| 225670_at | AI384017 | FAM173B | 8.18E−04 | 25591-25601 |
| 225750_at | BE966748 | | 6.24E−04 | 25602-25612 |
| 226041_at | BF382393 | NAPEPLD | 1.87E−03 | 25613-25623 |
| 226594_at | AA528157 | | 1.12E−03 | 25624-25634 |
| 226648_at | AI769745 | HIF1AN | 1.93E−03 | 25635-25645 |
| 226727_at | BG171264 | CISD3 | 3.53E−04 | 25646-25656 |
| 226987_at | W68720 | RBM15B | 1.48E−03 | 25657-25667 |
| 227143_s_at | AA706658 | BID | 1.30E−03 | 122-132 |
| 227338_at | H99038 | | 7.99E−04 | 25668-25678 |
| 227735_s_at | AA553959 | | 9.29E−04 | 133-143 |
| 227736_at | AA553959 | C10orf99 | 2.00E−03 | 144-154 |
| 227961_at | AA130998 | CTSB | 1.94E−03 | 25679-25689 |
| 229676_at | AA400998 | MTPAP | 2.41E−05 | 25690-25700 |
| 231576_at | AA829940 | | 9.56E−05 | 25701-25711 |
| 234983_at | BE893995 | | 1.10E−04 | 25712-25722 |
| 241355_at | BF528433 | HR | 1.20E−03 | 25723-25733 |
| 242648_at | BE858995 | KLHL8 | 1.59E−03 | 25734-25744 |
| 35156_at | AL050297 | R3HCC1 | 1.37E−03 | 25745-25760 |
| 36711_at | AL021977 | MAFF | 1.77E−03 | 155-170 |
| 58780_s_at | R42449 | ARHGEF40 | 7.64E−04 | 25761-25776 |

TABLE 8
Annotated 160-gene lung cancer prognostic gene set. Cox regression
p-values indicate the significance of each gene's association with
survival over and above the covariates of age, stage, gender,
grade and smoking history.

| Affymetrix | Genbank | | | SEQ |
|---|---|---|---|---|
| Probe ID | Accession no | Gene Symbol | p-value | ID NOS |
| 1729_at | L41690 | TRADD | 0.000818 | 271-286 |
| 200046_at | NM_001344 | DAD1 | 0.000047 | 27881-27891 |
| 200063_s_at | BC002398 | NPM1 | 0.000594 | 27892-27902 |
| 200619_at | NM_006842 | SF3B2 | 5E−07 | 27903-27913 |
| 200621_at | NM_004078 | CSRP1 | 0.000125 | 27914-27924 |
| 200718_s_at | AA927664 | SKP1 | 6.91E−05 | 27925-27935 |
| 200725_x_at | NM_006013 | RPL10 | 0.000694 | 27936-27946 |
| 200732_s_at | AL578310 | PTP4A1 | 0.000105 | 27947-27957 |
| 200738_s_at | NM_000291 | PGK1 | 9.19E−05 | 27958-27968 |
| 200786_at | NM_002799 | PSMB7 | 0.000515 | 27969-27979 |
| 200886_s_at | NM_002629 | PGAM1 | 0.000519 | 27980-27990 |
| 201010_s_at | NM_006472 | TXNIP | 0.000907 | 27991-28001 |
| 201152_s_at | N31913 | MBNL1 | 0.000392 | 28002-28012 |
| 201174_s_at | NM_018975 | TERF2IP | 1.85E−05 | 28013-28023 |
| 201175_at | NM_015959 | TMX2 | 0.000853 | 28024-28034 |
| 201202_at | NM_002592 | PCNA | 0.00022 | 287-297 |
| 201256_at | NM_004718 | COX7A2L | 1.72E−05 | 28035-28045 |
| 201288_at | NM_001175 | ARHGDIB | 6.5E−06 | 298-308 |
| 201303_at | NM_014740 | EIF4A3 | 3E−07 | 28046-28056 |
| 201320_at | BF663402 | SMARCC2 | 0.000415 | 28057-28067 |
| 201457_x_at | AF081496 | BUB3 | 0.000242 | 28068-28078 |
| 201460_at | AI141802 | MAPKAPK2 | 6.62E−05 | 28079-28089 |
| 201499_s_at | NM_003470 | USP7 | 0.000808 | 28090-28100 |
| 201535_at | NM_007106 | UBL3 | 0.000773 | 28101-28111 |
| 201544_x_at | BF675004 | PABPN1 | 0.000866 | 28112-28122 |
| 201586_s_at | NM_005066 | SFPQ | 0.000605 | 28123-28133 |
| 201597_at | NM_001865 | COX7A2 | 0.000144 | 28134-28144 |
| 201655_s_at | M85289 | HSPG2 | 0.000187 | 28145-28155 |
| 201865_x_at | AI432196 | NR3C1 | 0.000873 | 171-181 |
| 201897_s_at | NM_001826 | CKS1B | 1.92E−05 | 28156-28166 |
| 201919_at | AL049246 | SLC25A36 | 0.000142 | 28167-28177 |
| 201930_at | NM_005915 | MCM6 | 7.95E−05 | 28178-28188 |
| 201960_s_at | NM_015057 | MYCBP2 | 0.000508 | 28189-28199 |
| 201997_s_at | NM_015001 | SPEN | 0.000494 | 28200-28210 |
| 202107_s_at | NM_004526 | MCM2 | 0.000123 | 28211-28221 |
| 202239_at | NM_006437 | PARP4 | 0.000455 | 28222-28232 |
| 202503_s_at | NM_014736 | KIAA0101 | 1.1E−06 | 28233-28243 |
| 202553_s_at | NM_015484 | SYF2 | 0.000338 | 28244-28254 |
| 202555_s_at | NM_005965 | MYLK | 0.000623 | 309-319 |
| 202697_at | NM_007006 | NUDT21 | 0.000777 | 28255-28265 |
| 202737_s_at | NM_012321 | LSM4 | 0.000193 | 28266-28276 |
| 202822_at | BF221852 | LPP | 4.3E−06 | 28277-28287 |
| 202954_at | NM_007019 | UBE2C | 0.000667 | 28288-28298 |
| 202957_at | NM_005335 | HCLS1 | 0.000338 | 28299-28309 |
| 203005_at | NM_002342 | LTBR | 0.000984 | 28310-28320 |
| 203037_s_at | NM_014751 | MTSS1 | 0.000506 | 28321-28331 |
| 203055_s_at | NM_004706 | ARHGEF1 | 0.000578 | 28332-28342 |
| 203057_s_at | AV724783 | PRDM2 | 0.000516 | 28343-28353 |
| 203147_s_at | BE962483 | TRIM14 | 0.000277 | 28354-28364 |
| 203232_s_at | NM_000332 | ATXN1 | 0.000559 | 28365-28375 |
| 203314_at | NM_012227 | GTPBP6 | 0.000551 | 28376-28386 |
| 203385_at | NM_001345 | DGKA | 0.000277 | 28387-28397 |
| 203536_s_at | NM_004804 | CIAO1 | 0.000121 | 28398-28408 |
| 203746_s_at | NM_005333 | HCCS | 0.00021 | 28409-28419 |
| 203804_s_at | NM_006107 | LUC7L3 | 0.00068 | 28420-28430 |
| 203818_s_at | NM_006802 | SF3A3 | 0.00015 | 28431-28441 |
| 203846_at | BC003154 | TRIM32 | 0.000994 | 28442-28452 |
| 204020_at | BF739943 | PURA | 0.000236 | 28453-28463 |
| 204135_at | NM_014890 | FILIP1L | 0.000428 | 28464-28474 |
| 204170_s_at | NM_001827 | CKS2 | 3.03E−05 | 25777-25787 |
| 204206_at | NM_020310 | MNT | 0.000398 | 28475-28485 |
| 204538_x_at | NM_006985 | NPIP | 0.000736 | 28486-28496 |
| 204978_at | NM_007056 | SFRS16 | 0.000185 | 28497-28507 |
| 205202_at | NM_005389 | PCMT1 | 0.000731 | 28508-28518 |
| 205308_at | NM_016010 | FAM164A | 0.000636 | 28519-28529 |
| 207081_s_at | NM_002650 | PI4KA | 0.000584 | 28530-28540 |
| 207186_s_at | NM_004459 | BPTF | 0.000553 | 28541-28551 |
| 207365_x_at | NM_014709 | USP34 | 0.000814 | 28552-28562 |
| 208174_x_at | NM_005089 | ZRSR2 | 0.000515 | 28563-28573 |
| 208610_s_at | AI655799 | SRRM2 | 0.000352 | 28574-28584 |
| 208616_s_at | U48297 | PTP4A2 | 0.000957 | 28585-28595 |
| 208634_s_at | AB029290 | MACF1 | 0.000645 | 28596-28606 |
| 208727_s_at | BC002711 | CDC42 | 0.00045 | 28607-28617 |
| 208763_s_at | AL110191 | TSC22D3 | 0.000621 | 28618-28628 |
| 208798_x_at | AF204231 | GOLGA8A | 0.000574 | 28629-28639 |
| 208799_at | BC004146 | PSMB5 | 2.58E−05 | 320-330 |
| 208872_s_at | AA814140 | REEP5 | 0.000604 | 28640-28650 |
| 208891_at | BC003143 | DUSP6 | 2.52E−05 | 1-11 |
| 208943_s_at | U93239 | SEC62 | 0.000197 | 28651-28661 |
| 208994_s_at | AI638762 | PPIG | 0.000348 | 28662-28672 |
| 209007_s_at | AF267856 | C1orf63 | 0.000309 | 28673-28683 |
| 209045_at | AF195530 | XPNPEP1 | 0.000998 | 28684-28694 |
| 209050_s_at | AI421559 | RALGDS | 0.00021 | 28695-28705 |
| 209161_at | AI184802 | PRPF4 | 0.000622 | 28706-28716 |
| 209199_s_at | N22468 | MEF2C | 0.000613 | 28717-28727 |
| 209240_at | AF070560 | OGT | 0.00042 | 28728-28738 |
| 209263_x_at | BC000389 | TSPAN4 | 6.27E−05 | 28739-28749 |
| 209341_s_at | AU153366 | IKBKB | 0.000821 | 331-341 |
| 209365_s_at | U65932 | ECM1 | 3.27E−05 | 28750-28760 |
| 209448_at | BC002439 | HTATIP2 | 0.000387 | 28761-28771 |
| 209467_s_at | BC002755 | MKNK1 | 0.000533 | 28772-28782 |
| 209473_at | AV717590 | ENTPD1 | 0.00017 | 28783-28793 |
| 209609_s_at | BC004517 | MRPL9 | 1.42E−05 | 28794-28804 |
| 209939_x_at | AF005775 | CFLAR | 0.000316 | 342-350 |
| 209939_x_at | AF005775 | CFLAR | 0.000316 | 182-183 |
| 210266_s_at | AF220137 | TRIM33 | 2.47E−05 | 28805-28815 |
| 210686_x_at | BC001407 | SLC25A16 | 0.000696 | 28816-28826 |
| 211417_x_at | L20493 | GGT1 | 0.000634 | 28827-28837 |
| 211452_x_at | AF130054 | LRRFIP1 | 3.94E−05 | 28838-28848 |
| 211600_at | U20489 | PTPRO | 0.000506 | 28849-28859 |
| 211941_s_at | BE969671 | PEBP1 | 0.000148 | 28860-28870 |
| 211946_s_at | AL096857 | BAT2L2 | 0.000931 | 28871-28881 |
| 211974_x_at | AL513759 | RBPJ | 7.16E−05 | 351-361 |
| 211994_at | AI742553 | WNK1 | 0.000303 | 28882-28892 |
| 212112_s_at | AI816243 | STX12 | 0.000471 | 28893-28903 |
| 212239_at | AI680192 | PIK3R1 | 0.000135 | 28904-28914 |
| 212386_at | BF592782 | TCF4 | 0.000268 | 28915-28925 |
| 212586_at | AA195244 | CAST | 0.000913 | 28926-28936 |
| 212587_s_at | AI809341 | PTPRC | 0.000322 | 362-372 |
| 212616_at | BF668950 | CHD9 | 0.000167 | 28937-28947 |
| 212646_at | D42043 | RFTN1 | 0.000025 | 28948-28958 |
| 212786_at | AA731693 | CLEC16A | 0.000216 | 28959-28969 |
| 212873_at | BE349017 | HMHA1 | 0.000702 | 28970-28980 |
| 212944_at | AK024896 | SLC5A3 | 4.39E−05 | 28981-28991 |
| 212995_x_at | BG255188 | MZT2B | 0.000713 | 28992-29002 |
| 213175_s_at | AL049650 | SNRPB | 0.000101 | 29003-29013 |
| 213295_at | AA555096 | CYLD | 0.000371 | 29014-29024 |
| 213639_s_at | AI871396 | ZNF500 | 0.000791 | 29025-29035 |
| 213850_s_at | AI984932 | SRSF2IP | 0.000391 | 29036-29046 |
| 213857_s_at | BG230614 | CD47 | 0.000351 | 29047-29057 |
| 213911_s_at | BF718636 | H2AFZ | 0.000057 | 29058-29068 |
| 214035_x_at | AA308853 | LOC399491 | 0.000176 | 29069-29076 |
| 214141_x_at | BF033354 | SRSF7 | 0.000356 | 29077-29087 |
| 214464_at | NM_003607 | CDC42BPA | 0.000339 | 29088-29098 |
| 214494_s_at | NM_005200 | SPG7 | 0.000592 | 29099-29109 |
| 214686_at | AA868898 | ZNF266 | 0.0005 | 29110-29120 |
| 214730_s_at | AK025457 | GLG1 | 0.000424 | 29121-29131 |
| 214938_x_at | AF283771 | HMGB1 | 0.000633 | 29132-29142 |
| 214988_s_at | X63071 | SON | 0.000237 | 29143-29153 |
| 215333_x_at | X08020 | GSTM1 | 0.000756 | 29154-29164 |
| 217757_at | NM_000014 | A2M | 0.000278 | 29165-29175 |
| 217791_s_at | NM_002860 | ALDH18A1 | 0.000191 | 29176-29186 |
| 218004_at | NM_018045 | BSDC1 | 0.000002 | 29187-29197 |
| 218012_at | NM_022117 | TSPYL2 | 0.000896 | 29198-29208 |
| 218118_s_at | NM_006327 | TIMM23 | 0.000331 | 29209-29219 |
| 218127_at | AI804118 | NFYB | 0.000492 | 29220-29230 |
| 218160_at | NM_014222 | NDUFA8 | 0.000903 | 29231-29241 |
| 218251_at | NM_021242 | MID1IP1 | 0.000349 | 29242-29252 |
| 218552_at | NM_018281 | ECHDC2 | 0.00027 | 29253-29263 |
| 218686_s_at | NM_022450 | RHBDF1 | 0.000251 | 29264-29274 |
| 218873_at | NM_017710 | GON4L | 0.000111 | 29275-29285 |
| 219176_at | NM_024520 | C2orf47 | 0.00043 | 29286-29296 |
| 220036_s_at | NM_018113 | LMBR1L | 0.000225 | 29297-29307 |
| 220079_s_at | NM_018391 | USP48 | 2.24E−05 | 29308-29318 |
| 221073_s_at | NM_006092 | NOD1 | 0.000737 | 29319-29329 |
| 221249_s_at | NM_030802 | FAM117A | 1E−07 | 29330-29340 |
| 221495_s_at | AF322111 | TCF25 | 0.000377 | 29341-29351 |
| 221501_x_at | AF229069 | PKD1P1 | 0.000359 | 29352-29355 |
| 221510_s_at | AF158555 | GLS | 0.000824 | 29356-29366 |
| 221718_s_at | M90360 | AKAP13 | 0.000439 | 373-383 |
| 221743_at | AI472139 | CELF1 | 0.000168 | 29367-29377 |
| 221844_x_at | AV756161 | SPCS3 | 0.00099 | 29378-29388 |
| 221899_at | AI809961 | N4BP2L2 | 4.59E−05 | 29389-29399 |
| 221932_s_at | AA133341 | GLRX5 | 0.000189 | 29400-29410 |
| 221937_at | AI472320 | SYNRG | 0.0007 | 29411-29421 |
| 221942_s_at | AI719730 | GUCY1A3 | 0.000399 | 29422-29432 |
| 32259_at | AB002386 | EZH1 | 0.00059 | 29433-29448 |
| 40093_at | X83425 | BCAM | 5.71E−05 | 29449-29464 |
| 46256_at | AA522670 | SPSB3 | 0.000137 | 27865-27880 |
| 57082_at | AA169780 | LDLRAP1 | 0.000418 | 29465-29480 |
| 65770_at | AI186666 | RHOT2 | 0.000858 | 29481-29496 |

TABLE 9
Annotated list of 37 genes used to predict ACT benefit in NSCLC.
Cox-Regression p-value reflects significance of gene expression
pattern to outcome in ACT-treated patients, independent to age,
gender, stage, smoking history and 160-gene prognosis score.

| Affymetrix | Genbank | Gene | | |
|---|---|---|---|---|
| Probe ID | Accession no | Symbol | p-value | SEQ ID NOS |
| 201250_s_at | NM_006516 | SLC2A1 | 0.0007074 | 29497-29507 |
| 202504_at | NM_012101 | TRIM29 | 0.00091 | 384-394 |
| 202551_s_at | BG546884 | CRIM1 | 0.0003722 | 29508-29518 |
| 202698_x_at | NM_001861 | COX4I1 | 0.0009066 | 29519-29529 |
| 203405_at | NM_003720 | PSMG1 | 0.0004087 | 29530-29540 |
| 203694_s_at | NM_003587 | DHX16 | 0.0004141 | 29541-29551 |
| 203822_s_at | NM_006874 | ELF2 | 0.0007314 | 29552-29562 |
| 204303_s_at | NM_014772 | KIAA0427 | 0.0001162 | 29563-29573 |
| 204429_s_at | BE560461 | SLC2A5 | 0.0005819 | 29574-29584 |
| 205106_at | NM_014221 | MTCP1 | 0.0004813 | 29585-29595 |
| 206411_s_at | NM_007314 | ABL2 | 0.0008467 | 29596-29606 |
| 206414_s_at | NM_003887 | ASAP2 | 0.0004048 | 29607-29617 |
| 206432_at | NM_005328 | HAS2 | 0.0004209 | 29618-29628 |
| 206477_s_at | NM_002516 | NOVA2 | 0.0000115 | 29629-29639 |
| 206833_s_at | NM_001108 | ACYP2 | 0.0007803 | 29640-29650 |
| 206872_at | NM_005074 | SLC17A1 | 0.0000778 | 29651-29661 |
| 209020_at | AF217514 | C20orf111 | 0.0007324 | 29662-29672 |
| 209114_at | AF133425 | TSPAN1 | 0.0003499 | 395-405 |
| 210357_s_at | BC000669 | SMOX | 0.0003298 | 29673-29683 |
| 210456_at | AF148464 | PCYT1B | 0.0006394 | 29684-29694 |
| 210754_s_at | M79321 | LYN | 0.0005255 | 406-416 |
| 210775_x_at | AB015653 | CASP9 | 0.0003883 | 29695-29705 |
| 210844_x_at | D14705 | CTNNA1 | 0.0009938 | 417-427 |
| 213050_at | AA594937 | COBL | 0.0008898 | 428-438 |
| 213853_at | AL050199 | DNAJC24 | 0.0009609 | 29706-29716 |
| 215543_s_at | AB011181 | LARGE | 0.0009219 | 29717-29727 |
| 218149_s_at | NM_017606 | ZNF395 | 0.0003799 | 29728-29738 |
| 218665_at | NM_012193 | FZD4 | 0.0007849 | 29739-29749 |
| 218845_at | NM_020185 | DUSP22 | 0.0007801 | 29750-29760 |
| 219429_at | NM_024306 | FA2H | 0.0007887 | 439-449 |
| 219496_at | NM_023016 | ANKRD57 | 0.0000767 | 29761-29771 |
| 220658_s_at | NM_020183 | ARNTL2 | 0.0000575 | 450-460 |
| 221036_s_at | NM_031301 | APH1B | 0.0005189 | 29772-29782 |
| 221234_s_at | NM_021813 | BACH2 | 0.0001448 | 29783-29793 |
| 35666_at | U38276 | SEMA3F | 0.0004552 | 29794-29809 |
| 40560_at | U28049 | TBX2 | 0.0009767 | 461-476 |
| 46256_at | AA522670 | SPSB3 | 0.0004097 | 27865-27880 |

### REFERENCES

E. Bair, et al. (2004), Semi-supervised methods to predict patient survival from gene expression data, PLoS Biol, 2: E108
A. Bild, et al. (2006), Oncogenic pathway signatures in human cancers as a guide to targeted therapies, Nature, 439: 353-357
G. Bloom, et al. (2004), Multi-platform, multi-site, microarray-based human tumor classification, The American journal of pathology, 164: 9-16
B. M. Bolstad, et al. (2003), A comparison of normalization methods for high density oligonucleotide array data based on variance and bias, Bioinformatics, 19: 185-193
M. P. Brown, et al. (2000), Knowledge-based analysis of microarray gene expression data by using support vector machines, Proc Natl Acad Sci USA, 97: 262-267
E. C. Burton, et al. (1998), Autopsy diagnoses of malignant neoplasms: how often are clinical diagnoses incorrect?, Jama, 280: 1245-8
D. R. Cox (1972), Regression models and life-tables (with discussion), Journal of the Royal Statistical Society, B: 187-220
G. Dennis, Jr., et al. (2003), DAVID: Database for Annotation, Visualization, and Integrated Discovery, Genome biology, 4: 3
C. Desmedt, et al. (2007), Strong Time Dependence of the 76-Gene Prognostic Signature for Node-Negative Breast Cancer Patients in the TRANSBIG Multicenter Independent Validation Series, Clinical Cancer Research, 13: 3207-3214
S. Dudoit, et al. (2002), Comparison of Discrimination Methods for the Classification of Tumors Using Gene Expression Dat, Journal of the American Statistical Association, 97: 77-87
C. I. Dumur, et al. (2008), Interlaboratory performance of a microarray-based gene expression test to determine tissue of origin in poorly differentiated and undifferentiated cancers, J Mol Diagn, 10: 67-77
T. Egawa-Takata, et al. Early reduction of glucose uptake after cisplatin treatment is a marker of cisplatin sensitivity in ovarian cancer, Cancer Science, 101: 2171-2178
R. C. Gentleman, et al. (2004), Bioconductor: open software development for computational biology and bioinformatics, Genome biology, 5: R80
J. D. Hoheisel (2006), Microarray technology: beyond transcript profiling and genotype analysis, Nat Rev Genet, 7: 200-210
H. M. Horlings, et al. (2008), Gene Expression Profiling to Identify the Histogenetic Origin of Metastatic Adenocarcinomas of Unknown Primary, J Clin Oncol, 26: 4435-4441
R. A. Irizarry, et al. (2003), Exploration, normalization, and summaries of high density oligonucleotide array probe level data, Biostatistics, 4: 249-264
A. V. Ivshina, et al. (2006), Genetic Reclassification of Histologic Grade Delineates New Clinical Subtypes of Breast Cancer, Cancer Res, 66: 10292-10301
R. N. Jorissen, et al. (2009), Metastasis-Associated Gene Expression Changes Predict Poor Outcomes in Patients with Dukes Stage B and C Colorectal Cancer, Clinical Cancer Research, 15: 7642-7651
H. M. Khandwala, et al. (2000), The Effects of Insulin-Like Growth Factors on Tumorigenesis and Neoplastic Growth, Endocr Rev, 21: 215-244
K. Konishi, et al. (1999), Clinicopathological differences between colonic and rectal carcinomas: are they based on the same mechanism of carcinogenesis?, Gut, 45: 818-21
D. Kowalski, et al. (2008), Dysregulation of Purine Nucleotide Biosynthesis Pathways Modulates Cisplatin Cytotoxicity in Saccharomyces cerevisiae, Molecular Pharmacology, 74: 1092-1100
C. Li, et al. (2011), Oncogenic role of EAPII in lung cancer development and its activation of the MAPK-ERK pathway, Oncogene,
S. Loi, et al. (2007), Definition of Clinically Distinct Molecular Subtypes in Estrogen Receptor-Positive Breast Carcinomas Through Genomic Grade, J Clin Oncol, 25: 1239-1246
X. J. Ma, et al. (2006), Molecular classification of human cancers using a 92-gene real-time quantitative polymerase chain reaction assay, 130: 465-473
N. Pavlidis, et al. (2003), Diagnostic and therapeutic management of cancer of an unknown primary, Eur J Cancer, 39: 1990-2005
K. M. W. Pisters, et al. (2007), Cancer Care Ontario and American Society of Clinical Oncology Adjuvant Chemotherapy and Adjuvant Radiation Therapy for Stages I-IIIA Resectable Nonâ [symbol] “Small-Cell Lung Cancer Guideline, Journal of Clinical Oncology, 25: 5506-5518
I. Robieux, et al. (1996), Pharmacokinetics of vinorelbine in patients with liver metastases, Clin Pharmacol Ther, 59: 32-40
M. Schmidt, et al. (2008), The Humoral Immune System Has a Key Prognostic Impact in Node-Negative Breast Cancer, Cancer Res, 68: 5405-5413
K. Shedden, et al. (2008), Gene expression-based survival prediction in lung adenocarcinoma: a multi-site, blinded validation study, Nat Med, 14: 822-827
R. Simon (2005), Roadmap for Developing and Validating Therapeutically Relevant Genomic Classifiers, J Clin Oncol, 23: 7332-7341
R. Simon, et al. (2007), Analysis of Gene Expression Data Using BRB-Array Tools, Cancer Inform, 3: 11-7
J. J. Smith, et al. (2009), Experimentally Derived Metastasis Gene Expression Profile Predicts Recurrence and Death in Patients With Colon Cancer, Gastroenterology, 138: 958-968
J. Subramanian, et al. What should physicians look for in evaluating prognostic gene-expression signatures?, Nat Rev Clin Oncol, 7: 327-334
J. Subramanian, et al. (2010), Gene Expression Based Prognostic Signatures in Lung Cancer: Ready for Clinical Use?, Journal of the National Cancer Institute, 102: 464-474
T. Takeuchi, et al. (2006), Expression Profile-Defined Classification of Lung Adenocarcinoma Shows Close Relationship With Underlying Major Genetic Changes and Clinicopathologic Behaviors, Journal of Clinical Oncology, 24: 1679-1688
R. Tibshirani, et al. (2002), Diagnosis of multiple cancer types by shrunken centroids of gene expression, Proceedings of the National Academy of Sciences, 99: 6567-6572
R. W. Tothill, et al. (2005), An expression-based site of origin diagnostic method designed for clinical application to cancer of unknown origin, Cancer Res, 65: 4031-4040
R. K. Van Laar (2010), An online gene expression assay for determining adjuvant therapy eligibility in patients with stage 2 or 3 colon cancer, British journal of cancer, 103: 1852-1857
R. K. van Laar, et al. (2009), Implementation of a novel microarray-based diagnostic test for cancer of unknown primary, Int J Cancer, 125: 1390-1397
G. R. Varadhachary, et al. (2004), Diagnostic strategies for unknown primary cancer, Cancer, 100: 1776-85
Z. Wu, et al. (2004), A Model-Based Background Adjustment for Oligonucleotide Expression Arrays, Journal of the American Statistical Association, 99: 909-917
C.-Q. Zhu, et al. (2010), Prognostic and Predictive Gene Signature for Adjuvant Chemotherapy in Resected Non-Small-Cell Lung Cancer, Journal of Clinical Oncology, 28: 4417-4424

1. A method for classifying an isolated biological test sample obtained from a cancer patient, including the steps of:
selecting a set of marker molecules from;
a) any combination of 100 or more of the polynucleotides listed in Table 1, wherein the polynucleotides are detectable with the oligonucleotide probes SEQ ID NOS: 1-24196;
b) any combination of 100 or more of the polynucleotides listed in Table 3, wherein the polynucleotides are detectable with the oligonucleotide probes SEQ ID NOS: 171-270 and 25777-27864;
c) any combination of 15 or more of the polynucleotides listed in Table 6, wherein the polynucleotides are detectable with the oligonucleotide probes SEQ ID NOS: 1-170 and 24197-25776;
d) any combination of 2 or more of the polynucleotides listed in Table 8, wherein the polynucleotides are detectable with the oligonucleotide probes SEQ ID NOS: 1-11, 171-183, 271-383, 25777-25787 and 27865-29496; and
e) any combination of 2 or more of the polynucleotides listed in Table 9, wherein the polynucleotides are detectable with the oligonucleotide probes SEQ ID NOS: 384-476, 27865-27880 and 29497-29809,
providing a database populated with reference expression data, the reference expression data including expression levels of a plurality of molecules in a plurality of reference samples, the plurality of molecules including at least the marker molecules, each reference sample having a pre-assigned value for each of one or more clinically significant variables selected from the group including disease state, disease prognosis, and treatment response;
accepting input expression data, the input expression data including a test vector of expression levels of the marker molecules in the isolated biological test sample; and
assigning one of said pre-assigned values to the test sample for at least one of said clinically significant variables by passing the test vector to a statistical classification program;
wherein the statistical classification program has been trained to distinguish among said pre-assigned values on the basis of that part of the reference data corresponding to expression levels of the marker molecules.

2. A method according to claim 1, wherein the clinically significant variables are organised according to a hierarchy and the levels of the hierarchy are selected from the group consisting of anatomical system, tissue type and tumor subtype.

3. A method according to claim 1, wherein the disease prognosis is risk of recurrence.

4. A method according to claim 1 which is used to determine the risk of breast cancer recurrence, wherein the set of marker molecules includes the 200 marker molecules listed in Table 3, that are detectable with the oligonucleotide probes SEQ ID NOS: 171-270 and 25777-27864.

5. A method according to claim 1 which is used to determine the risk of colon cancer recurrence, wherein the set of marker molecules includes the 163 marker molecules listed in Table 6, that are detectable with the oligonucleotide probes SEQ ID NOS: 1-170 and 24197-25776.

6. A method according to claim 1 which is used to identify patients with stage I/II adenocarcinoma who are at increased risk of death, wherein the set of marker molecules includes the 160 marker molecules listed in Table 8, that are detectable with the oligonucleotide probes SEQ ID NOS: 1-11, 171-183, 271-383, 25777-25787 and 27865-29496.

7. A method according to claim 1 which is used to predict adjuvant chemotherapy response in patients with non-small-cell lung cancer, wherein the set of marker molecules includes the 37 marker molecules listed in Table 9, that are detectable with the oligonucleotide probes SEQ ID NOS: 384-476, 27865-27880 and 29497-29809.

8. A method of classifying an isolated biological test sample obtained from a cancer patient, including the step of:
comparing expression levels in the test sample of a set of marker molecules, selected from;
a) any combination of 100 or more of the polynucleotides listed in Table 1, wherein the polynucleotides are detectable with the oligonucleotide probes SEQ ID NOS: 1-24196;
b) any combination of 100 or more of the polynucleotides listed in Table 3, wherein the polynucleotides are detectable with the oligonucleotide probes SEQ ID NOS: 171-270 and 25777-27864;
c) any combination of 15 or more of the polynucleotides listed in Table 6, wherein the polynucleotides are detectable with the oligonucleotide probes SEQ ID NOS: 1-170 and 24197-25776;
d) any combination of 2 or more of the polynucleotides listed in Table 8, wherein the polynucleotides are detectable with the oligonucleotide probes SEQ ID NOS: 1-11, 171-183, 271-383, 25777-25787 and 27865-29496; and
e) any combination of 2 or more of the polynucleotides listed in Table 9, wherein the polynucleotides are detectable with the oligonucleotide probes SEQ ID NOS: 384-476, 27865-27880 and 29497-29809,
to expression levels of said set of marker molecules in a set of reference samples, each member of the set of reference samples having a known clinical annotation, to assign a clinical annotation to the isolated biological test sample,
wherein the clinical annotation is selected from the group including anatomical system, tissue of origin, tumor subtype, risk of cancer recurrence, prognosis of increased risk of death, and prediction of adjuvant chemotherapy response.

9.-26. (canceled)
